(19) United States
(12) Patent Application Publication
(10) Pub. No.: US 2008/0133300 A1
(43) Pub. Date: Jun. 5, 2008

(54) System and apparatus for enterprise resilience

(76) Inventor: Mady Jalinous, Washington, DC (US)

Correspondence Address: MILES & STOCKBRIDGE PC, 1751 PINNACLE DRIVE, SUITE 500, MCLEAN, VA, 22102-3833, US

(21) Appl. No.: 11/978,616

(22) Filed: Oct. 30, 2007

Related U.S. Application Data
(60) Provisional application No. 60/855,110, filed on Oct. 30, 2006.
(60) Provisional application No. 60/865,930, filed on Nov. 15, 2006.

(51) Int. Cl. G06F 17/30

(52) U.S. Cl. 705/7

(57) ABSTRACT

A system and apparatus for the creation of a comprehensive process that diagnoses the risk factors threatening an enterprise and, it mitigates the risks by prevention or preparedness to respond and recover to incidents. In accordance with one or more embodiments of the present invention, the system may continuously monitor dependent and critical data for signals indicating the need for prevention or for response to an incident, which ever may be the circumstance. In general, the process operates as one continuous flow, where every stage and phase is directly dependent on the previous phase. As each process and phase is developed and completed it trickles down its results to feed critical information for the next process or step or phase.

### CROSS-REFERENCE TO RELATED APPLICATIONS

This application claims benefit of priority to U.S. Provisional Patent Application No. 60/855,110, filed Oct. 30, 2006 and to U.S. Provisional Patent Application No. 60/865,930, filed Nov. 15, 2006, both of which are herein incorporated in their entireties by reference.

### FIELD OF THE INVENTION

Embodiments of the present invention relate to a system and apparatus for providing enterprise resilience, and more particularly to a system and apparatus for diagnosing enterprise risk factors, mitigating the risks by preparing prevention and/or preparedness plans, and continuously monitoring system data for signals indicating the need for preventive action or response to an incident.

### BACKGROUND

Every government agency, public or private organization or company should care about risk assessment, risk mitigation planning, and incident response planning. Unfortunately, although each may say that they do, frequently, they have not done any risk mitigation analysis and/or planning. Specific entities and/or individuals that can be affected by an agency's or company's failure to adequately assess and plan for risk may include: shareholders—enterprises face myriad, multi-faceted risks that can measurably impact shareholder value in a negative manner; business partners—suppliers, distributors may also be directly impacted; and citizens—continuing critical infrastructure and available places of assembly following and incident have a direct and dramatic impact on the citizens affected by the incident. Even when risk assessment, risk mitigation planning, and incident response planning is done, it is currently not embodied in a single integrated system to enable an agency and/or company to immediately and coherently respond to signals of increasing risk and/or an actual incident.

### SUMMARY

Some embodiments the present invention pertain to systems and apparatus for the creation of a comprehensive process that identifies/diagnoses the risk factors threatening an enterprise and then mitigates the identified risks by creating a prevention plan to mitigate the risk or a preparedness plan to respond and recover to incidents for which a prevention plan is not possible, for example, a hurricane. In accordance with one or more embodiments of the present invention, the system may continuously monitor dependent and critical data for signals indicating the need for prevention or for response to an incident, which ever may be the circumstance. In general, the process operates as one continuous flow, where every stage and phase is directly dependent on the previous phase. As each process and phase is developed and completed it trickles down its results to feed critical information for the next process or step or phase.

### BRIEF DESCRIPTION OF THE DRAWINGS

Non-limiting and non-exhaustive embodiments of the present invention are described with reference to the following figures, wherein like reference numerals refer to like parts throughout the various views unless otherwise precisely specified.

FIG. 1 is a block diagram of the diagnostic components of the system for performing risk assessment, risk mitigation planning, and risk mitigation implementation, in accordance with an embodiment of the present invention.

FIG. 2 is a functional block diagram of an enterprise solution design framework, in accordance with an embodiment of the present invention.

FIG. 3 is a block diagram illustrating the operational flow within an enterprise resilience system, in accordance with an embodiment of the present invention.

FIG. 4 is a block diagram illustrating the operational flow within an enterprise risk assessment phase of FIG. 3, in accordance with an embodiment of the present invention.

FIG. 5 is a functional block diagram of the operational flow within a planning phase of the enterprise solution design framework, in accordance with an embodiment of the present invention.

FIG. 6 is a screen shot of an executive dashboard configured to provide a user with access to information on a specific risk and/or incident, in accordance with an embodiment of the present invention.

FIG. 7 is a functional flow diagram showing how the system operates in response to an incident or event, in accordance with an embodiment of the present invention.

FIG. 8 is a functional diagram showing how the health status of people injured in the incident may be collected, in accordance with an embodiment of the present invention.

FIG. 9 is a diagram of how an incident may be handled by a risk assessment, risk mitigation planning, and risk mitigation implementation system, in accordance with an embodiment of the present invention.

FIG. 10 is a flow diagram of how the system may manage recovery operations after an incident, in accordance with an embodiment of the present invention.

FIG. 11 is functional flow diagram illustrating the remote dispatch of electronic health records from a location of an incident to one or more nearest care centers, in accordance with an embodiment of the present invention.

FIG. 12 is a functional block diagram showing a flow for the accumulation and dissemination of a patient's health profile and medical records through out a collaborated continuum of care, in accordance with an embodiment of the present invention.

FIG. 13 is a screen shot of an Emergency Operations Center (EOC) that may be used to manage the implementation of a response to an incident with casualties and health risks, in accordance with an embodiment of the present invention.

FIG. 14 is a block diagram showing the hierarchical structure of an enterprise risk and incident management system, in accordance with one or more embodiments of the present invention.

FIG. 15 is a is a block diagram showing the hierarchical structure of operational user interfaces for an enterprise risk and incident management system, in accordance with one or more embodiments of the present invention.

FIG. 16 is a functional block diagram of the platform architecture for a risk mitigation system, in accordance with one or more embodiments of the present invention.

FIG. 17 is a functional block diagram of content integration between the various layers of the risk mitigation system of FIG. 16, in accordance with one or more embodiments of the present invention.

FIG. 18 is a stylized depiction of the different information and devices that may be in communication with the risk mitigation system 1600, in accordance with one or more embodiments of the present invention.

FIGS. 19 through 51 are sample screen shots of an enterprise resilience solution, in accordance with an embodiment of the present invention.

FIG. 52 is a top-level functional block diagram of the architecture of the first responder solution, in accordance with an embodiment of the present invention.

FIG. 53 is a top-level functional block diagram of the architecture of the first responder solution in a two-server configuration, in accordance with an embodiment of the present invention.

FIG. 54 is a screen shot of a page in the Internet Information Services (IIS) web server being used to create a new application pool, for use with one or more embodiments of the present invention.

FIG. 55 shows the performance tab with the default values for use in accordance with one or more embodiments of the present invention.

FIG. 56 shows the recycling tab with the default values for use in accordance with one or more embodiments of the present invention.

FIG. 57 shows the cache options tab with the default values for use in accordance with one or more embodiments of the present invention.

FIG. 58 is a screen shot of a properties page for the IIS server for use with embodiments of the present invention.

FIG. 59 is a functional block diagram showing a comparison of a classic web application model and an Ajax web application model.

FIG. 60 is a block diagram of a recommended GEMS Physical Deployment with a server cluster and NLB.

FIG. 61 is an artistic representation of the GEMS approach for integration with, EAI applications like SAP R/3 through GEMS Adapter for BizTalk.

### DESCRIPTION OF VARIOUS EMBODIMENTS OF THE INVENTION

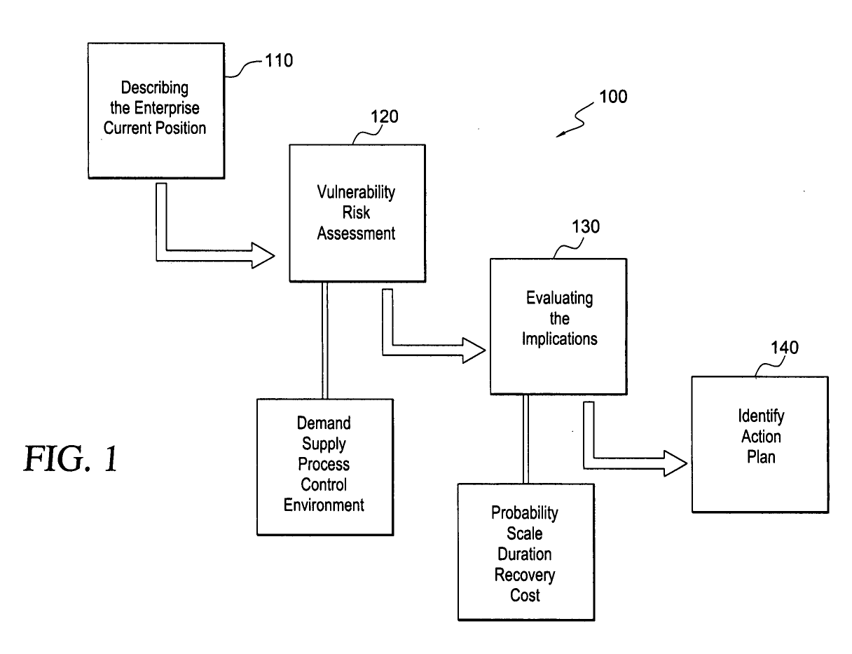

In accordance with one or more embodiments of the present invention, the system may enable the performance of a risk assessment, an analysis of the assessed risks, creating a plan to avoid and/or mitigate and/or respond to the risks, and implementing and maintaining the plan. FIG. 1 is a block diagram of the diagnostic components of a system 100 for performing risk assessment, risk mitigation planning, and risk mitigation implementation, in accordance with an embodiment of the present invention. In FIG. 1, the system 100 may be divided into a four step process, including describing (110) the current status of an enterprise, performing (120) a vulnerability risk assessment of the enterprise, evaluating (130) implications of the resulting risk assessment, and creating and implementing (140) a risk action plan to mitigate the identified risks.

Describing (110) the current status of the enterprise may include identifying all the different entity types within the enterprise that needs to be protected, as well as all the entities that will be part of the implementation, for example, private entities, police stations, fire stations, hospitals, etc. with their respective locations, roles and full profile. This may include identifying all of the people in the enterprise, by location and with a detailed profile about each person. The profile for each person may also contain health information that may be provided by each person electronically, for example, via the Internet. This may also include identifying taxonomies for all private and public first responder entities by type, location, and capability. In addition, all available physical sites that will be part of the plan may be identified including their type, location, size, facilities, and the like. The description (110) may further include identifying procurement sources (i.e., vendors) for all necessary supplies and services with pre-negotiated purchase order prices and terms and conditions.

In accordance with an embodiment of the present invention, taxonomy attributes for a police station may include: the station information (e.g., name, logo, address, latitude and longitude coordinates, and/or map, brief description), the functional capabilities (e.g., operational coverage area, holding cells, medical capabilities, etc.), the personnel information (e.g., names and specialties of management, police officers, detectives, staff, and chain of command within and outside of station), the number and types of available vehicles (e.g., squad cars, paddy wagons, SWAT vehicles, etc.), special capabilities (e.g., foreign languages, SWAT, etc.), station processes, any special incident management procedures (e.g., for natural disasters, riots, etc.), and identifying a knowledge-base, a training program. Similar taxonomies for fire stations, hospitals, social services may also be developed.

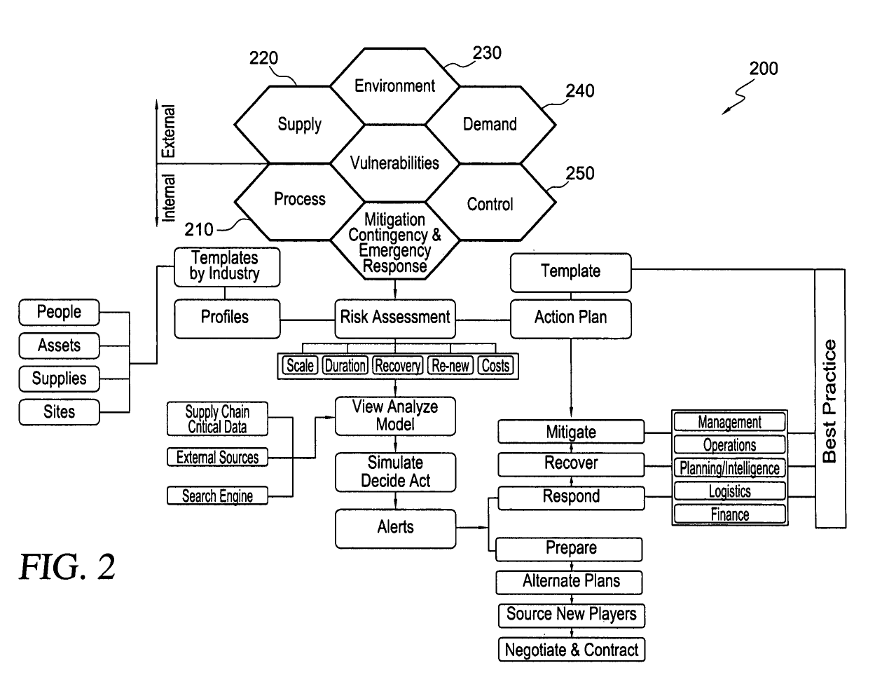

FIG. 2 is a functional block diagram of an enterprise solution design framework 200, in accordance with an embodiment of the present invention. In FIG. 2, the framework facilitates development of the risk mitigation plan by being useable to implement and maintain a resiliency plan (i.e., risk mitigation plan). The framework may operate using a service-oriented architecture with hosted services and standard templates to ensure industry and regulatory compliance and rapid test and deployment of the resiliency plan. The framework also implements industry and impact (i.e., incident) templates to facilitate rapid solution design and notification and escalation procedures that extend to include government agencies and local communities. The framework may be used to identify vulnerabilities in five general areas, which include, process 210, supply 220, environment 230, demand 240, and control 250, in order to develop mitigation plans and contingency and emergency response plans.

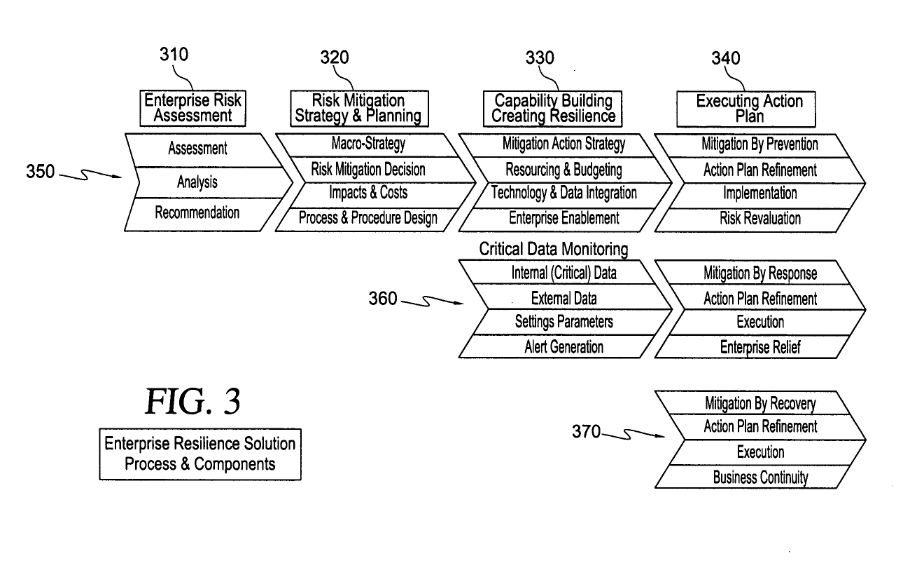

FIG. 3 is a block diagram 300 illustrating the operational flow within an enterprise resilience system, in accordance with an embodiment of the present invention. In FIG. 3, the enterprise resilience system provides a four-step, three-tier process that includes the following steps: enterprise risk assessment 310, risk mitigation strategy and planning 320, capability building and creating an action plan to provide resilience 330, and executing the action plan 340. In addition, the three process tiers include: a plan creation phase 350, a monitoring phase 360, and a reaction phase 370.

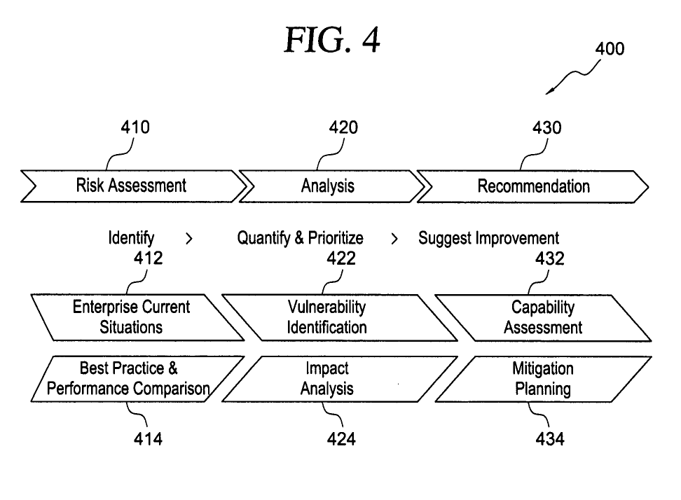

FIG. 4 is a block diagram illustrating the operational flow within an enterprise risk assessment phase of FIG. 3, in accordance with an embodiment of the present invention. In FIG. 4, elements from the enterprise risk assessment 310 of FIG. 3 are shown indicating a flow order for performing the risk assessment 310 to include performing a risk assessment 410 to identify the enterprise risks, then performing an analysis 420 to quantify and prioritize the enterprise risks 430, and finally preparing a recommendation 430 that suggests improvements to reduce the enterprise risks. Risk assessment 410 may include identifying the risks 412 associated with current enterprise situations and comparing these against standard best practices to determine how the performance of the current enterprise situations 414. Analysis 420 may include identifying vulnerabilities 422 of the current enterprise situations and performing an analysis of the impacts 424 certain situations (e.g., fire, strike, etc.) would have on the current enterprise situations. Recommendation 430 may include providing a capability assessment 432 of the current enterprise situation and providing mitigation planning 434 to correct deficiencies and mitigate risks.

In accordance with one or more embodiments of the present invention, the initial phase begins with documenting and categorizing of the current status of an enterprise with respect to its vulnerabilities to common risks that may threaten the organization from different areas of business. For example, accurate and candid information on the business areas shown in FIG. 2 may be gathered for assessment, analysis and mitigation, with respect to their priority and criticality in risk mitigation. Identifying different thresholds of criticality for each risk and developing corresponding plans for their risk mitigation measures. For the process 210 area, information may be gathered on, for example: business ethics, supply chain security, customs, research and development efficacy, third-party providers, global operations, personnel recruiting and retention, professional development, and information technology. For the supply area 220, information may be gathered on, for example: supplier quality, supplier concentration (regional or number), supplier dispersion, transportation capacity and pricing, visibility, multi-tier coordination, fuel prices, raw material availability and pricing, and lead time length and variability. For the environment area 230, information may be gathered on, for example: fire/flood hazard level, weather patterns, natural disaster likelihood, terrorism likelihood, regulation and legislation, macro economic information (e.g., interest rates, exchange rates, GDP growth, business cycles, etc.), infrastructure congestion, and geopolitics. For the demand area 240, information may be gathered on, for example: price, features/specifications, volume, visibility, multi-tiered coordination, customer dispersion, lead time length and variability, transportation capacity and pricing, and seasonality. For the control area 250, information may be gathered on, for example: theft/shrinkage, IP loss, product defect/recall, business rules, SKU proliferation, financial controls (e.g., Sarbanes-Oxley Act), general scandals, workplace violence, cyber-theft and others.

According to the enterprise management decision, the platform may provide the tools to empower the organization to accumulate the appropriate information in a variety of ways, for example: industry standards and best practices, management knowledge and recommendations, consultants and experts, and surveys using interviews and/or self assessment.

The recommended approach may be a combination of the above and the data and content gathering may be based on a multi-dimensional distributed architecture. The dimensions may include: profiling the structure of the business to determine whether it is a small business with one location, or an organization with multiple locations and branches. If it is a large organization with multiple locations, it may also have extended enterprise partners both in the downstream as well as upstream, suppliers and distributors, domestic or world wide. This activity may require a very robust profiling with a configurable taxonomy, configurable forms and data fields, where new fields are created ad hoc, with a simultaneous creation of an input page, an output page and a position on the database. This approach will enable the user to profile people, sites, supplies and assets.

In general, the initial profiling effort needs to cover three different groups of enterprise personnel: employees and partners who will be involved in the risk assessment phase, employees and partners (internal and external/outsourced) who will be owners of the risk elements and will be mobilized as part of the solution, and employees and partners who will need to be protected and have risks mitigated from their areas of business.

The relevant areas of business are any formation by department or by function that properly refers to the enterprise's supply, demand, process, controls and environment. These areas are risk drivers in which different risk may originate to threaten the business continuity of an enterprise. As these business functions are being created based on a configurable taxonomy, they also need to become affiliated with the above categories of people, site, supplies and assets. The methodology of the risk assessment is dependent on the industry and the enterprises preferences on which risk assessment approach to adopt: (as e.g. Carver, Edge tool, Six Sigma and others). This function requires a flexible and configurable form builder with a workflow engine to create diagnostics for risk assessment according to any methodology that an enterprise wishes to implement.

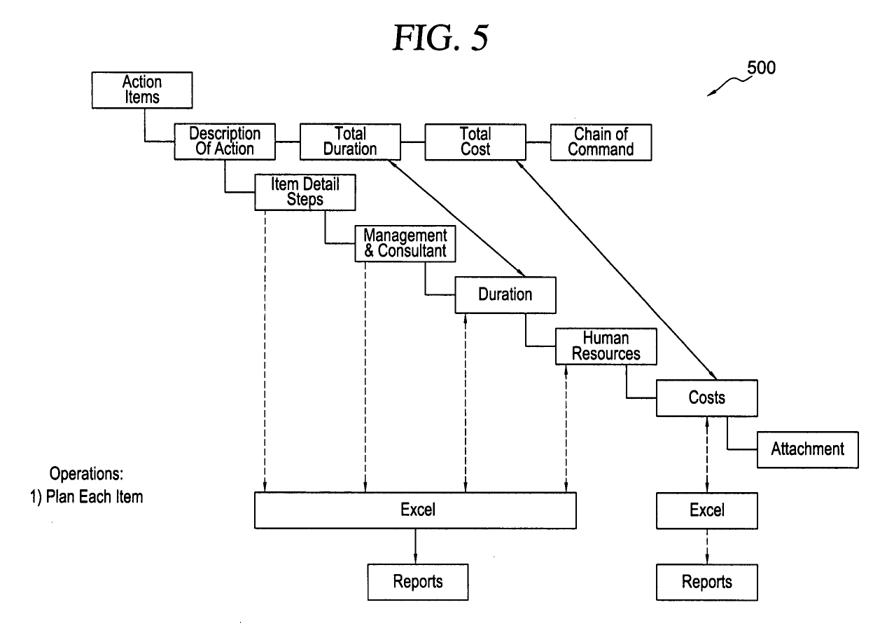

FIG. 5 is a functional block diagram 500 of the operational flow within a planning phase of the enterprise solution design framework, in accordance with an embodiment of the present invention. In the planning phase, the previously identified process relevant risk elements are prioritized according to a quantified total risk score as well as recommendation of one or more mitigation measures. Every mitigation measure is also classified as either a prevention-to reduce or eliminate the risk, or a response-to manage an incident effectively and efficiently, or a recovery to assure business continuity. In addition, every mitigation measure may have an associated action plan that may be configured to execute when required. In general, the plan will include:

a) A listing of the exact steps and sub-steps that are to be executed;

b) A human resource in charge of its execution;

c) A check of other involvements and availability of the resource;

d) A substitute resource in case of unavailability of the first resource;

e) Assets needed to get the task done;

f) A budget required to mobilize the execution of the plan;

g) A chain of command that owns the responsibility of the plan;

h) The related areas of the business that may be impacted;

i) A means to manage the impacted areas and their costs;

j) A time to start and the time to end the tasks for the steps; and

k) A reporting mechanism and the frequency of reporting.

### The result is an automated resiliency plan (i.e., action plan) with interdependencies between all of the elements in and associated with the enterprise.

In accordance with an embodiment of the present invention, an automated action plan, in general, provides an antidote to organizational paralysis. For example, in the event of a supply chain failure or a crisis caused by a natural or unnatural incident, automated action plans for prevention, response and recovery may be automatically enacted, thus, saving time and assets. The possibility for human intervention in modifying the “Optimum Plans of Action” is an option at every stage of the process.

In accordance with an embodiment of the present invention, the next phase may be a monitoring phase in which internal enterprise critical data, external data, and environmental information may be monitored. In this phase critical data will be monitored and used for prevention or response. The critical data are both internal as well as external in nature. For example, the internal data may be extracted from the process area 210 and controls area 250. The external data may be extracted from the supply area 220, the demand area 240 and the environment area 230. An example of critical supply data may be related to a supplier's shipment failure. An example of external or environmental data may be news about an up coming hurricane or tornado.

In accordance with an embodiment of the present invention, through integration with internal and external data and content sources (either through xml or web services hand shake), information may be brought in, and parameters and ranges may be set for each of the business areas. Any indication of any incoming data or content that is out side the acceptable range or parameter will immediately trigger an alert to the proper profile.

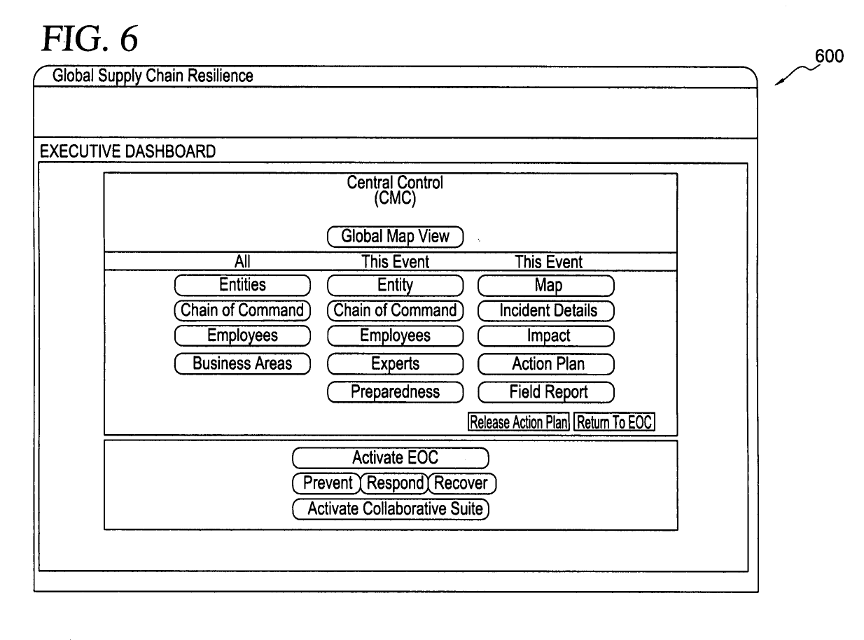

In accordance with an embodiment of the present invention, a decision support engine may include an executive dash-board that may suggest approaches and provide access to important information, assist in making critical decisions and provide the ability to carry out operations necessary to prevent, or respond to, or recover from risks threatening the enterprise. FIG. 6 is a screen shot of an executive dashboard 600 configured to provide a user with access to information on a specific risk and/or incident, in accordance with an embodiment of the present invention.

In accordance with an embodiment of the present invention, the components of the decision support engine may include profiles of people, places, assets and supplies. This may provide quick access to all the profiling done in the risk assessment phase. The decision support engine may also include intelligence on the monitoring activities and critical data and alerts to provide a suggested plan of action and a quick access to and view of the monitoring activities. The decision support engine may still further include access to preparedness and operations actions. These actions may be separated into three types: prevention, response, and recovery.

In accordance with an embodiment of the present invention, in general, preventive operations will result from the methodical process of risk assessment, analysis and planning, where a list of items have been identified as critical and cost effective to mitigate by means of an action plan to move the risks away. As a result, each business area looks at its list of risk mitigation recommendations and moves to mitigate the risk elements by activating the appropriate operations. Since these operations have been pre-planned, an executive order can quickly activate the process. These acts may be treated as individual projects with specific tasks, time lines, responsibility assignments and reporting mechanism in a collaborative application environment. For example, prevention activities can be triggered by: a pre-meditated executive decision to act on mitigation recommendations resulting from the diagnostic process, or an executive decision driven by an alert generated from the monitoring activities.

In accordance with an embodiment of the present invention, in general, response operations may be initiated by the system in response to an incident requiring emergency crisis management. Upon incident detection the system will automatically identify the type of the incident. Through its GPS integration, the system performs its territory marking and, then, creates an action plan, assembles the right team, identifies the pre-determined chain of command and alerts all the parties. As it is creating the right action plans, the system may pull from the procedural library where emergency management objects reside. It may also pull from the pre-planning efforts done by the company and from the best practice procedures repository. As it is creating the right plan, the system may follow the right roles and match them with the right profiles from the company internal employees, partners and external sources. It may also identify the right chain of command and the proper supplies and assets required to manage the incident. The system may also send pre-existing purchase orders through the right enterprise workflow to get authorization to procure any required supplies. These pre-existing purchase orders are, generally, based on pre-negotiated contracts. In general, the procurement engine is part of the platform, but it may also be implemented as a separate, but related, module.

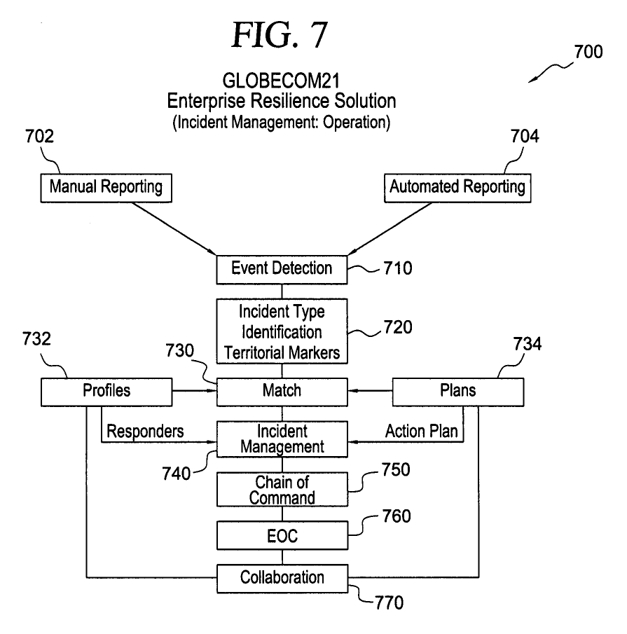

In accordance with an embodiment of the present invention, the action plan and the team are completely synchronized, so the individual alerts and activities may be assigned and communicated to the team through a hand held device as well as a PC. FIG. 7 is a functional flow diagram 700 showing how the system operates in response to an incident or event, in accordance with an embodiment of the present invention. An action plan associated with the incident or event may be automatically transferred into a collaborative suite and delivered to a pre-specified chain of command. As individual responders conduct the operations they can quickly report on their PDAs and they can quickly respond as specific questions and procedures in the form of questions or multiple choices appear on their PDAs. These responses may be automatically and instantly communicated to the chain of command and, in-turn, be used to update and edit the plan and resend to all the operators to be in synch with each others' progress.

In FIG. 7, an event/incident may be detected (710) by the system as a result of receiving (702) manual reporting information and/or receiving (704) automated reporting information. The type of incident and territorial markers around the incident may be identified (720). The system may match (730) personnel profiles 732 and plans 734 identified to be associated the specific incident occurs and the list of responders and action plan may be notified to respond to begin managing (740) the plan to mitigate the incident. The chain of command may be identified and notified (750) and the executive or emergency operations center (EOC) (760) will function either as the Emergency Operations Center of First responders or the Executive Operation Center for an Enterprise risk management. Collaboration will begin after the system auto-assembles the plan of action based on the incident type. It then automatically sends an alert and disseminates the entire plan to the EOC. While simultaneously sending the individual action items to the respective profiles based on their assigned roles and responsibilities. Allowing them to circle back and collaborate with all the other co-responders.

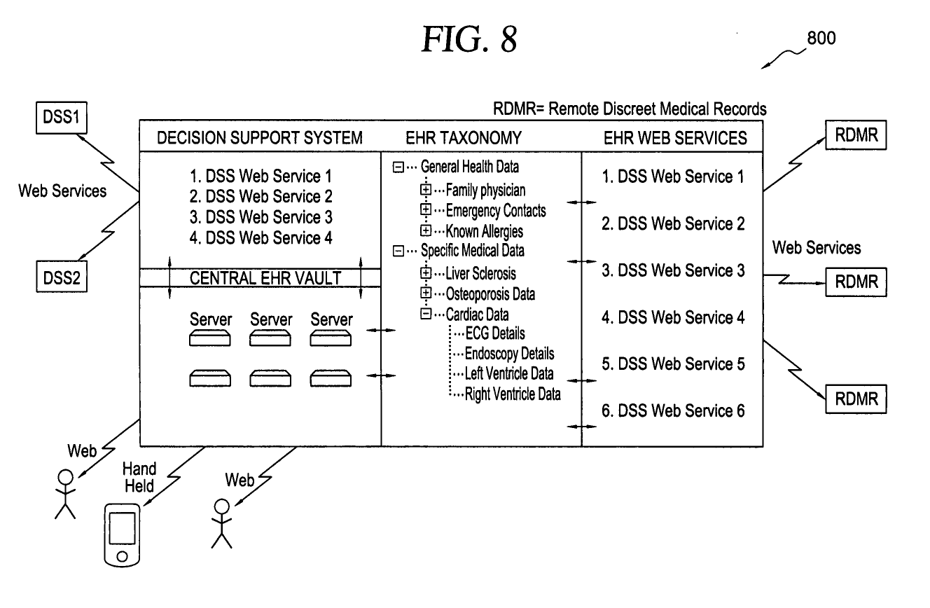

For example, in an incident involving injuries, until the operation is successfully managed, immediate attention is given to saving lives and moving people out of the harms way. FIG. 8 is a functional diagram 800 showing how the health status of people injured in the incident may be collected, transmitted and used, in accordance with an embodiment of the present invention. To facilitate this, people's health status may be recorded and a GPS locator may locate the emergency center closest to the incident and send the injured status and medical needs to the center immediately. The emergency center's inventory of beds and doctors and paramedics are communicated back to the field and the injured are transferred to the right emergency facilities.

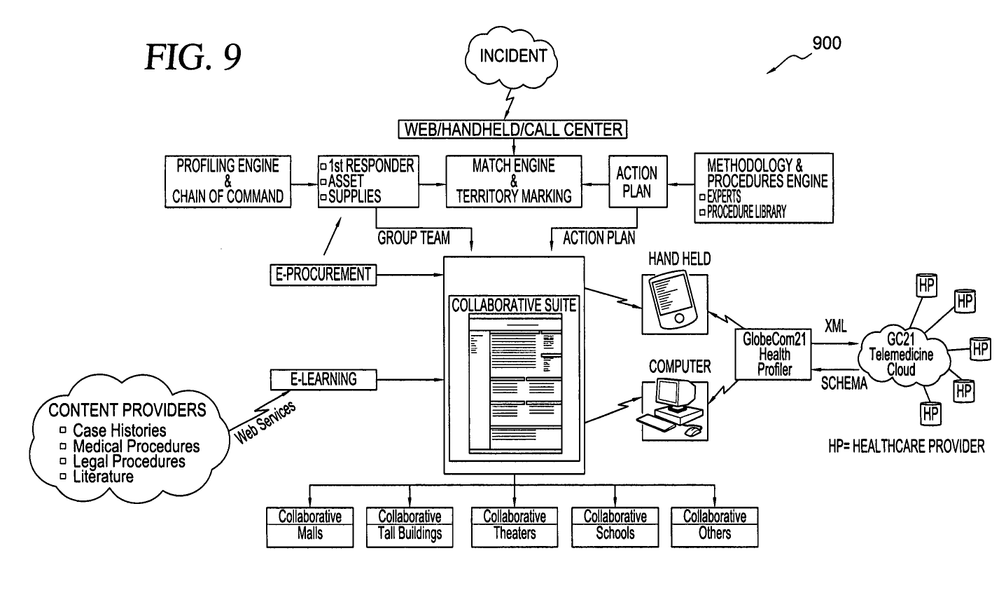

In general, response activities may be triggered by an executive decision driven by an alert generated from the monitoring activities, and/or an incident or crisis in progress. FIG. 9 is a diagram 900 of how an incident may be handled by a risk assessment, risk mitigation planning, and risk mitigation implementation system, in accordance with an embodiment of the present invention. Incident Management Response: activities that address short term, direct effects of an incident. These activities include immediate actions to preserve life, property, and the environment and meet basic human needs. For example, the activities may include: receiving & acting on an alert: Incident Reports are investigated and/or activated; incidents are matched to: multi First Responders from multi agencies; multiple procedures are assigned to: First Responders to create an action Plan; deliver Command: Alerts and Commands with action items to all on Hand Held Devices; alerts & Commands Control are received: by the Chain Of Command on PC and Hand Held Devices; and the chain of command is summoned to the EOC center for the incident management operations.

In accordance with an embodiment of the present invention, in general, recovery operations are the act of business continuity after an incident has occurred. This operation is all about making sure that the business continuity of a company is assured. After the occurrence of the incident the integrity of an infrastructure be it a building or technology or others may be compromised. The necessity of contingency plans and full planning for implementing the plans is critical. The process from the diagnostic phase to analysis to planning may be based on three types of plans for three different events: prevention to prevent an incident from occurring, response to react to an incident that has already occurred, and recovery to get back on track and assure business continuity after the initial response and diffusing a crisis. The recovery operation works very similar to the response process. A contingency action plan may be matched with the team to operate the recovery. There is an additional component in the recovery planning, it is the assignment and the actual marching orders to the entire employee team according to a contingency plan. There may be a need to change management or change behavior or a changed of location or process or controls or environment. In the recovery plan there is a special need to communicate and be on the collaboration environment with the third parties and contractors who will be involved with variety of ways to achieve normalcy and business continuity.

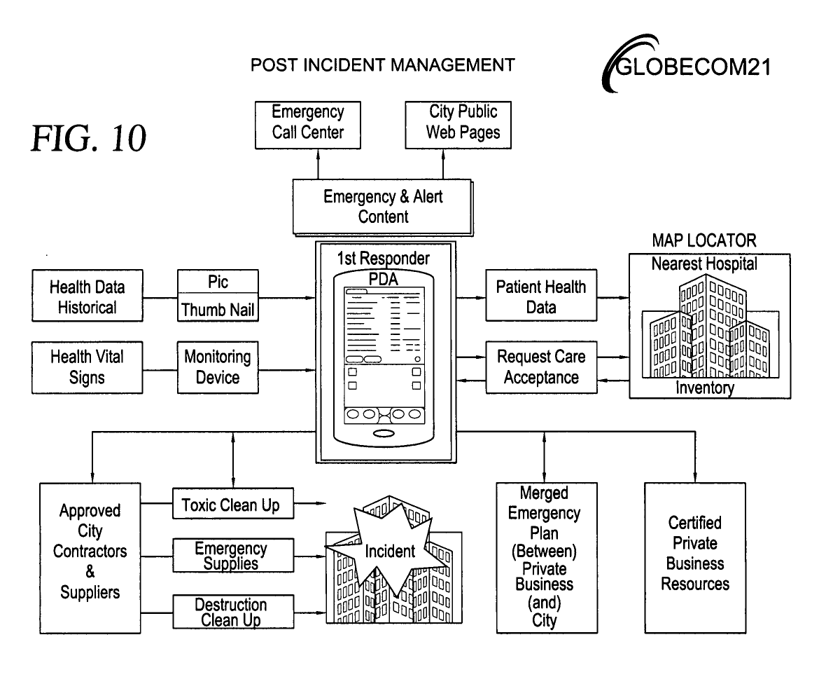

FIG. 10 is a flow diagram of how a risk assessment, risk mitigation planning, and risk mitigation implementation system may manage recovery operations after an incident, in accordance with an embodiment of the present invention. In FIG. 10, Post-Incident Management (Recovery): The recovery phase, involves actions needed to help individuals and communities return to normal when feasible. It is the development, coordination, and execution of services and site restoration plans and reconstitution of government operation and services.
1. First Responder Group: Facility for First Responders to collaborate with peers and report to Command Facility for Chain of Command to receive progress report and Monitor
2. Emergency Medical Group: Facility for EMU to use telecom devices to attend to the injured Facility for alerting emergency rooms, hospital, doctors to transfer patients
3. Recovery Group: Facility for searching and rescue and assist disabled people Facility for informing and updating the public
4. Clean up Group: Facility for Public and Private Entities to cooperate and Collaborate to cleanup toxicities
5. Other Collaborative Groups: Facility for a number of groups (on need basis) to collaborate and report on all tasks

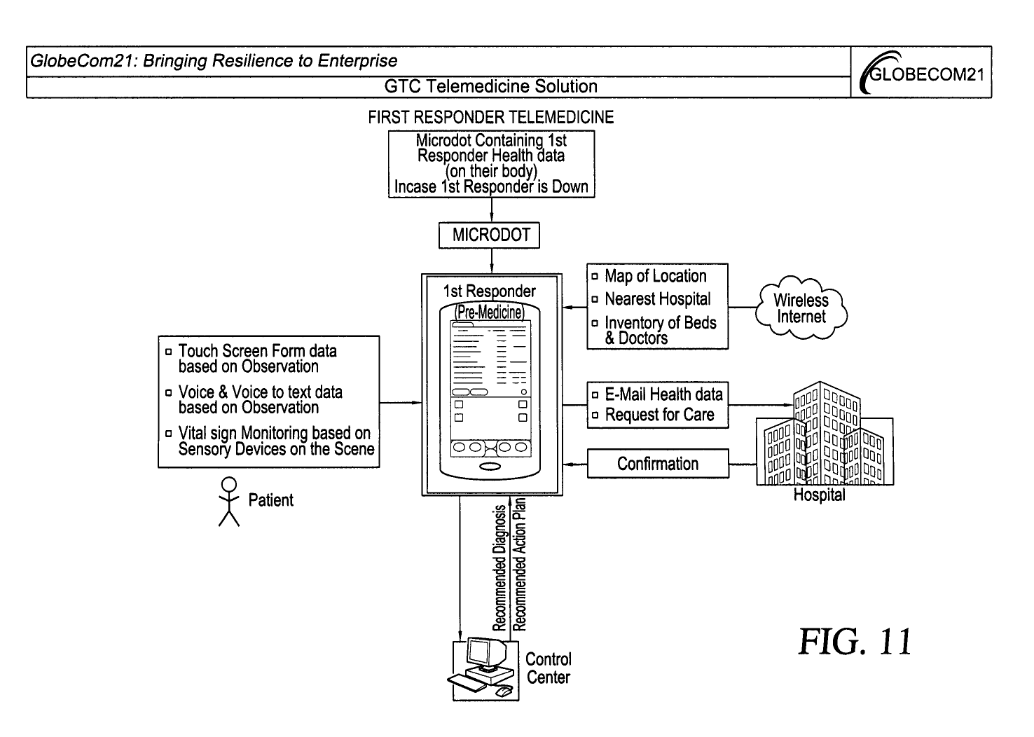

FIG. 11 is functional flow diagram illustrating the remote dispatch of electronic health records from a location of an incident to one or more nearest care centers, in accordance with an embodiment of the present invention.

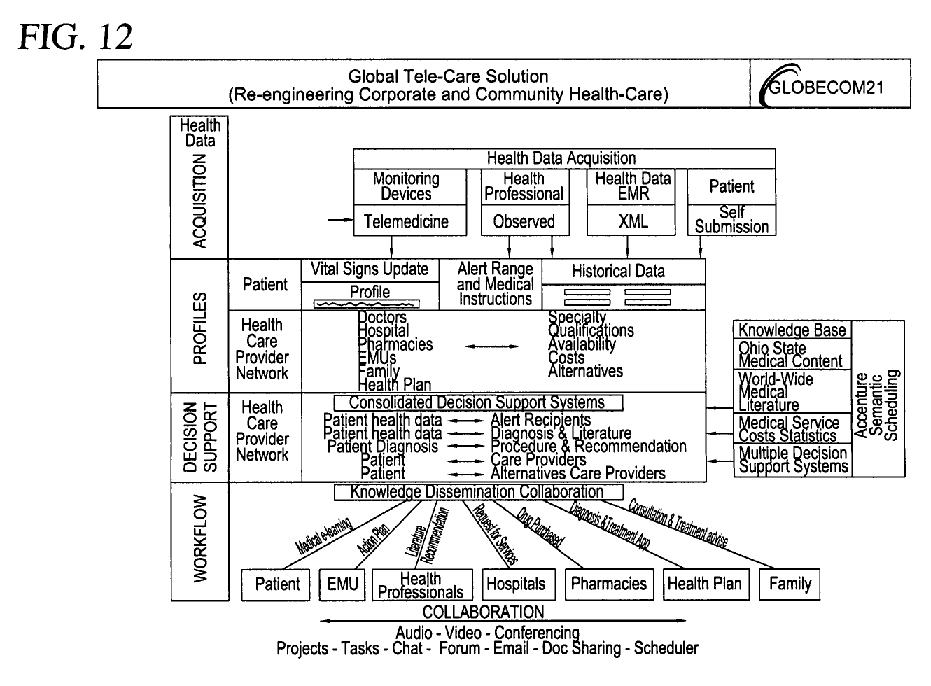

FIG. 12 is a functional block diagram showing a flow for the accumulation and dissemination of a patient's health profile and medical records through out a collaborated continuum of care, in accordance with an embodiment of the present invention. To create the Emergency Telemedicine Solution (an appendix to the GC21 risk & crisis management system) Globecom21 has utilized the following components of its GC21 platform: Profiling engine, Work-Flow engine, Methodology & Procedures engine, collaborative suite, e-learning and integration with 3^{rd} party products to configure its Health Care & Telemedicine frame-work. Emergency Telemedicine Solution is a comprehensive application that provides both the back-end application for the health data acquisition as well as the front-end for the health data distribution and collaboration through the web and hand held devices through the entire health care network. Globecom21 telemedicine tools are ideal for delivering both emergency as well as consistent health data within the GC21 Smart Medical Network.

GC21 Smart Medical Network consists of GC21 software solution integrated wirelessly with medical devices touch-screen patient Assessment, and live video conferencing. Ability to report vital signs for emergency care as well as continuous monitoring through video streaming. Fully supports HIPPA compliance.

GC21 telemedicine applications are extremely valuable when there is regular and frequent need to monitor vital signs and other critical health data for preventive as well as crisis management situations.

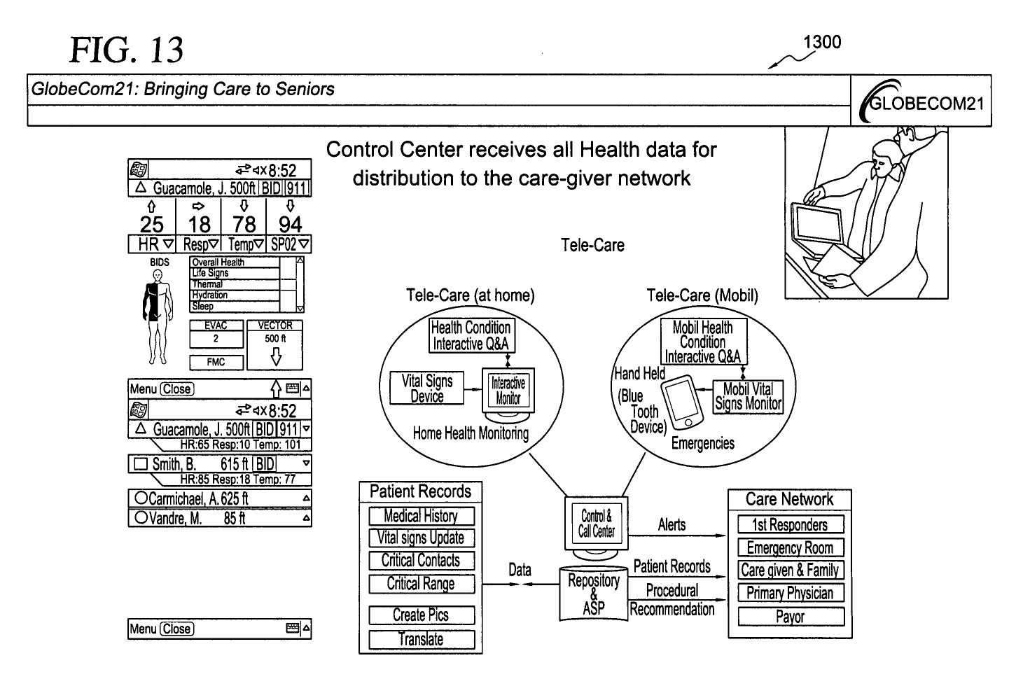

In accordance with an embodiment of the present invention, an Executive Operations Center (EOC) may provide the presentation component of operations. It may offer a virtual executive center to use as a macro view of the incident and the events to assist the executives and their colleagues, branch managers and partners to be on the same page and the same collaborative environment to efficiently manage a crisis. The platform may turn readily available technology, for example, PDAs, pagers, and cell phones, into vital tools for communication and knowledge sharing between the EOC and critical players within the enterprise and its value chain. FIG. 13 is a screen shot 1300 of an Executive Operations Center (EOC) that may be used to manage the implementation of a risk mitigation response to an incident, in accordance with an embodiment of the present invention.

In accordance with an embodiment of the present invention, a private/public partnership may be established to facilitate the cooperation between private enterprises with incident risk mitigation plans and the government agencies charged with responding to the incident. This is important, because in every public incident and crisis management operation government plays a critical role. The local agencies and first responders are typically the people who will be rushing to the scene in case of an incident. The only problem is that often these agencies are completely unaware of the plans made by the enterprise to deal with the incident. Typically when enterprises prepare to face incidents, their planning, steps and procedures are very mindful of the special circumstances of the enterprise, it would be extremely helpful and at times critical that the government becomes aware of the enterprise's plan in case of a crisis. Therefore, the enterprise may share its information that has been carefully gathered and the response plan that was methodically designed with the local government that has rushed to the rescue at the event of an incident. Embodiments of the system can send an SMS or an email on a handheld device or a PC and invite the government agencies to connect to and be a part of their EOC center and have access to the same exact critical information that they need to effectively deal with the incident. With the governments consent and cooperation, these agencies and even special agents may be profiled by the enterprise in advance. This approach gains special recognition and is particularly welcomed by the government when the enterprise is a critical infrastructure, such as, places of large assembly, schools, universities and others. This system materialized the true essence of a public/private partnership, to create a practical environment for a realistic cooperation and collaboration between the enterprise nad the government agencies to mitigate risks, respond and recover from incidents and crisis.

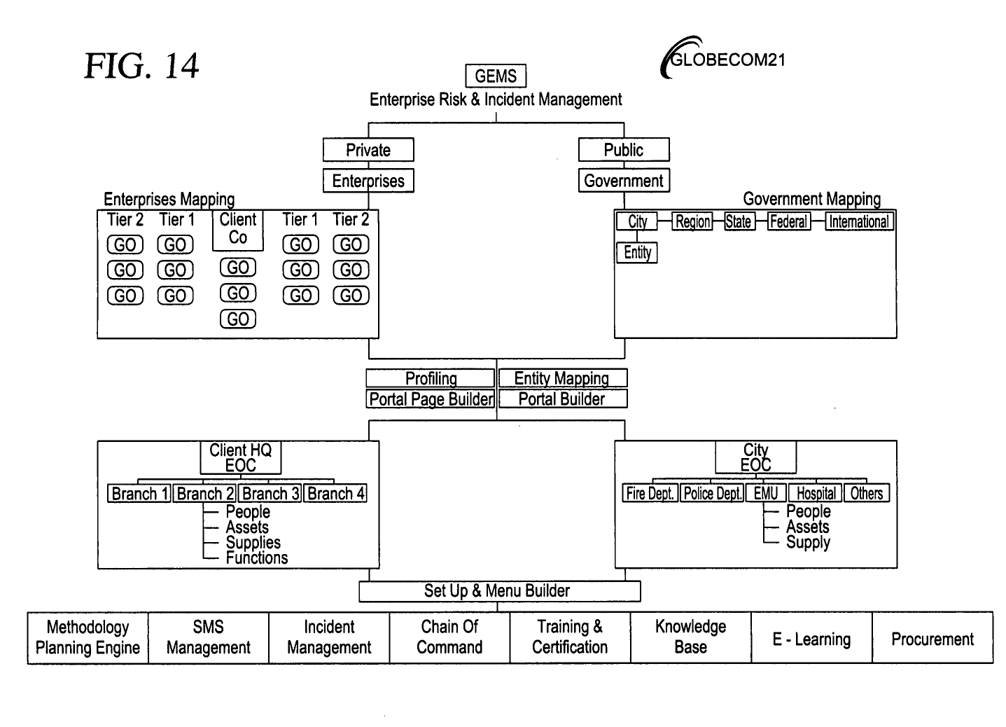

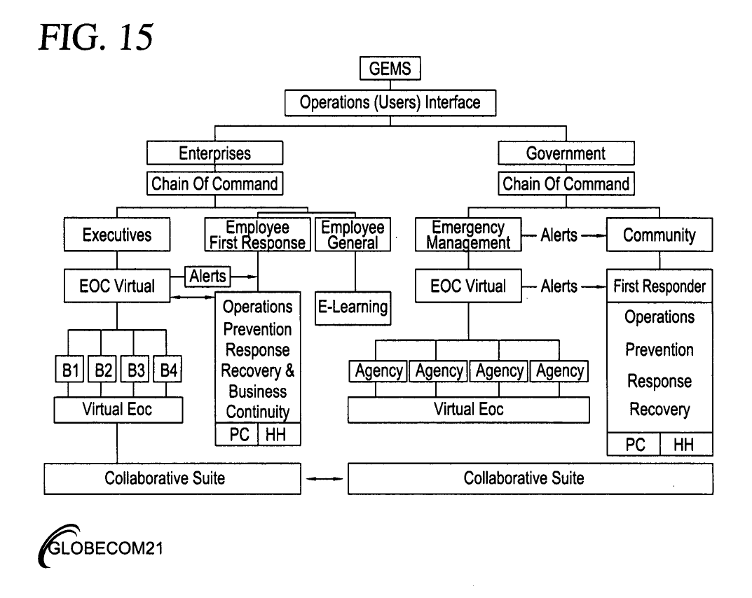

Another reason for this cooperation is for the recovery phase. In this phase, generally, there are three parties involved in the operations, the enterprise, the third party contractors, and the government. It would be particularly important and efficient to have each one easily access and use collaborative environment, so they can act as one team. This way the parties may treat the entire effort as a project and get all the tasks done to satisfaction with full documentation and an automated reporting mechanism. FIG. 14 is a block diagram showing the hierarchical structure of an enterprise risk and incident management system, in accordance with one or more embodiments of the present invention. FIG. 15 is a is a block diagram showing the hierarchical structure of operational user interfaces for an enterprise risk and incident management system, in accordance with one or more embodiments of the present invention.

In accordance with an embodiment of the present invention, a transaction-based audit log may be included in the system to capture end-to-end transactions. An enterprise is often liable for the protection of the lives and safety of its employees, customers and relevant citizens that it may touch their lives, either by its actions or very existence. To be able to keep accurate records of exactly what an enterprise has done to protect the above lives and health is of paramount importance. Not to mention the management's responsibility towards their shareholders to protect the assets of the enterprise. Even equally as important is to insure the business continuity of the enterprise and an obligation to disclose risks that threatens the enterprise and an ability to demonstrate the plans for its mitigation. All of these will absolutely affect the value of the shares of a company as its shareholders and potential shareholders evaluate the risks and the management's ability to mitigate risks and respond at the event of an incident. Keeping a careful log of the entire effort from risk assessment, to analysis, planning, building a capability to mitigate risks through prevention, preparing the enterprise by creating an adequate level of preparedness and being able to respond to an incident and recover from it to assure business continuity are great ways to mitigate risks. These risks may be driven by controls, whether through corporate governance or government regulations or business law. Being able to document the process of preparedness may provide other benefits, such as, greatly simplifying the demonstration of responsible enterprise governance.

Recently, the US government enacted strict regulations requiring Chemical companies to comply with safety and security issues that are at the top of the list of Home Land Security Department. These regulations and the Sarbanes-Oxley Act are expected to be joined by many more government regulations that will need to be implemented where the implemented procedures are subject to being audited by one or more government agencies. For example, one such regulation deals with individual insurance companies' audit preparedness. The US government is currently willing to cover up to $100 Billion of major terrorism costs, while private companies are liable to cover up to $40 Billion. However, these figures will be switched as the Terrorism Insurance Act expires in 2007. To purchase terrorism insurance from insurance companies is either impossible all together or extremely expensive without auditable preparedness and compliance.

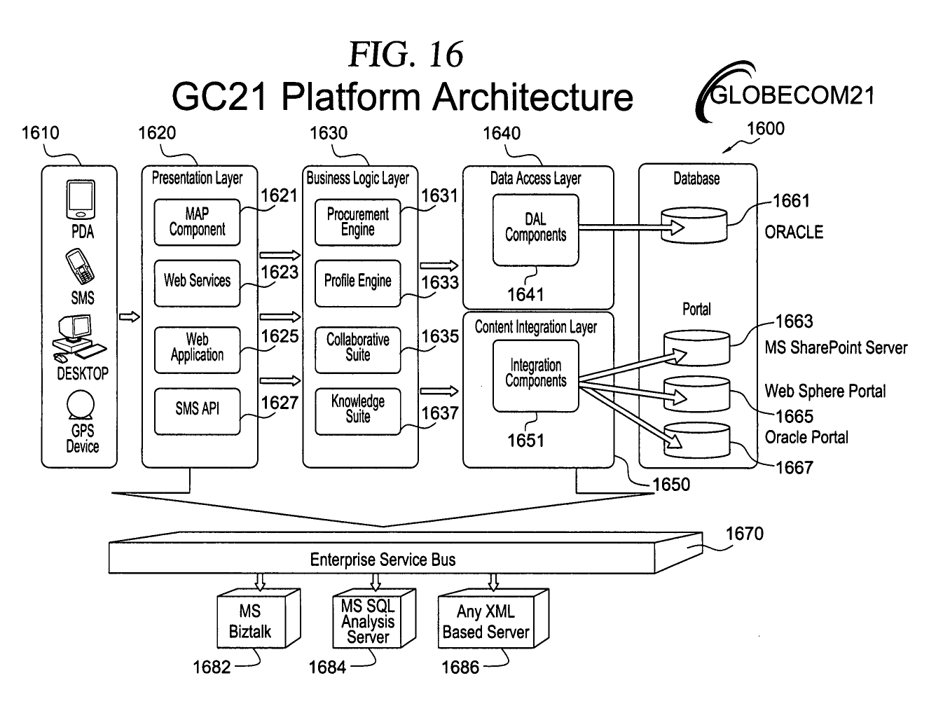

FIG. 16 is a functional block diagram of platform architecture for a risk mitigation system 1600, in accordance with one or more embodiments of the present invention. In FIG. 16, multiple different user devices 1610, for example, but not limited to, PDAs, cell phones with SMS, PCs, and GPS devices, may access a presentation layer 1620 of the risk mitigation system 1600. The presentation layer may include a map component 1621, a web services component 1623, a web application component 1625, and an SMS application programming interface (API). The presentation layer 1620 may in turn access a business logic layer 1630 that may include a procurement engine 1631, a profile engine 1633, a collaborative suite 1635, and a knowledge base 1637. The business logic layer may access a data access layer (DAL) 1640 with DAL components 1641, and a content integration layer 1650 with integration components 1651. DAL 1640 may access a database, for example, an Oracle database 1661, via DAL components 1641, and the content integration layer 1650 may access several portals, for example, a MicroSoft SharePoint Server portal 1663, a Web Sphere Portal 1665, and an Oracle portal 1667 via integration components 1651.

In FIG. 16, the presentation layer 1620, the business logic layer 1630, the DAL 1640 and the content integration layer 1650 may be in communication with an enterprise service bus 1670 to communicate with resources external to the system 1600, such as, for example, a MicroSoft Biztalk server 1682, a MicroSoft SQL Analysis Server 1684, and any XML-based server 1686.

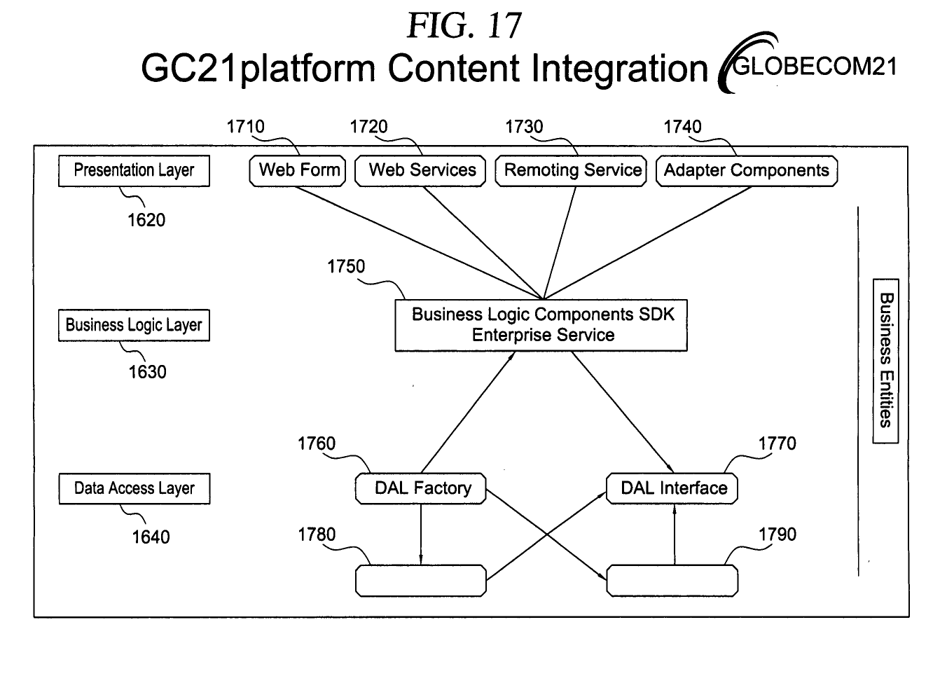

FIG. 17 is a functional block diagram 1700 of content integration between the various layers of the risk mitigation system 1600 of FIG. 16, in accordance with one or more embodiments of the present invention. In FIG. 17, web forms 1710, web services 1720, remoting services 1730, and adapter components 1740 are available at the presentation layer 1620 and are each in communication with business logic components/SDK Enterprise Service 1750, which is available at the business logic layer 1630. The business logic components/SDK Enterprise Service 1750 is in communication with a DAL factory 1760 and a DAL interface 1770, both of which are located at the DAL 1640. The DAL factory 1760 and the DAL interface 1770 are each in communication with an Oracle data access layer 1780 and an SQL data access layer 1790 at the DAL 1640.

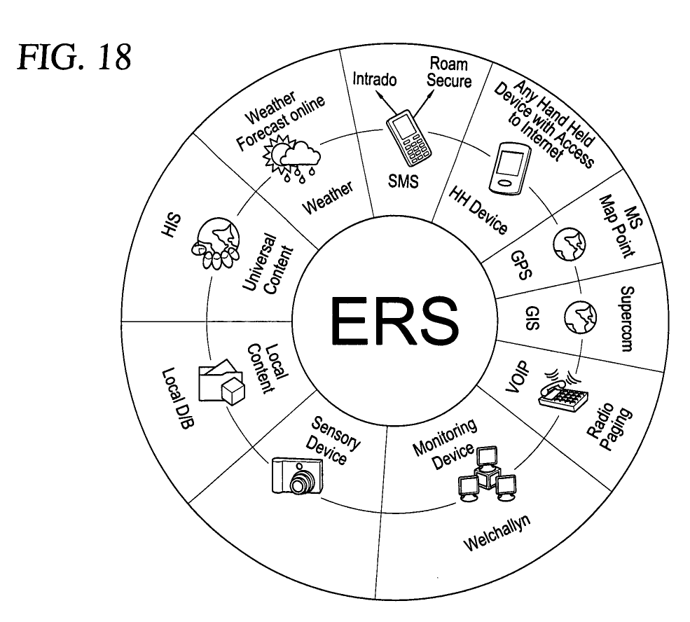

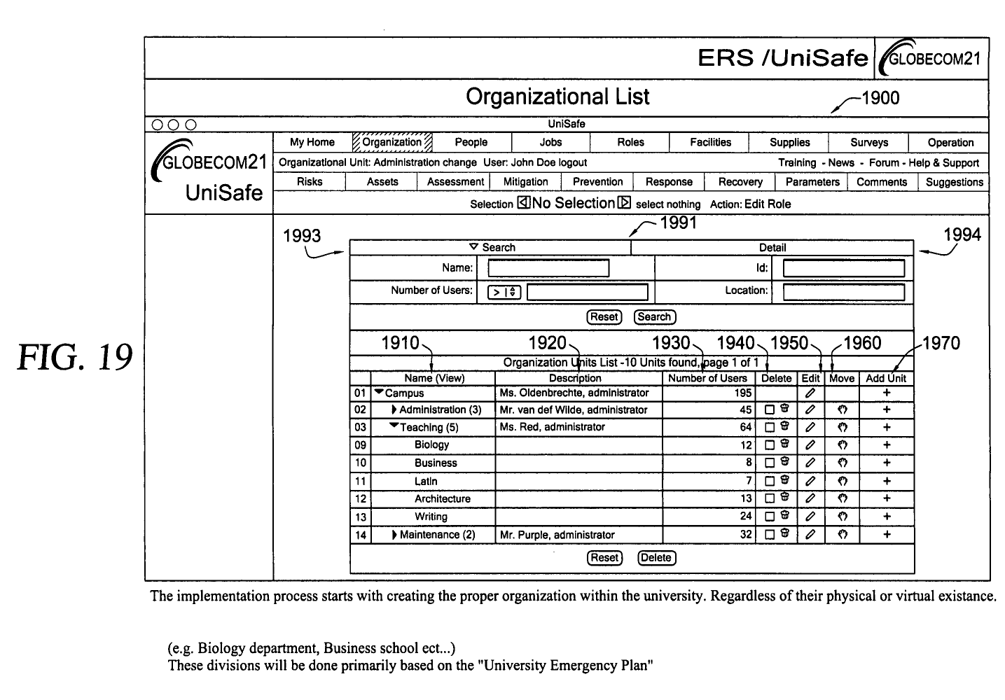

FIG. 18 is a stylized depiction of the different information and devices that may be in communication with an Enterprise Response Solution (ERS), the GC21 second version, in accordance with one or more embodiments of the present invention. FIGS. 19 through 51 are a series of screen shots of input screens from an ERS system for a university, or any other enterprise, in accordance with an embodiment of the present invention.

In FIG. 19, an initial Organization Units List screen 1900 is presented for a user to create an organizational structure for the university. The list may include fields for names of organization units 1910, names of responsible people and their titles 1920 for each organization unit 1910, a number of users 1930 associated with each organization unit 1910, and fields to delete 1940, edit 1950, move 1960, and add unit 1970 records to each of the names of organization units 1910. An access control panel 1991 is provided to aid in accessing information on the organization unit list and includes an extendable search menu portion 1993 and an extendable detail menu portion 1994. The search feature bar 1993 enables the user to enter search terms to locate organization units on the list. The detail feature bar 1994 enables the user to access detailed information on a highlighted organization unit.

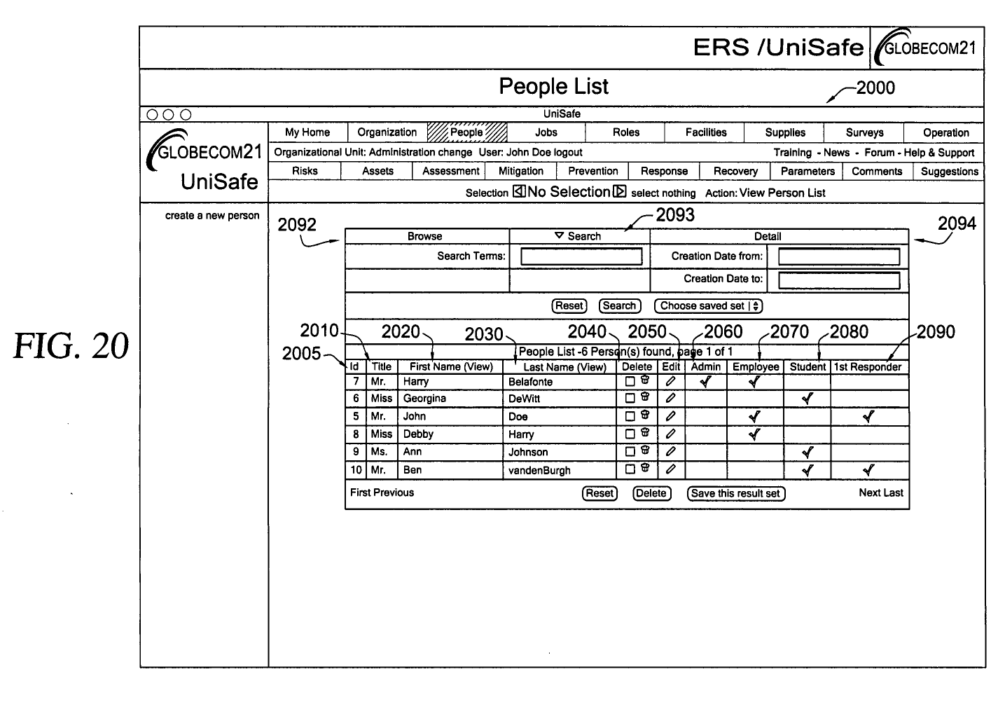

In FIG. 20, a People List screen 2000 is presented to a user to show an organizational structure for the people at the university. The list may include fields for an identification (id) number 2005, title 2010, a first name 2020, a last name 2030, and fields to delete 2040 and edit 2050 the record, and fields to specify the role(s) that each person plays at the university, for example, an admin field 2060, an employee field 2070, a student field 2080, and a first responder field 2090. An access control panel 2091 is provided to aid in accessing information on the organization unit list and includes an extendable browse menu portion 2092, an extendable search menu portion 2093 and an extendable detail menu portion 2094. The browse feature bar 2092 enables the user to enter search terms to locate people on the list. The search feature bar 2093 enables the user to enter search terms to locate people on the list. The detail feature bar 2094 enables the user to access detailed information on a highlighted person on the list.

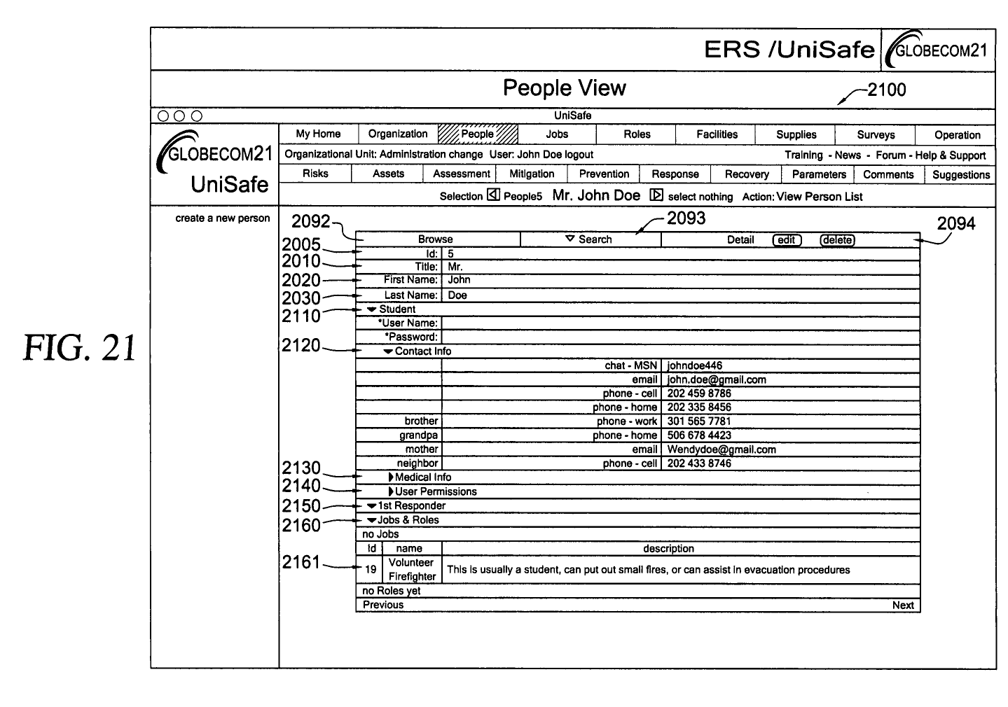

In FIG. 21, a People View screen 2100 is presented for a user, for example, id #5, John Doe, from FIG. 20 that provides the available detailed information on John Doe. The screen may include the identification (id) number 2005, title 2010, first name 2020, and last name 2030 fields from FIG. 20 and expandable menu bars for listing additional information about Mr. Doe that is relevant to each area. For example, the menu bars may include a student menu bar 2110, a contact information menu bar 2120, a medical information menu bar 2130, a user permissions menu bar 2140, a first responder menu bar 2150, and a jobs and roles menu bar 2160. Under the activated jobs and roles menu bar 2160 is displayed additional information about Mr. Doe's roles, for example, he is a volunteer firefighter 2161.

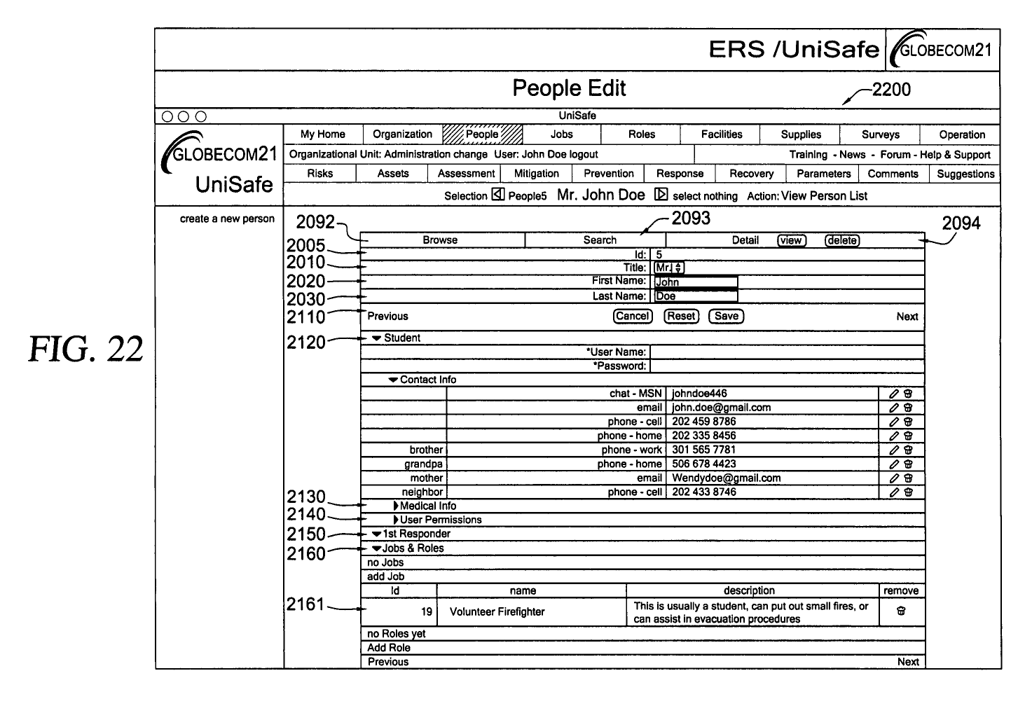

In FIG. 22, a People Edit screen 2200 is presented for use by a user to edit the detailed information on people in the system, for example, information on person id #5, John Doe, from FIGS. 20 and 21, is displayed and available to be edited.

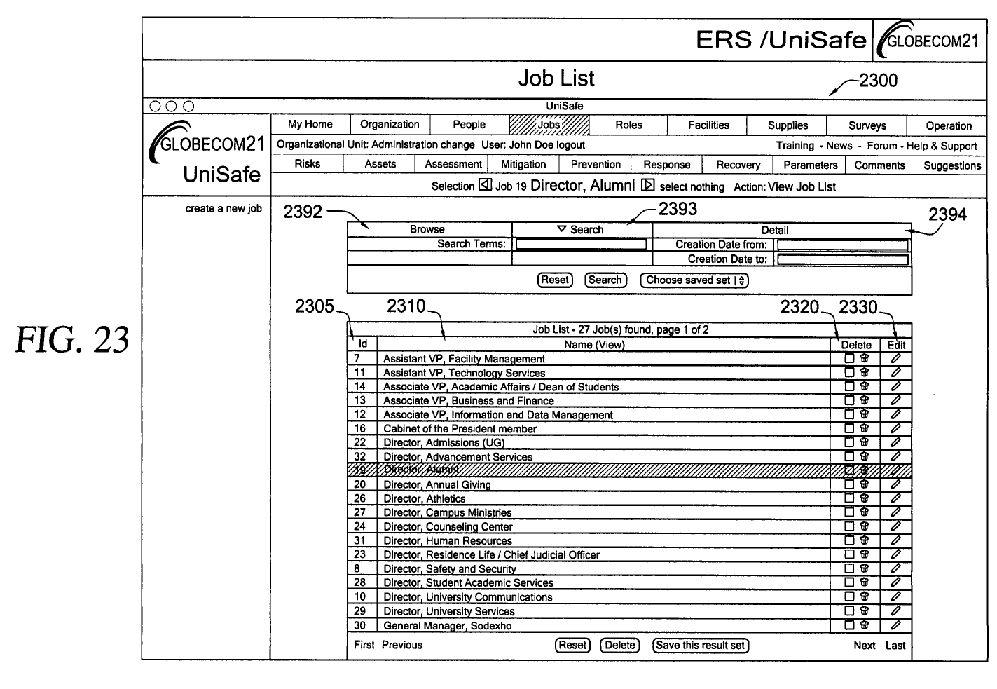

In FIG. 23, a Job List screen 2300 is presented for adding/editing information about available jobs that a person at the university can have. For example, in FIG. 23, the job list includes: fields for a job id 2305, a job name 2310, and delete and edit fields 2320, 2330, respectively, that permit the displayed job name information to be edited. An access control panel 2391 is provided to aid in accessing information on the organization unit list and includes an extendable browse menu portion 2392, an extendable search menu portion 2393 and an extendable detail menu portion 2394. The browse feature bar 2392 enables the user to enter search terms to locate jobs on the list. The search feature bar 2393 enables the user to enter search terms to locate jobs on the list. The detail feature bar 2394 enables the user to access detailed information on a highlighted job on the list.

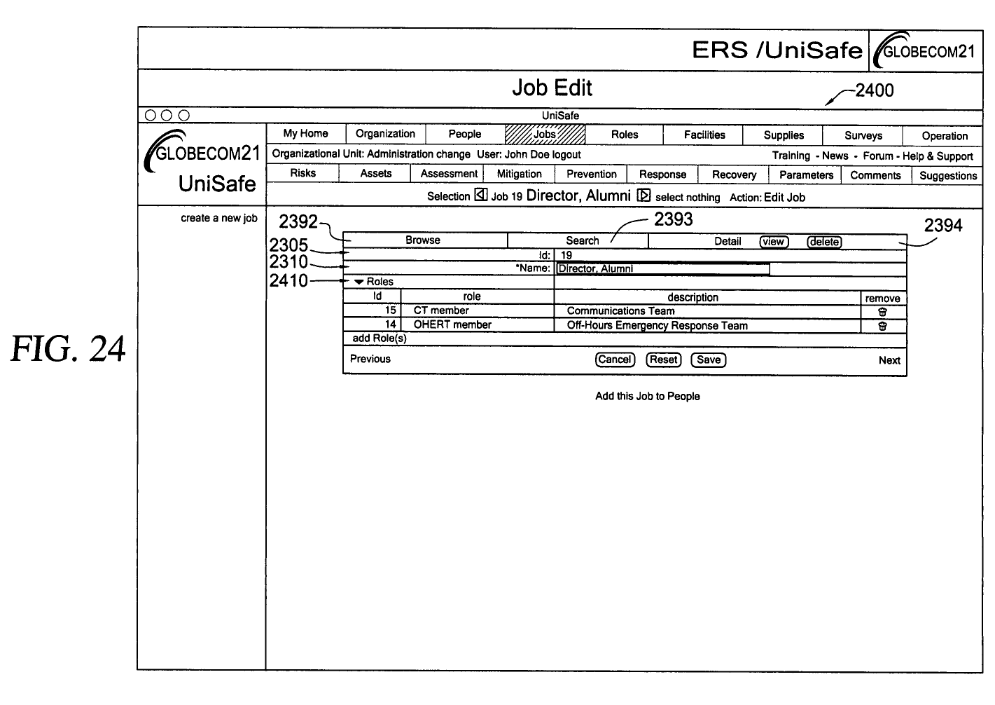

In FIG. 24, a Job Edit screen 2400 is presented for use by a user to edit information on jobs in the system, for example, detailed information on job id #19, Director, Alumni, from FIGS. 20 and 21, by clicking on the detail feature bar in FIG. 23 with. An open roles menu tab 2410 is shown under which information on the roles that a person in this job may perform during an incident.

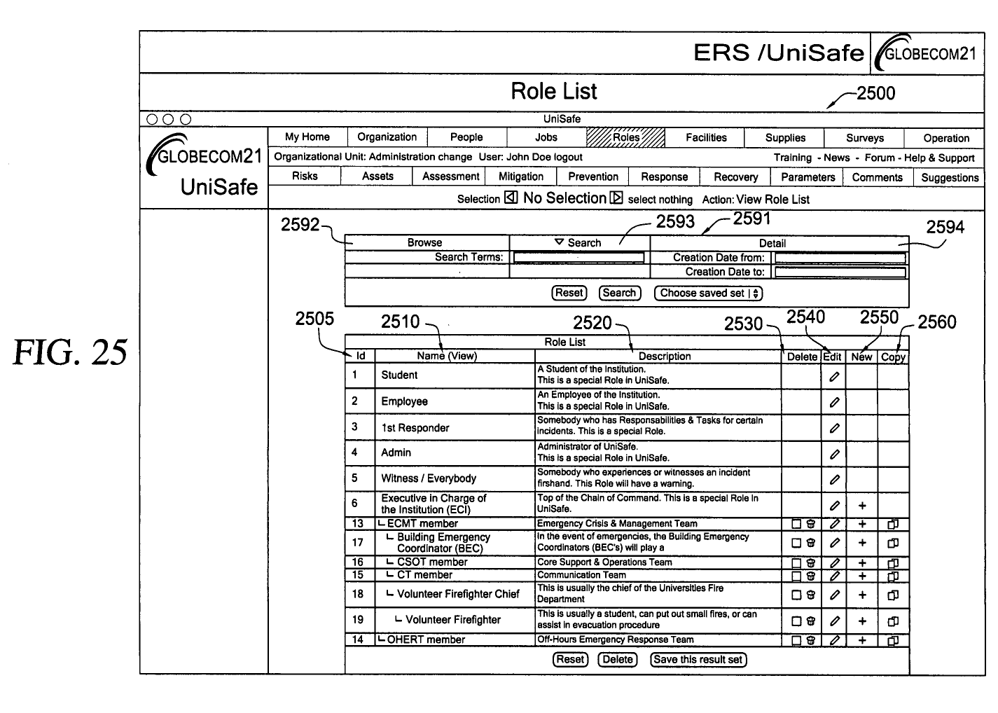

In FIG. 25, a Role List screen 2500 is presented to a user to show a list of possible roles for the people at the university. The list may include fields for an identification (id) number 2505, a role name 2510, a role description 2520, and fields to delete 2530 and edit 2540 the record, and fields to specify the whether the role(s) are new 2550 and/or copied 2560. An access control panel 2591 is provided to aid in accessing information on the role list and includes an extendable browse menu portion 2592, an extendable search menu portion 2593 and an extendable detail menu portion 2594. The browse feature bar 2592 enables the user to enter search terms to locate roles on the list. The search feature bar 2593 enables the user to enter search terms to locate roles on the list. The detail feature bar 2594 enables the user to access detailed information on a highlighted role on the list.

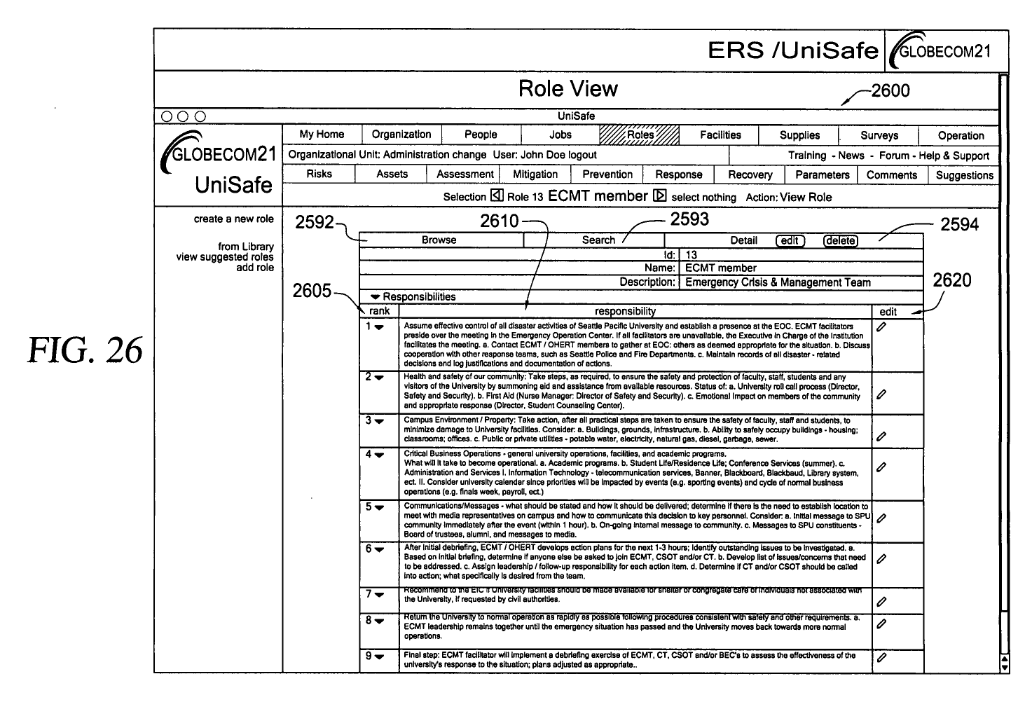

In FIG. 26, a Role View screen 2600 is presented for a specific role, for example, id #13, ECMT Member, from FIG. 25 that provides additional information on ECMT Member. The screen may include fields for a rank number 2605, responsibility 2610, and an edit field 2620 to edit the responsibility information.

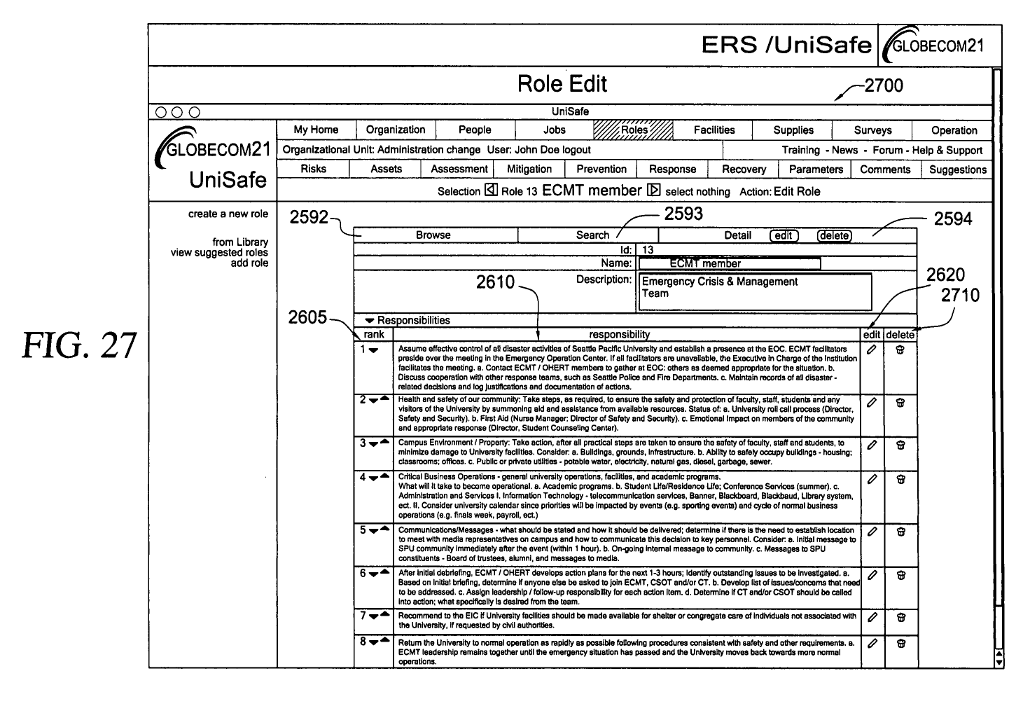

In FIG. 27, a Role Edit screen 2700 is presented for use by a user to edit information on a role in the system, for example, information on role id #13, ECMT Member, from FIGS. 25 and 26, is displayed and available to be edited. In addition to the rank number 2605, responsibility 2610 and edit fields 2620, a delete field 2710 is provided to enable the user to delete the responsibility description associated with a specific rank.

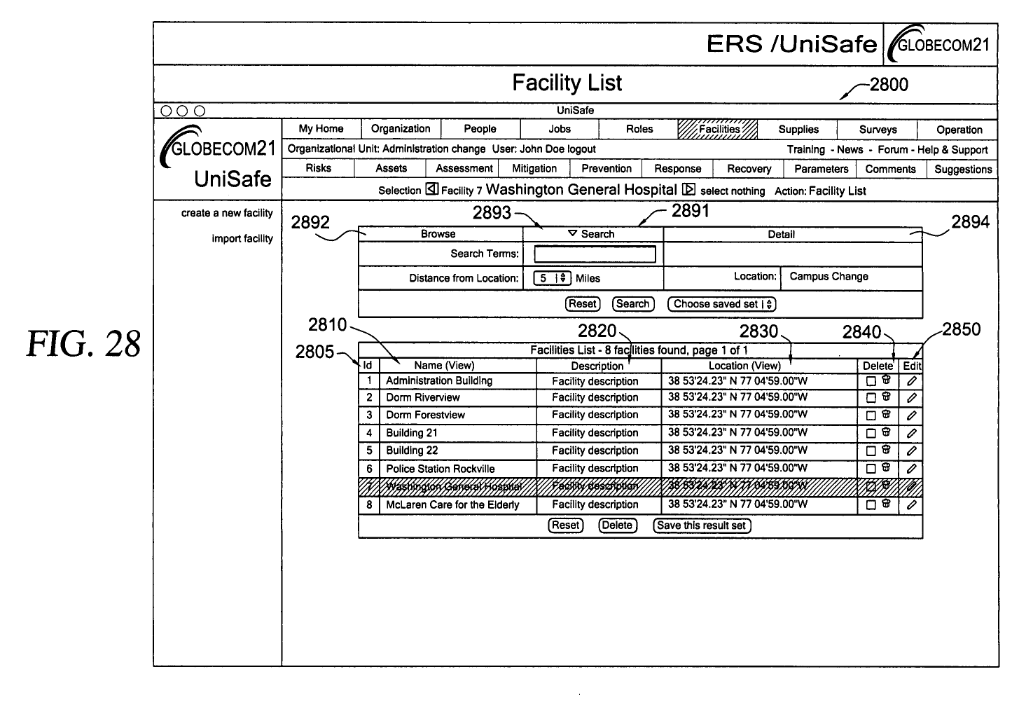

In FIG. 28, a Facility List screen 2800 is presented to a user to show a list of possible facilities available for use by the university. The list may include fields for an identification (id) number 2805, a building name 2810, a building description 2820, a building location 2830 (e.g., longitude and latitude), and fields to delete 2840 and edit 2850 the record. An access control panel 2891 is provided to aid in accessing information on the role list and includes an extendable browse menu portion 2892, an extendable search menu portion 2893 and an extendable detail menu portion 2894. The browse feature bar 2592 enables the user to enter search terms to locate facilities on the list. The search feature bar 2893 enables the user to enter search terms to locate facilities on the list. The detail feature bar 2894 enables the user to access detailed information on a highlighted facility on the list.

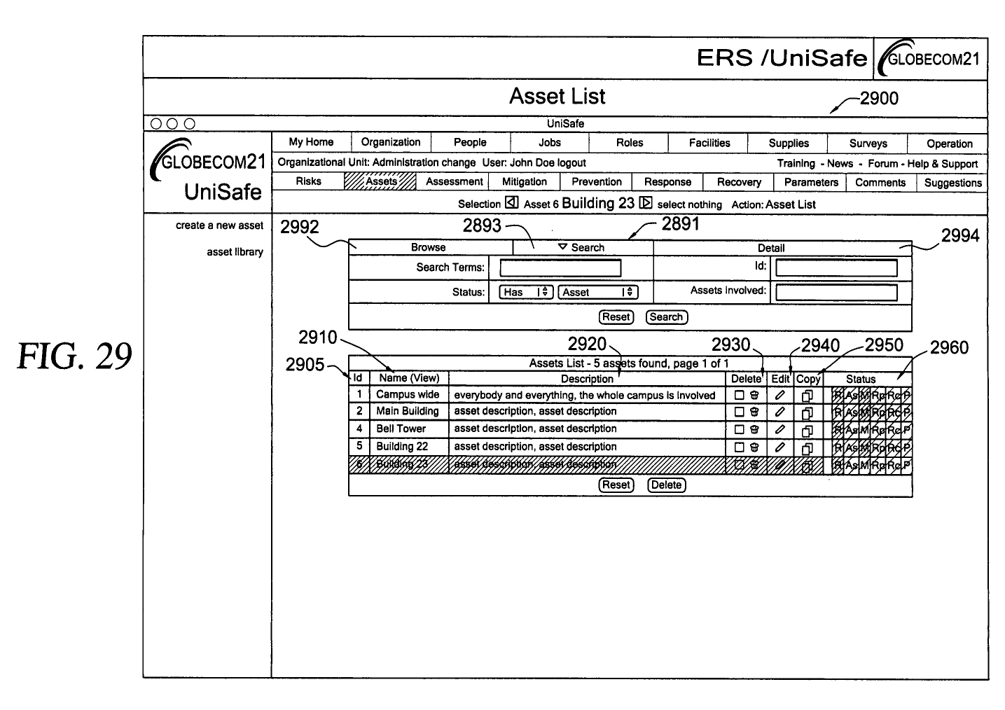

In FIG. 29, an Asset List screen 2900 is presented to a user to show a list of possible assets available for use by the university. The list may include fields for an identification (id) number 2905, an asset name 2910, an asset description 2920, and fields to delete 2930, edit 2940 and copy 2950 the record for each asset. In addition, a status field 2960 is provided for each asset that displays several different pieces of status information for each asset. An access control panel 2991 is provided to aid in accessing information on the asset list and includes an extendable browse menu portion 2992, an extendable search menu portion 2993 and an extendable detail menu portion 2994. The browse feature bar 2992 enables the user to enter search terms to locate assets on the list. The search feature bar 2993 enables the user to enter search terms to locate assets on the list. The detail feature bar 2994 enables the user to access detailed information on a highlighted asset on the list.

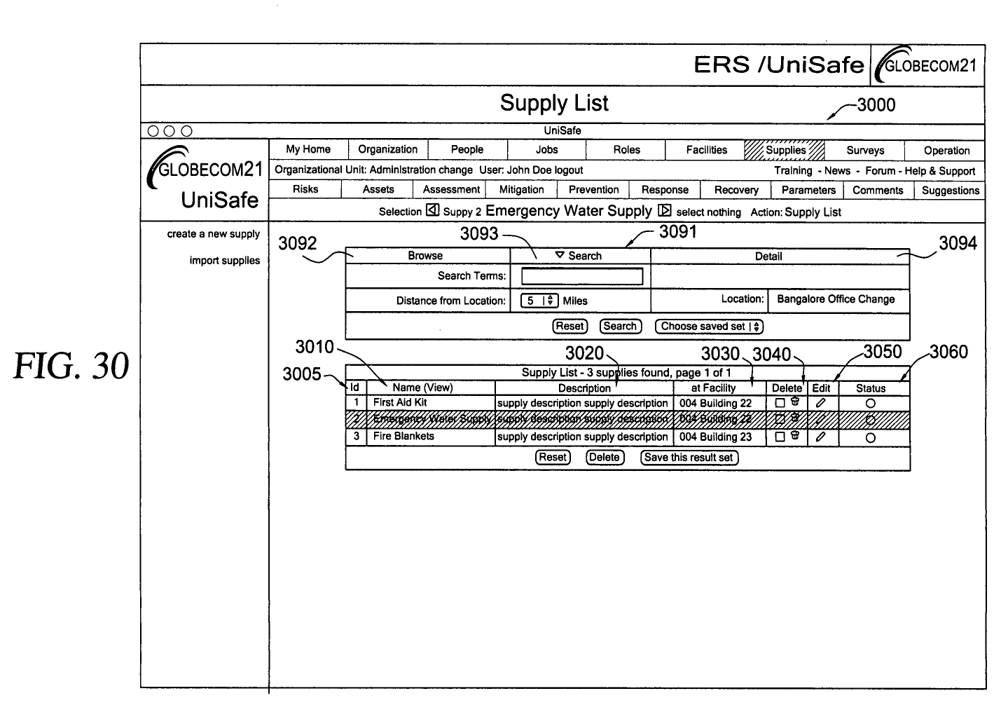

In FIG. 30, a Supply List screen 3000 is presented to a user to show a list of possible supplies available for use by the university. The list may include fields for an identification (id) number 3005, a supply name 3010, a supply description 3020, a location 3030 for the supply, and fields to delete 3040 and edit 3050 the record for each supply. In addition, a status field 3060 is provided for each supply that displays status information for each supply. An access control panel 3091 is provided to aid in accessing information on the supply list and includes an extendable browse menu portion 3092, an extendable search menu portion 3093 and an extendable detail menu portion 3094. The browse feature bar 3092 enables the user to enter search terms to locate supplies on the list. The search feature bar 3093 enables the user to enter search terms to locate supplies on the list. The detail feature bar 3094 enables the user to access detailed information on a highlighted supply on the list.

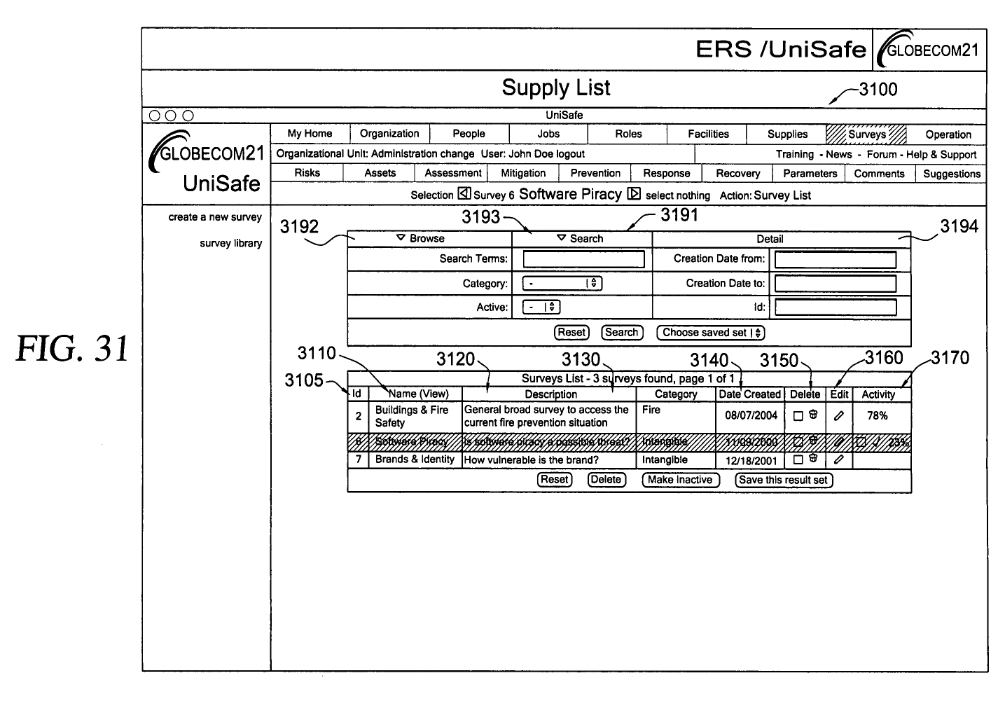

In FIG. 31, a Survey List screen 3100 is presented to a user to show a list of surveys available for use by the university. The list may include fields for an identification (id) number 3105, a survey name 3110, a survey description 3120, a category 3130 for the survey, survey date 3140, and fields to delete 3150 and edit 3160 the record for each supply. In addition, an activity field 3170 is provided for each survey that displays the completed portion of the survey activity for the survey. An access control panel 3191 is provided to aid in accessing information on the survey list and includes an extendable browse menu portion 3192, an extendable search menu portion 3193 and an extendable detail menu portion 3194. The browse feature bar 3192 enables the user to enter search terms to locate surveys on the list. The search feature bar 3193 enables the user to enter search terms to locate surveys on the list. The detail feature bar 3194 enables the user to access detailed information on a highlighted survey on the list.

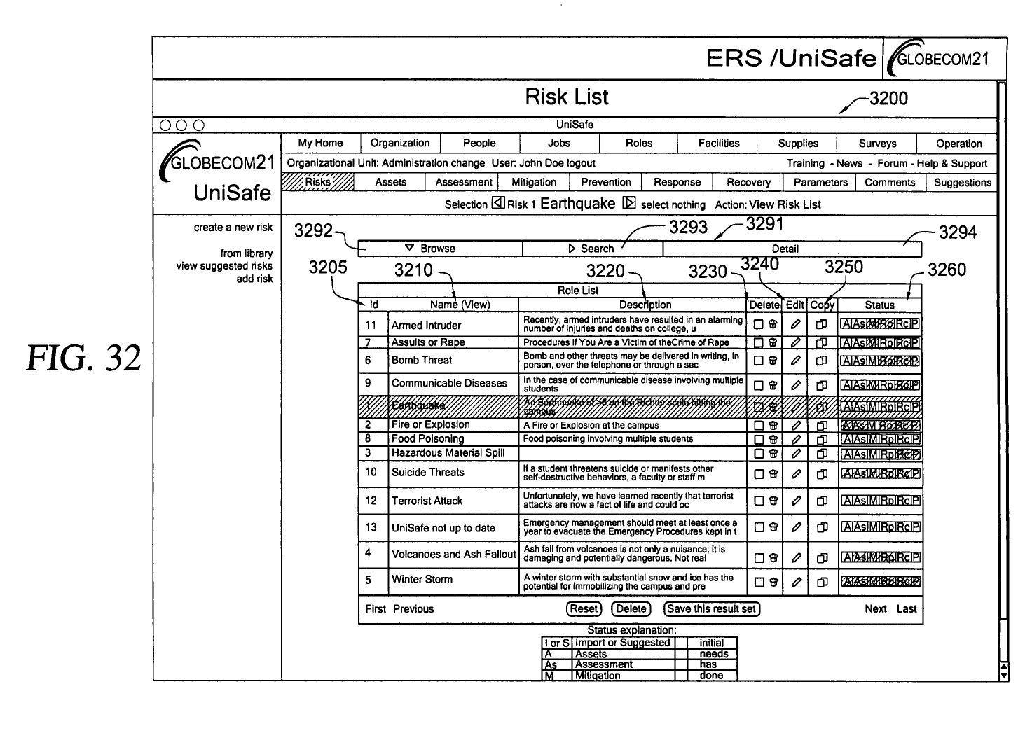

In FIG. 32, a Risk List screen 3200 is presented to a user to show a list of risks identified as being applicable to the university. The list may include fields for an identification (id) number 3205, a risk name 3210, a risk description 3220, and fields to delete 3230, edit 3240 and copy 3250 the record for each risk. In addition, a status field 3260 is provided for each risk that displays the individual status of assets, planning, etc. associated with each risk. An access control panel 3291 is provided to aid in accessing information on the risk list and includes an extendable browse menu portion 3292, an extendable search menu portion 3293 and an extendable detail menu portion 3294. The browse feature bar 3292 enables the user to enter search terms to locate risks on the list. The search feature bar 3293 enables the user to enter search terms to locate risks on the list. The detail feature bar 3294 enables the user to access detailed information on a highlighted risk on the list.

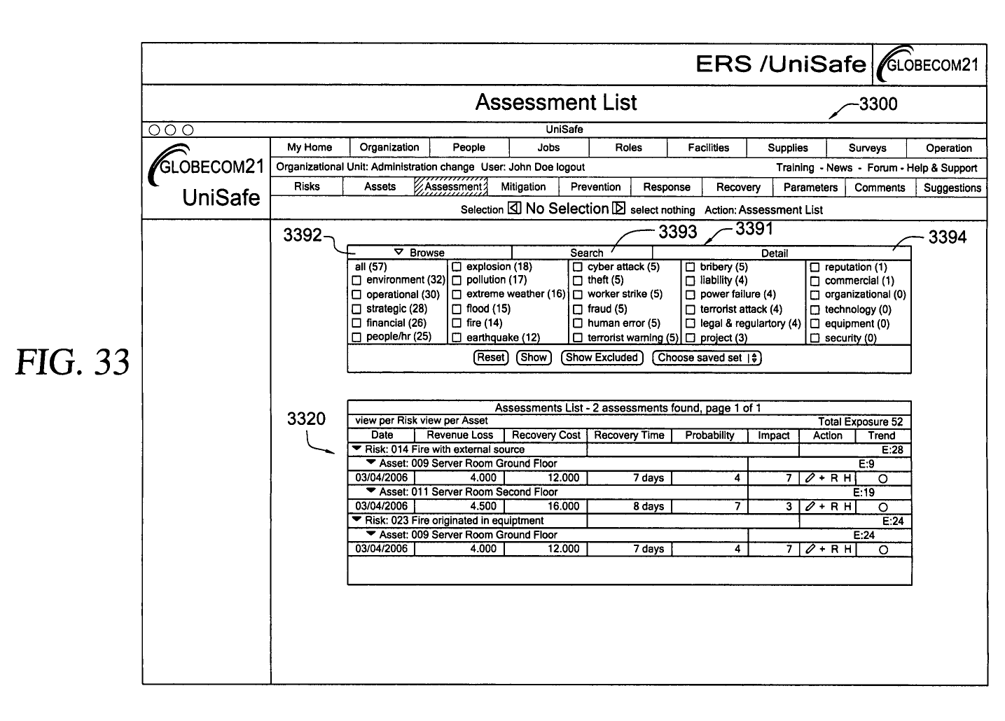

In FIG. 33, an Assessment List screen 3300 is presented to a user to show a list of assessments that are available for use by the university. The list may be browsed and/or searched and additional details about the available categories of assessments may be displayed. In addition, a display area 3320 is provided to display a view of the assessment results sorted by risk and the asset(s) that would be affected by each risk. An access control panel 3391 is provided to aid in accessing information on the assessment list and includes an extendable browse menu portion 3392, an extendable search menu portion 3393 and an extendable detail menu portion 3394. The browse feature bar 3392 enables the user to enter search terms to locate assessments on the list. The search feature bar 3393 enables the user to enter search terms to locate assessments on the list. The detail feature bar 3394 enables the user to access detailed information on a highlighted assessment on the list.

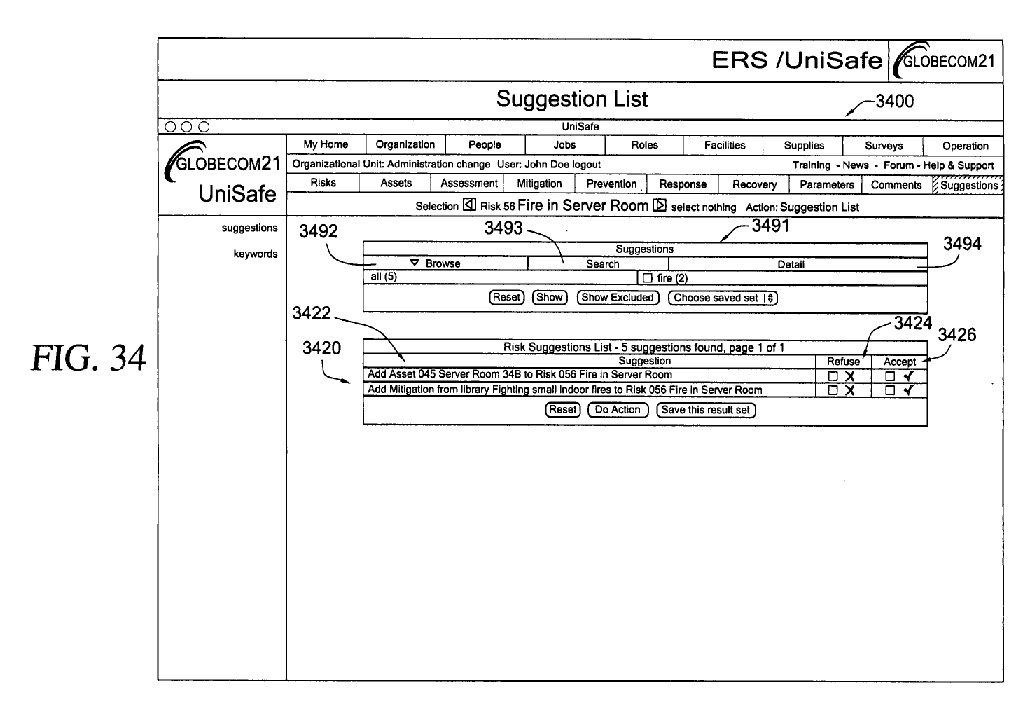

In FIG. 34, a Suggestion List screen 3400 is presented to a user to show a list 3410 of suggestions organized by category that have been entered into the system and that are available for consideration by the university. The list may be browsed and/or searched and additional details about the available categories of suggestions may be displayed. In addition, a display area 3320 is provided to display a view of the suggestion results that includes a field to display the suggestion 3422 as well as fields to refuse 3424 and accept 3426 the suggestion. An access control panel 3491 is provided to aid in accessing information on the suggestion list and includes an extendable browse menu portion 3492, an extendable search menu portion 3493 and an extendable detail menu portion 3494. The browse feature bar 3492 enables the user to enter search terms to locate suggestions on the list. The search feature bar 3493 enables the user to enter search terms to locate suggestions on the list. The detail feature bar 3494 enables the user to access detailed information on a highlighted suggestion on the list.

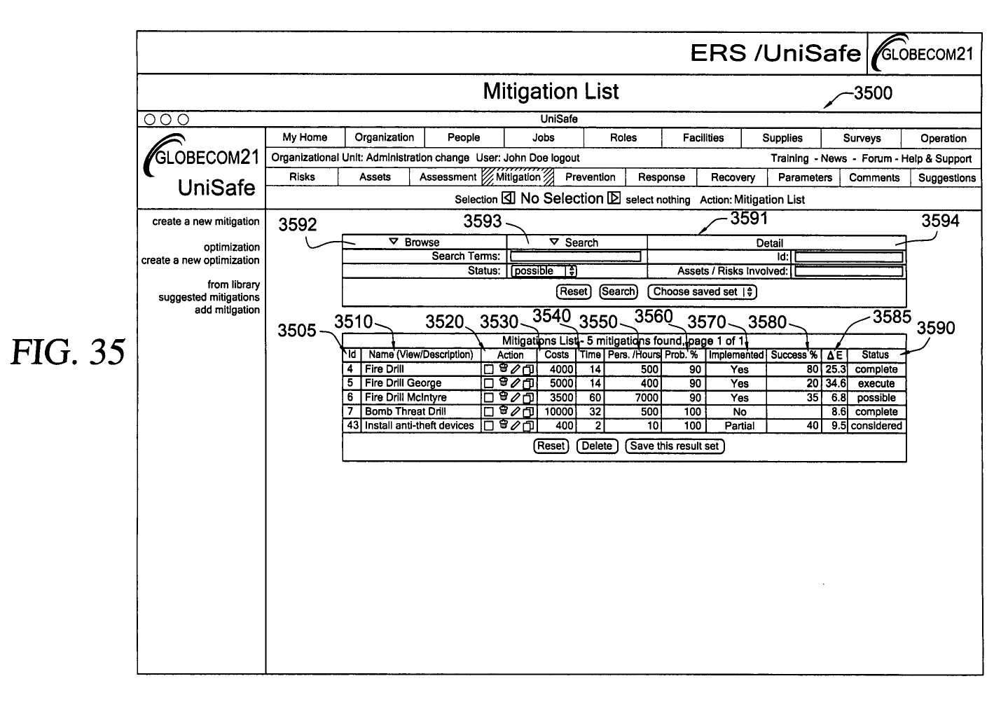

In FIG. 35, a Mitigation List screen 3500 is presented to a user to show a list of mitigations available for use by the university. The list may include fields for an identification (id) number 3505, a mitigation name 3510, action options 3520, costs to perform the mitigation 3530, time to perform the mitigation 3540, personnel hours needed to perform the mitigation 3550, a percent probability of the mitigation occurring 3560, whether the mitigation has been implemented 3570, a success rate for the mitigation implementation 3580, a delta-E (ΔE) 3585 that measures the Exposure index a formula that the system uses to factor in the entire exposure of the enterprise to the risk, including: costs, time to recover, probability of occurrence, mitigation measures and the portion implemented and the success or failure of such mitigation results, and a status of the implementation of the mitigation 3590. An access control panel 3591 is provided to aid in accessing information on the mitigation list and includes an extendable browse menu portion 3592, an extendable search menu portion 3593 and an extendable detail menu portion 3594. The browse feature bar 3592 enables the user to enter search terms to locate mitigations on the list. The search feature bar 3593 enables the user to enter search terms to locate mitigations on the list. The detail feature bar 3594 enables the user to access detailed information on a highlighted mitigation on the list.

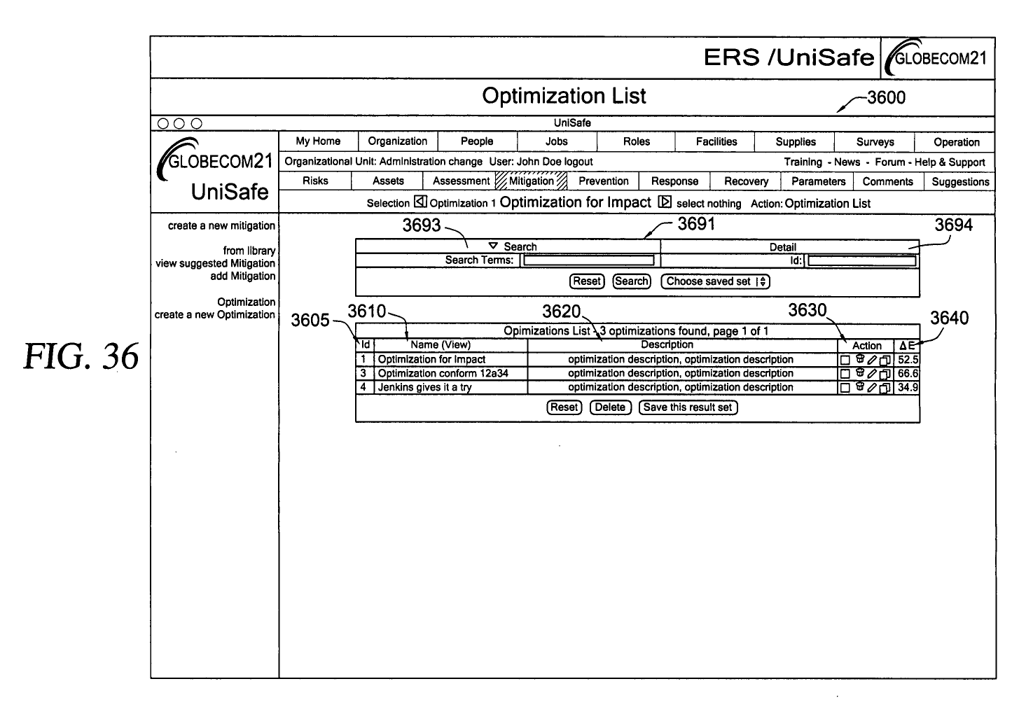

In FIG. 36, an Optimization List screen 3600 is presented to a user to show a list of optimizations available for use by the university. The list may include fields for an identification (id) number 3605, an optimization name 3610, an optimization description 3620, action options 3630, and a delta-E (ΔE) 3585 that measures the Exposure Index. An access control panel 3691 is provided to aid in accessing information on the optimization list and includes an extendable search menu portion 3693 and an extendable detail menu portion 3694. The search feature bar 3693 enables the user to enter search terms to locate optimizations on the list. The detailed feature bar 3694 enables the user to access detailed information on a highlighted mitigation on the list.

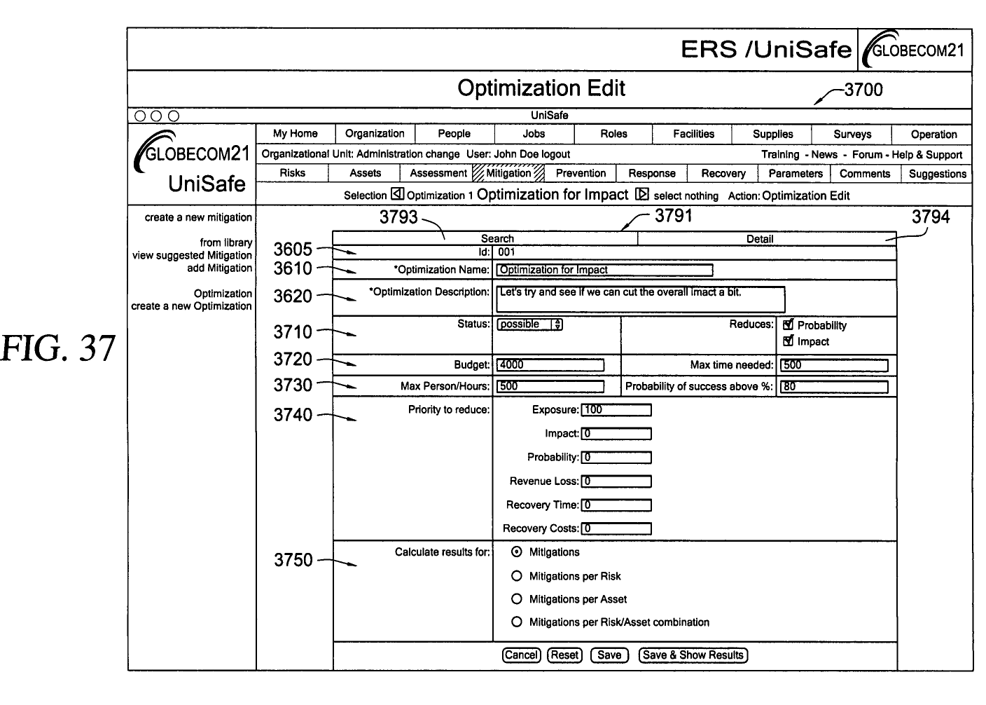

In FIG. 37, an Optimization Edit screen 3700 is presented for use by a user to edit information on optimizations in the system, for example, information on optimization id #001, Optimization for impact, from FIG. 36, is displayed and available to be edited. The edit screen may include fields for the identification (id) number 3705, the optimization name 3710, the optimization description 3620, a status of the optimization 3710, a budget for the optimization 3720, a priority to reduce 3740, and several calculated results for 3750 that measure the results of the mitigation. An access control panel 3791 is provided to aid in accessing information on the optimization list and includes an extendable search menu portion 3793 and an extendable detail menu portion 3794. The search feature bar 3793 enables the user to enter search terms to locate optimizations on the list. The detailed feature bar 3694 enables the user to access detailed information on a highlighted mitigation on the list.

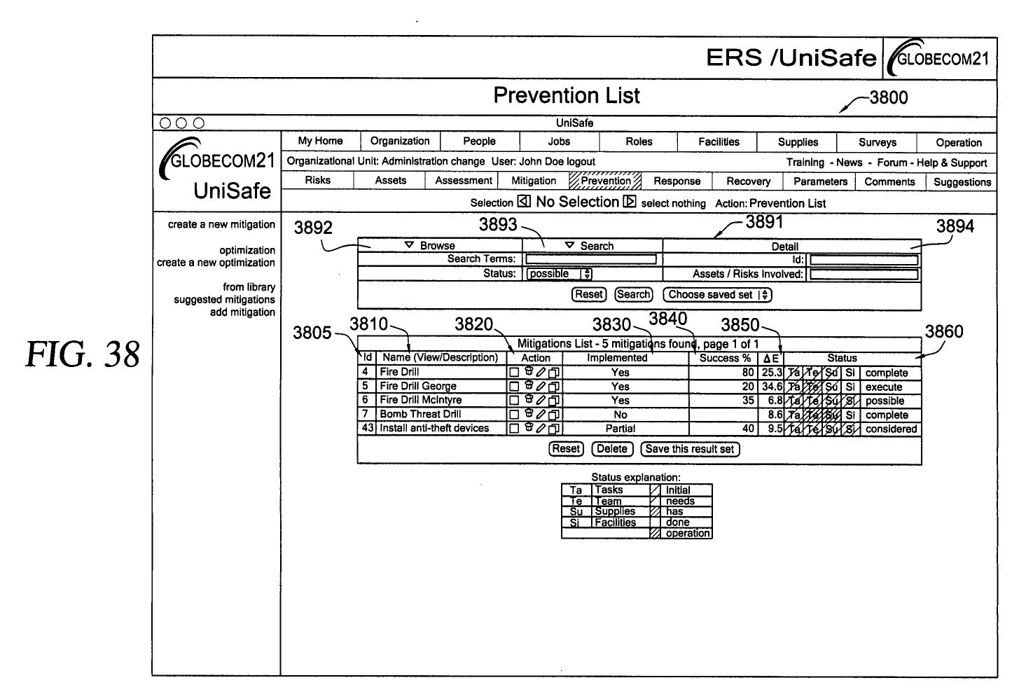

In FIG. 38, a Prevention List screen 3800 is presented to a user to show a list of preventive mitigations that are available for use by the university. The list may include fields for an identification (id) number 3805, a preventive mitigation name 3810, action options 3820, whether the preventive mitigation has been implemented 3830, a success rate for the preventive mitigation implementation 3840, a ΔE 3850 that, and a status of the implementation of the preventive mitigation 3860. An access control panel 3891 is provided to aid in accessing information on the prevention list and includes an extendable browse menu portion 3892, an extendable search menu portion 3893 and an extendable detail menu portion 3894. The browse feature bar 3892 enables the user to enter search terms to locate preventive mitigations on the list. The search feature bar 3893 enables the user to enter search terms to locate preventive mitigations on the list. The detail feature bar 3894 enables the user to access detailed information on a highlighted preventive mitigation on the list.

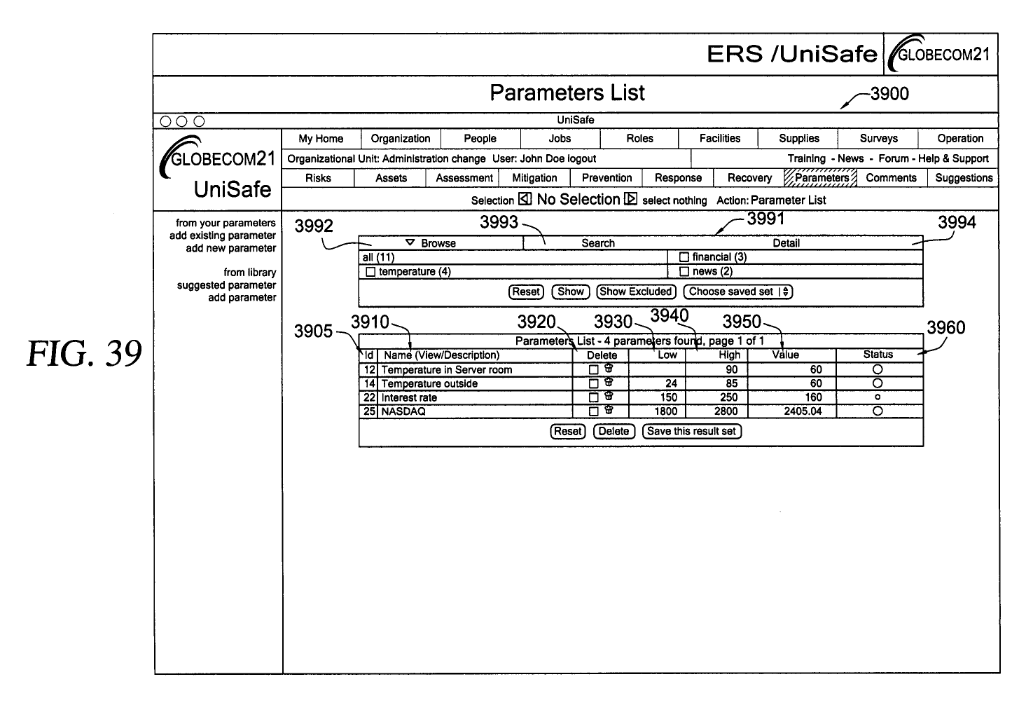

In FIG. 39, a Parameters List screen 3900 is presented to a user to show a list of parameters that are available for use by the university. The list may include fields for an identification (id) number 3905, a parameter name 3910, a delete option 3920, a low value 3930, a high value 3940, a value 3950 and a status of the implementation of the preventive mitigation 3960. An access control panel 3891 is provided to aid in accessing information on the prevention list and includes an extendable browse menu portion 3892, an extendable search menu portion 3893 and an extendable detail menu portion 3894. The browse feature bar 3892 enables the user to enter search terms to locate preventive mitigations on the list. The search feature bar 3893 enables the user to enter search terms to locate preventive mitigations on the list. The detail feature bar 3894 enables the user to access detailed information on a highlighted preventive mitigation on the list.

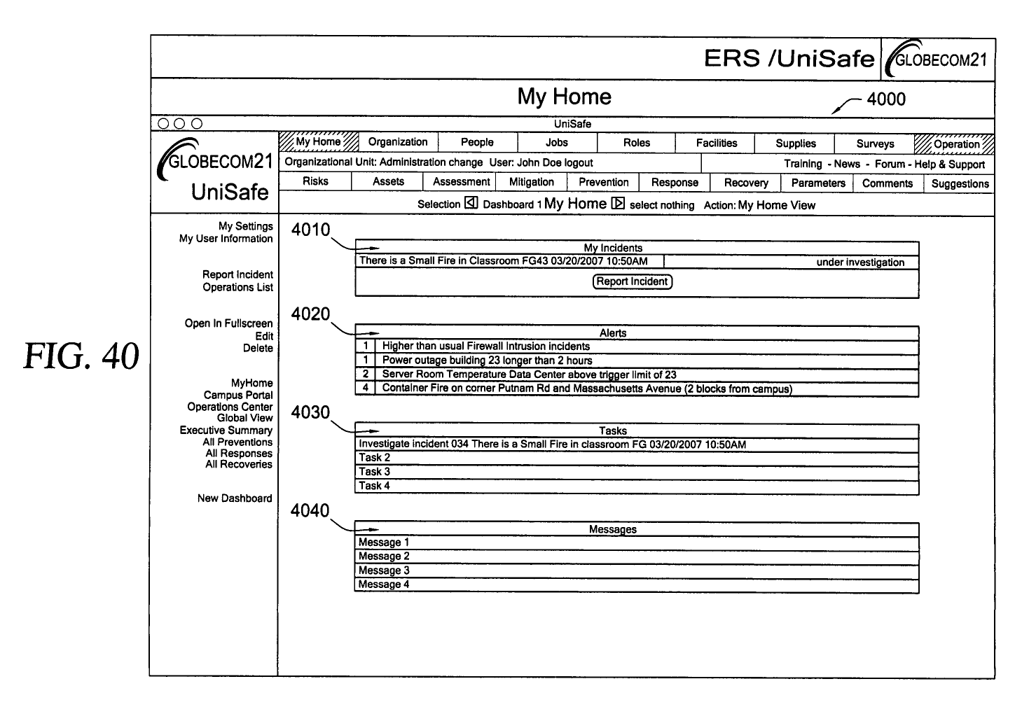

In FIG. 40, a My Home screen 4000 is presented to a user to show a listing of incidents 4010, alerts 4020, tasks 4030, and messages 4040 related to my home that are available for use by the university.

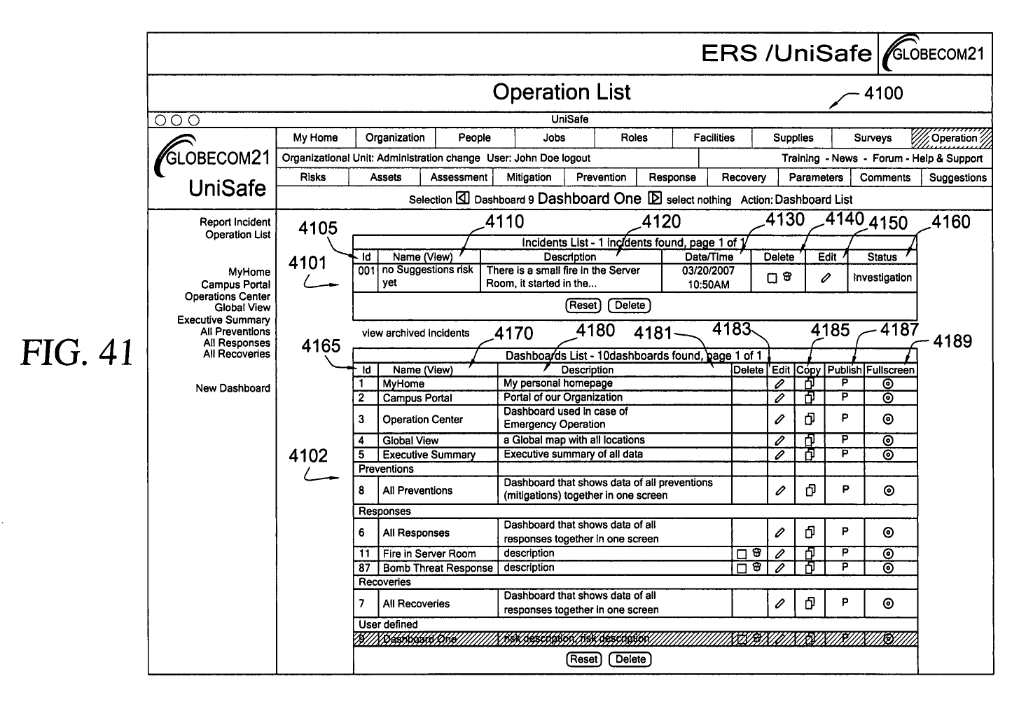

In FIG. 41, an Operation List screen 4100 is presented to a user to show a list of incidents 4101 and the related operations that are available for use by the university. The list of incidents may include fields for an identification (id) number 4105, an incident name 4110, an incident description 4120, a date and time of the incident 4130, a delete incident 4140, an edit incident 4150 and a status of the operation 4160. The related operations 4102 may include fields for an identification (id) number 4165, an operation dashboard name 4170, a delete operation 4181, an edit operation 4183, a copy operation 4185, a publish operation 4187, and a fullscreen option 4189.

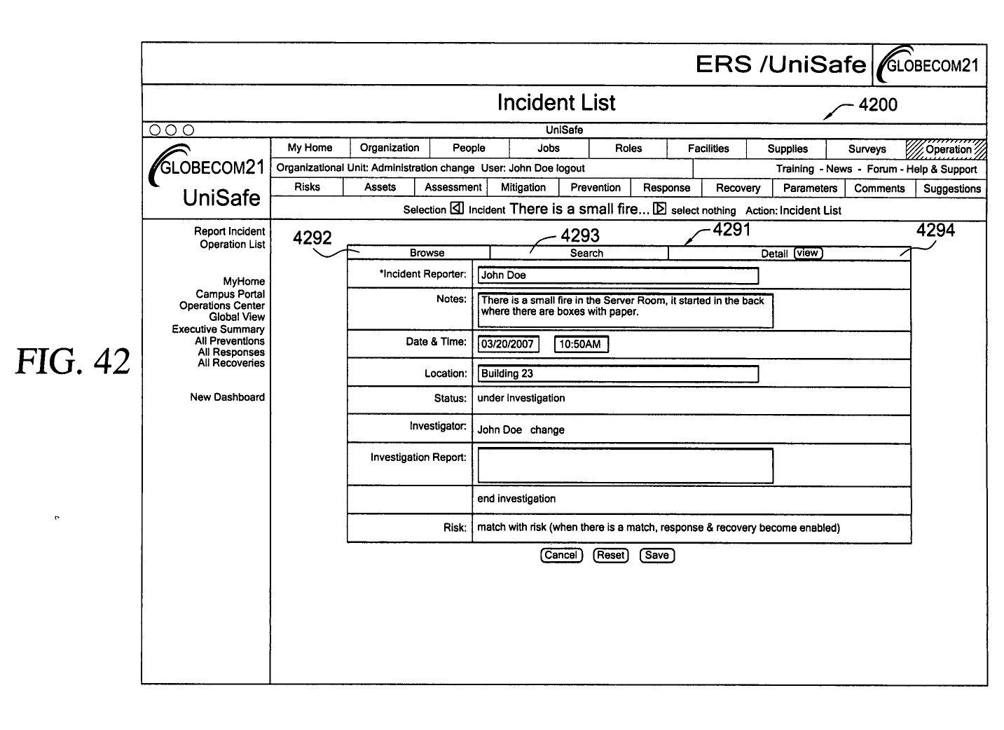

In FIG. 42, an Incident Edit screen 4200 is presented to a user to edit an incident report that is available for use by the university. The screen may include an access control panel 4291 to aid in editing information on the incident edit list and that includes an extendable browse menu portion 4292, an extendable search menu portion 4293 and an extendable detail menu portion 4294. The browse feature bar 4292 enables the user to enter search terms to locate incident on the list. The search feature bar 4293 enables the user to enter search terms to locate incidents on the list. The detail feature bar 4294 enables the user to access detailed information on a highlighted incident on the list.

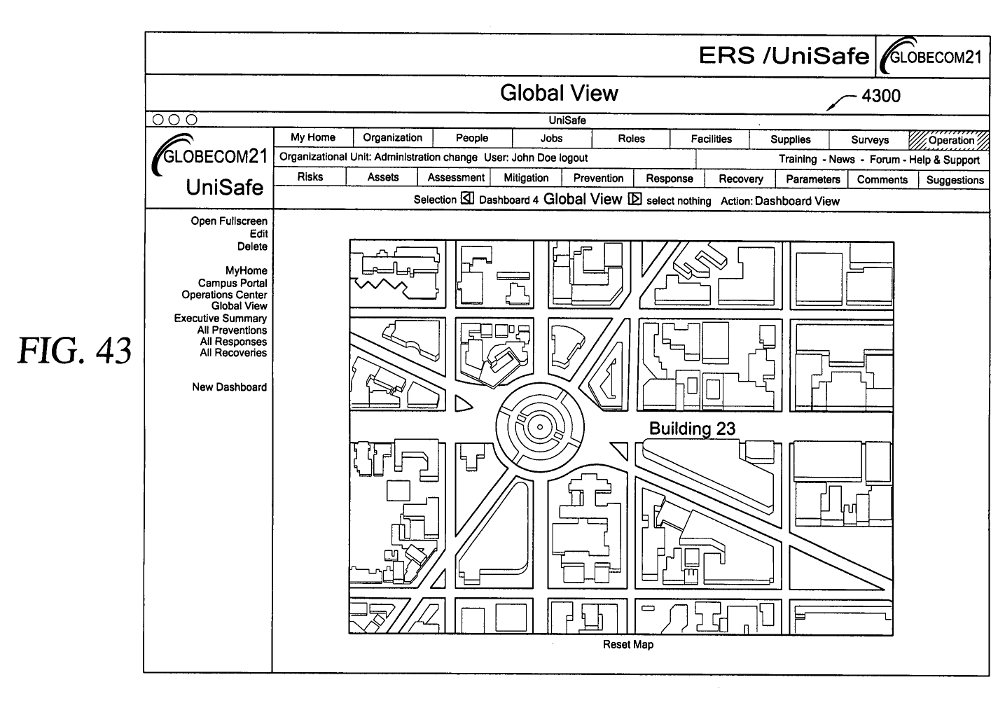

In FIG. 43, a Global View screen 4300 is presented to a user to show a map of the incident area that is available for use by the university.

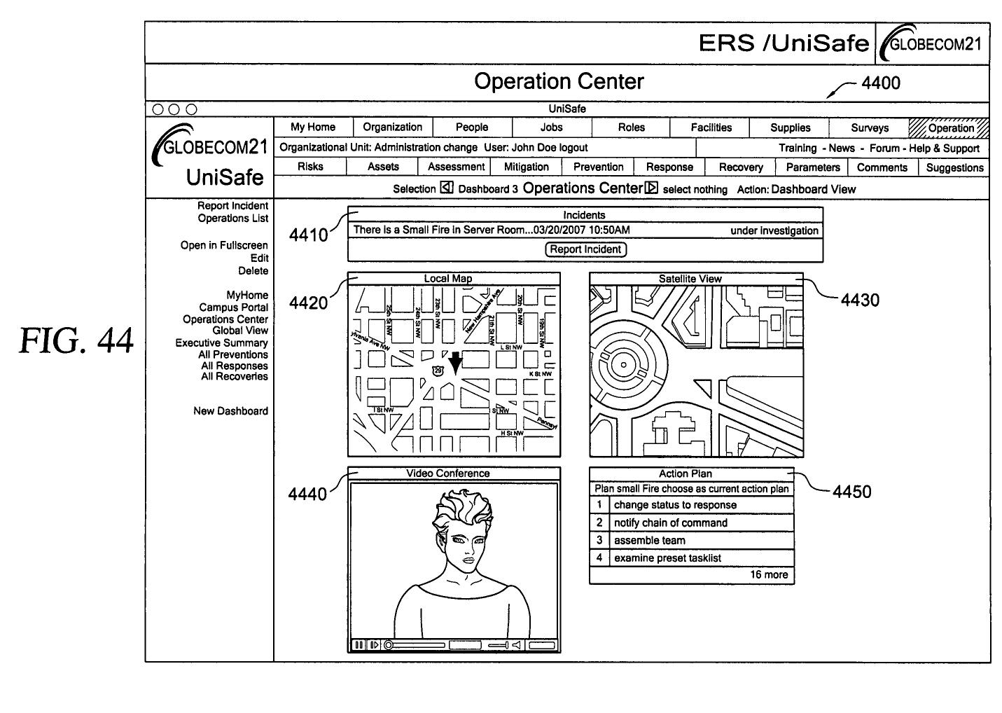

In FIG. 44, an Operation Center screen 4400 is presented to a user to show a list of incidents 4410, a local map 4420 of the incident area, a satellite view 4430 of the incident area, a video-teleconferencing window 4440, and an action plan listing 4450 that is available for use by the university.

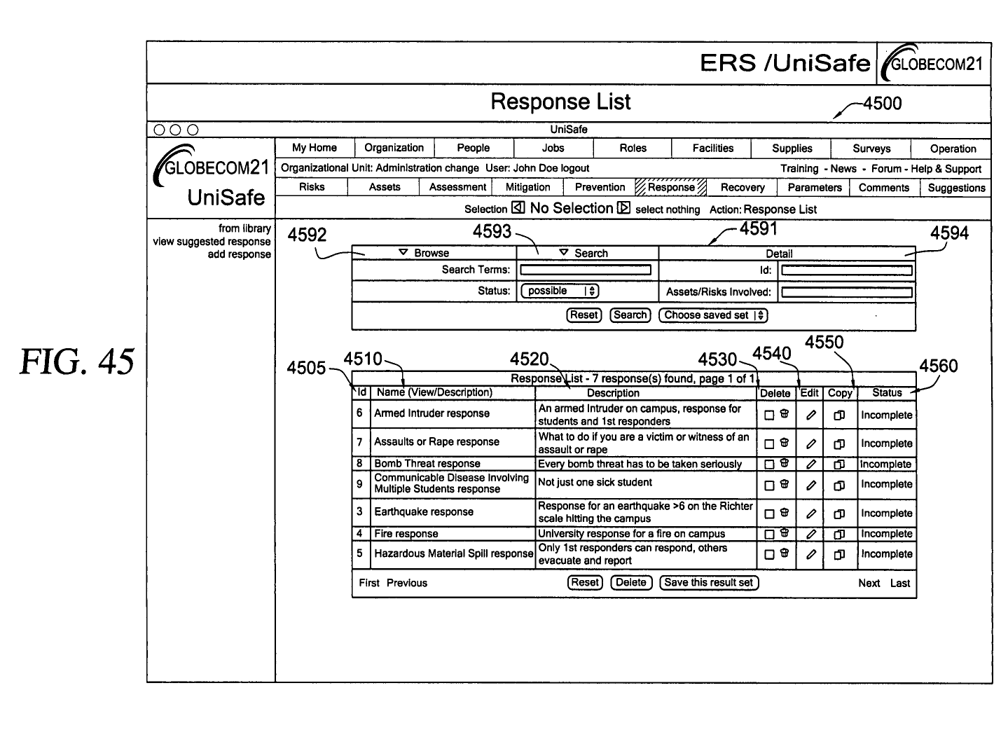

In FIG. 45, a Response List screen 4500 is presented to a user to show a list of responses that are available for use by the university. The list may include fields for an identification (id) number 4505, a response name 4510, a response description 4520, a delete option 4530, an edit option 4540, a copy option 4550, and a status of the implementation of the response 4560. An access control panel 4591 is provided to aid in accessing information on the prevention list and includes an extendable browse menu portion 4592, an extendable search menu portion 4593 and an extendable detail menu portion 4594. The browse feature bar 4592 enables the user to enter search terms to locate responses on the list. The search feature bar 4593 enables the user to enter search terms to locate responses on the list. The detail feature bar 4594 enables the user to access detailed information on a highlighted response on the list.

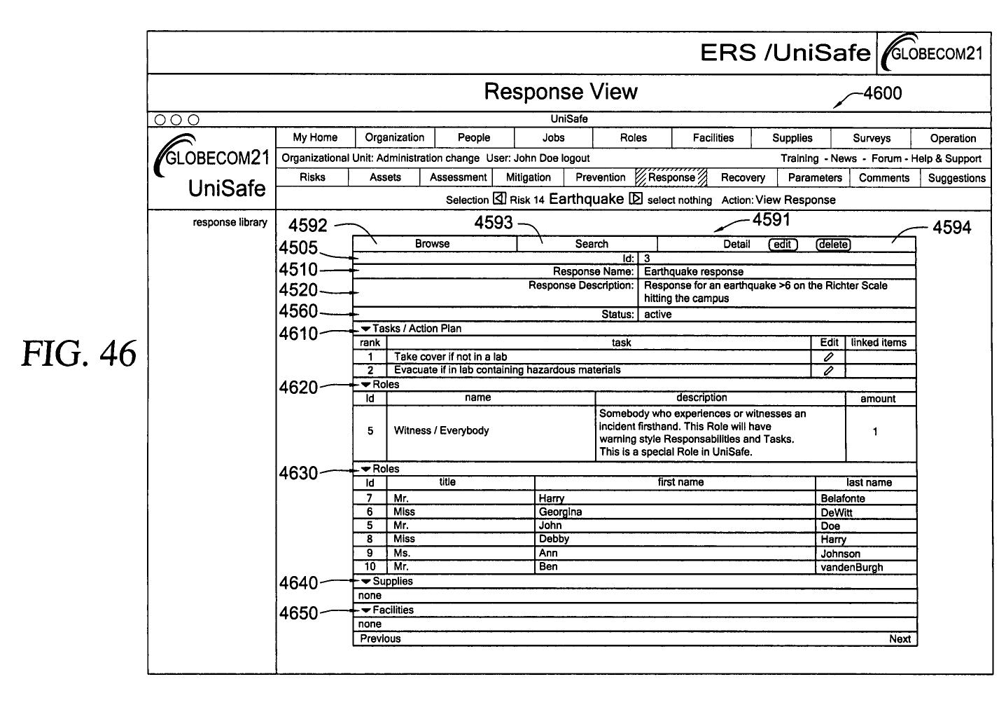

In FIG. 46, a Response View screen 4600 is presented for a response, for example, id #3, Earthquake response, from FIG. 45 that provides the available detailed information on the earthquake response. The screen may include the identification (id) number 4505, response name 4510, response description 4520, and status 4560 fields from FIG. 45 and expandable menu bars for listing additional information about the response that is relevant to each area. For example, the menu bars may include a tasks/action plan menu bar 4610, a roles menu bar 4620, a people menu bar 4630, a supplies menu bar 4640, and a facilities menu bar 4650.

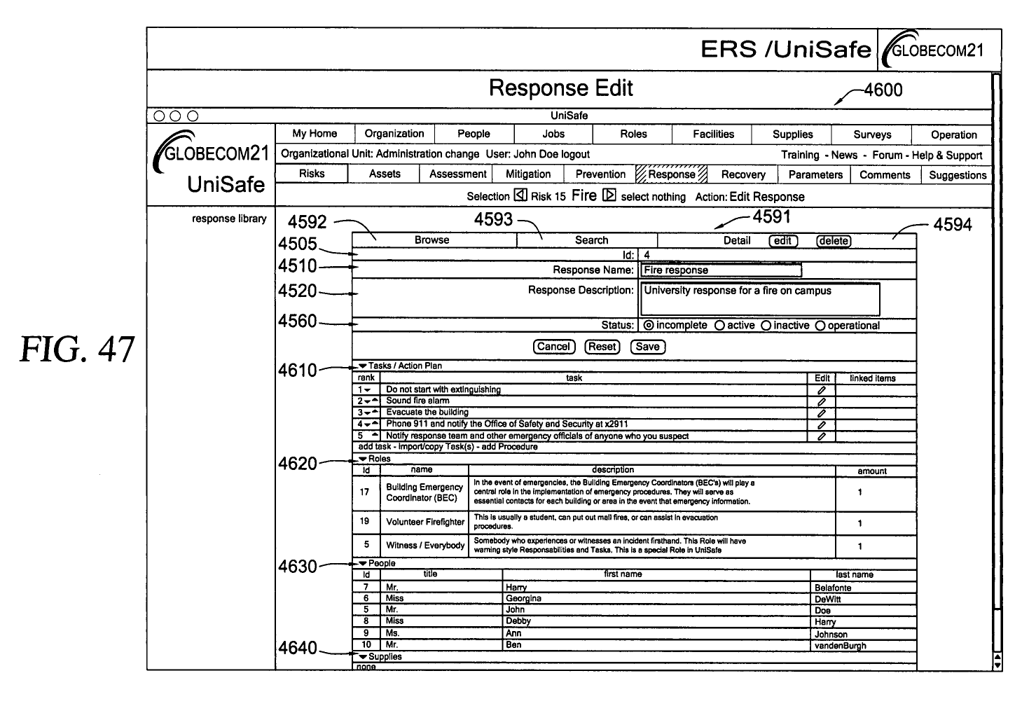

In FIG. 47, a Response Edit screen 4700 is presented for use by a user to edit the detailed information on the responses in the system, for example, information on a response id #4, Fire Response is displayed and available to be edited.

In FIG. 47, a Response Edit screen 4700 is presented for use by a user to edit the detailed information on a response, for example, id #4, fire response, from FIG. 45 that provides the available detailed information on the fire response. The screen may include the identification (id) number 4505, response name 4510, response description 4520, and status 4560 fields from FIG. 45 and expandable menu bars for listing additional information about the response that is relevant to each area from FIG. 46. For example, the menu bars may include a tasks/action plan menu bar 4610, a roles menu bar 4620, a people menu bar 4630, a supplies menu bar 4640, and a facilities menu bar 4650.

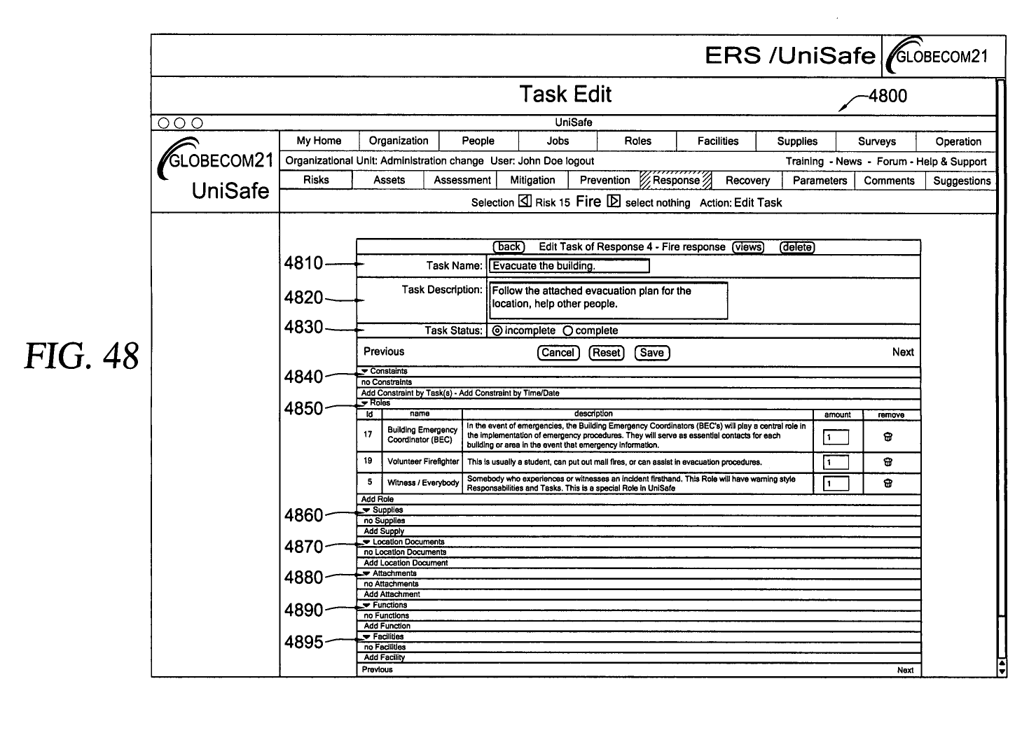

In FIG. 48, a Task Edit screen 4800 is presented for use by a user to edit the detailed information on a response, for example, id #3, evacuate the building, from FIG. 47 that provides the available detailed information on the building evacuation task. The screen may include the task name 4810, task description 4820, and status 4830 and expandable menu bars for listing additional information about the task that is relevant to each area. For example, the menu bars may include a constraints menu bar 4840, a roles menu bar 4850, a supplies menu bar 4860, a documents location menu bar 4870, an attachments menu bar 4880, a functions menu bar 4890, and a facilities menu bar 4895.

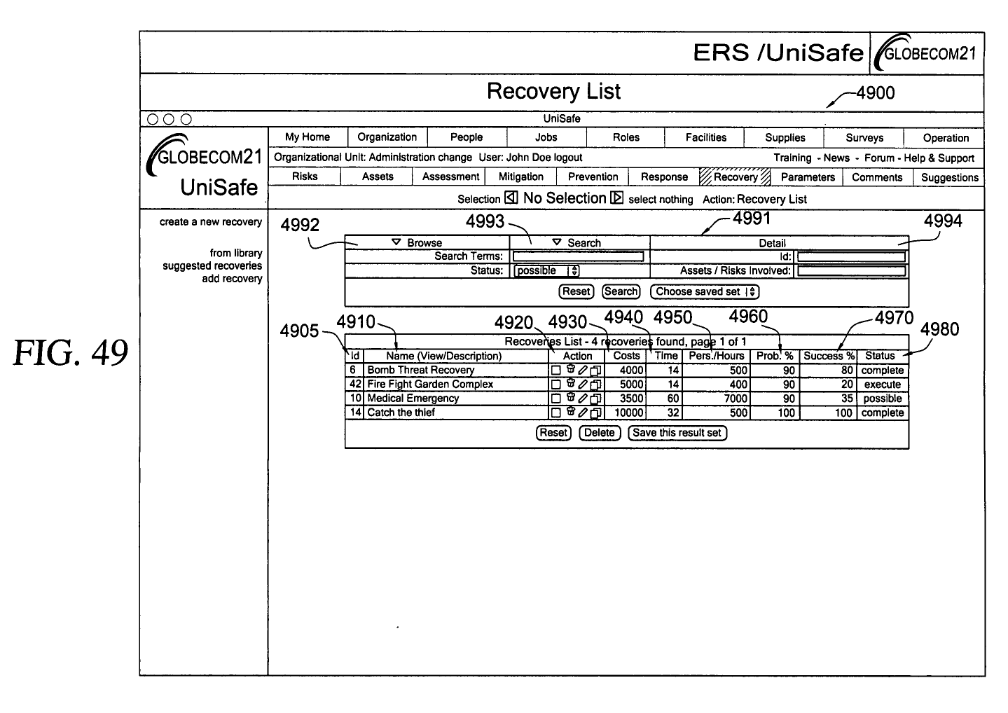

In FIG. 49, a Recovery List screen 4900 is presented to a user to show a list of recovery available for use by the university. The list may include fields for an identification (id) number 4905, a recovery name 4910, action options 4920, costs to perform the recovery 4930, time to perform the recovery 4940, personnel hours needed to perform the recovery 4950, a percent probability of the recovery occurring 4960, a success rate for the recovery implementation 4970, and a status of the implementation of the recovery 4980. An access control panel 4991 is provided to aid in accessing information on the recovery list and includes an extendable browse menu portion 4992, an extendable search menu portion 4993 and an extendable detail menu portion 4994. The browse feature bar 4992 enables the user to enter search terms to locate recoveries on the list. The search feature bar 4993 enables the user to enter search terms to locate recoveries on the list. The detail feature bar 4994 enables the user to access detailed information on a highlighted recovery on the list.

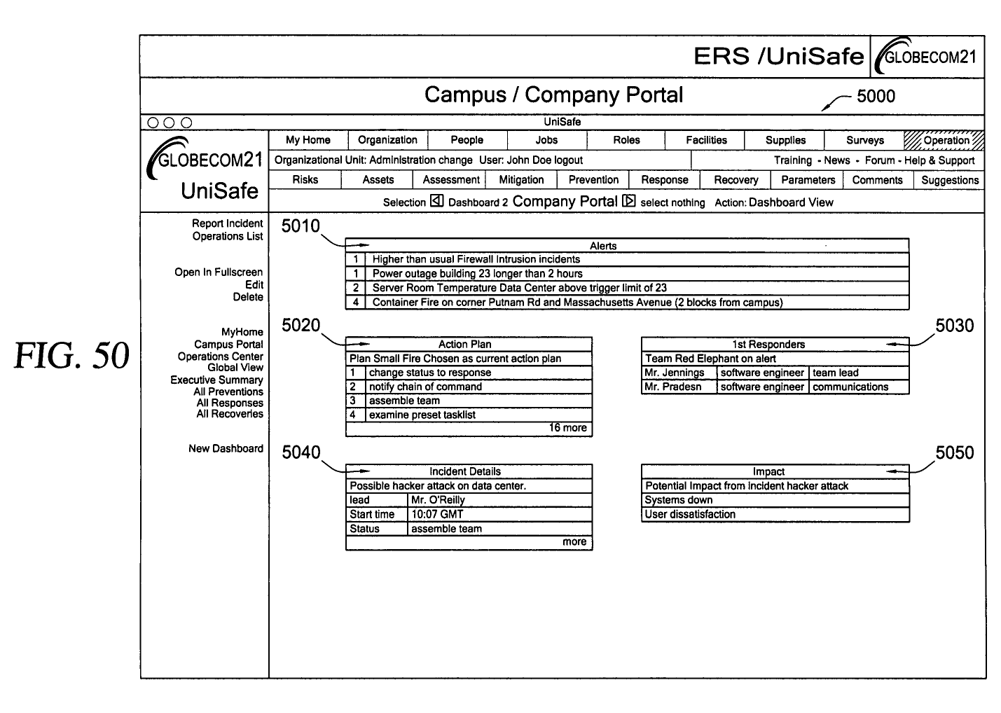

In FIG. 50, a Campus/Company Portal screen 5000 is presented to a user to show a listing of alerts 5010, action plans 5020, first responders 5030, incident details 5040 and impact 5050 related to the campus or company that are available for use.

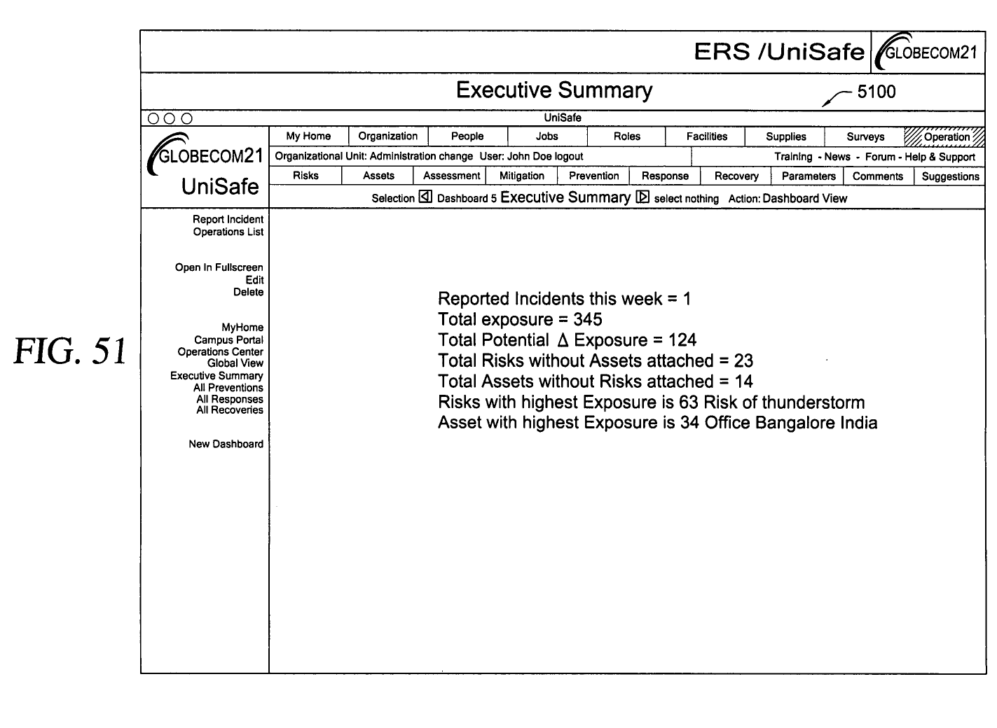

In FIG. 51, an Executive Summary screen 5100 is shown displaying a brief executive summary of the reported incidents and calculated risk values that occurred over the previous week.

In accordance with another embodiment of the present invention, an integrated first responder solution may be provided as a multi-tier application with different levels of functionality to provide end-users with the choice of how to use the application. The application may be integrated with multiple service providers to provide a seamless e-commerce ability. For example, the application may be written in ASP.NET with C# and uses an MSSQL Server as its data store.

The general properties of the present embodiment of the first responder solution provide a robust profiling at multiple levels. For example, entities may be profiled at a company level, individual level and then drilled down to machine level. The solution may have a framework that allows addition of different entity types, where each entity type can have multiple instances and where each instance may have multiple internal users. In general, the framework automatically handles all user rights and is scalable. In addition, the solution provides an industry strength catalog and RFQ based buying behavior for first responders to procure hardware as and when required. The solution also provides a methodology engine that automatically outputs action plans for specific reported incidents. These incident specific Action Plans must match the exact First Responder companies and their respective human resources as defined in the methodology and the incident's geographic co-ordinates.

The first responder solution must talk to the collaborative suite using web services. The solution must be flexible enough to talk to other applications using web services. Although the solution deployment is not transaction intensive, the solution must be able to handle a large number of concurrent users. In addition, the application: provides high performance, measured in terms of supported users, and user response time; permits processor scalability; is capable of clustering; allows for a flexible deployment strategy, for example, being deployable to two physical machines, one application server and one database server, and in any other deployment configuration; and is easy to maintain.

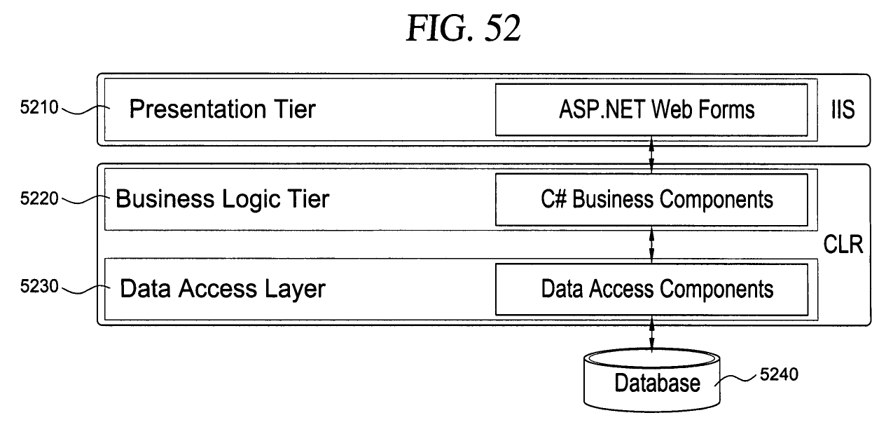

Architecture. In accordance with the present embodiment, Microsoft windows 2003 with .NET Framework were used as the development and deployment platform. FIG. 52 is a top-level functional block diagram of the architecture of the first responder solution, in accordance with an embodiment of the present invention. In FIG. 52, ASP.NET Web Forms are shown as being used for a presentation tier 5210 which is in communication with C# business components in a logical middle business logic tier (i.e., layer) 5220. In turn the business components access a back end database 5240 through ADO.NET and a DB helper class known as the Data Access Layer (DAL) 5230, separate from the business logic layer (BLL) 5220.

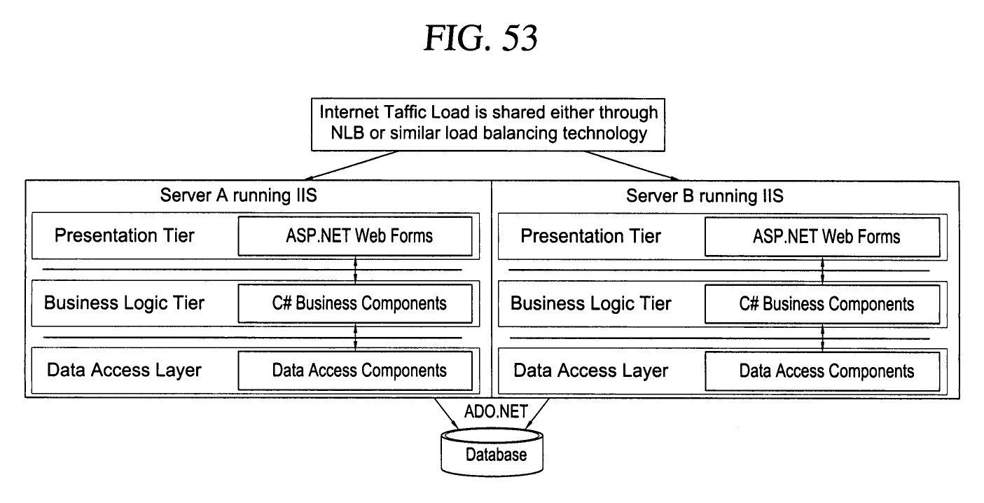

FIG. 53 is a top-level functional block diagram of the architecture of the first responder solution, in accordance with an embodiment of the present invention. In FIG. 53, the first responder solution is shown to be physically deployed between two servers. In this embodiment, inbound network traffic may be split between the two application servers using, for example, Network Load Balancing, NLB. Once a network request has reached one of the machines in the cluster, then all the work for that request will be performed on that particular machine. In general, the business logic and data access components will be installed as assemblies on both servers, which in essence will be identical clones of one another. If the load-balancing software is configured to use “sticky IPs,” then each server can have its own session-state store, because a second request will be guaranteed to return to the server where the first request was fulfilled. For a more fault-tolerant solution, the two application servers can share a common session-state store such as SQL Server or a dedicated session server (Not shown on diagram). The type and location of the session-state store is generally determined by the values in the ‘sessionState’ child node of the ‘system.web’ element in the ‘web.config’ file for each Web site.

Business Solution. In accordance with the present embodiment, the development environment used for the first responder solution included Microsoft .NET Framework ver 1.1, Microsoft.NET Visual Studio.NET 2003, Windows 2000 Professional (workstations), Windows 2003 Server Standard Edition, IIS 5.0, SQL Server 2000, and IE 5.5/6.0.

In accordance with the present embodiment of the first responder solution, there are four main application areas, a user interface area, a user interface processing area, a business components area and a data access layer area. The user interface and user interface processing areas are implemented in the presentation tier and operate to capture data input from the user and display data returned by the backend system and handle simple navigation. In the present embodiment, they are implemented using ASP.NET Web Forms, user controls, and server controls. These constructs permit clean separation between designer HTML and UI code such as event handlers for buttons. The business components area is implemented in the business logic tier and controls user navigation and process flows with backend business objects, and handles management of user session data. In the present embodiment, they are implemented using C# classes with each field exposed as a property. The data access layer area is implemented in the data access layer to handle the interaction with the back end data store. In the present embodiment, they are implemented t handle the interaction with the backend data store, which is implemented as C# DB Helper class.

System Details. In accordance with the present embodiment, the directory structure is implemented as separate directories for each individual module and different directories are used to keep all class files, related to each individual module, common JavaScript, images, themes for style sheets, and user controls. In addition, a class directory structure is used that is divided into 3 parts: business service classes, common classes, and data service classes, and each directory structure is granted read/write permission to upload/download documents for individual modules.

Validations. In accordance with the present embodiment, for most client side validations, the solution uses .NET's validation controls. There are also cases use JavaScript for validation and server side validations may be done.

Utility Classes and Controls. In accordance with the present embodiment, utility classes are those classes in which common functions are defined. The present embodiment used Microsoft's Web Control called Tree control.

Exception handling. In accordance with the present embodiment, page level exception handling is handled by try, catch statements. Application level exceptions may be handled by writing code in a global.asax file (a.k.a., the ASP.NET application file), which intimates error via mail to technical group. A custom error page is displayed to the user.

Database Model. In accordance with the present embodiment, a key requirement for the application was to create a high-performance solution, so SQL Server 2000 was chosen as a scalable enterprise database server, for which .NET provides database-native managed provider.

Stored procedures. In accordance with the present embodiment, stored procedures may be used to access tables in the database. This provides several benefits, including: providing a clean mechanism to encapsulate queries; changing a query can be done without changing the data access code; a DBA can easily see what SQL statements are being executed; stored procedures are typically more secure, and it is easier to control database access. In addition, the use of stored procedures can help avoid round trips to the client by issuing more than one request in the stored procedure; stored procedures usually offer the best performance compared to middle-tier-generated SQL; and stored procedures can handle transactions. Unfortunately, the disadvantage of stored procedures is that they tend to be proprietary and are usually not portable across platforms.

Recommended Production Environment. In accordance with the present embodiment, the production environment used for the first responder solution included Microsoft .NET Framework Ver. 1.1, Windows 2003 Server Standard Edition, IIS 6.0; SQL Server 2000; and IE 5.5 and above.

Security. In accordance with the present embodiment, role based security is managed within the application itself and an application user hierarchy includes a First Responder Solution Admin (Super User), an Entity Instance Admin (First Responder Company Admin); and entity instance users (having different roles). Entity instance administration creates required internal roles and assigns permission to these roles. While creating s user a role is assigned to the user and, depending upon the role the user gets, access will only be granted to a specified functionality in a respective role. There is only single entry point to this application and that is login page. Security options provided by the .NET framework can be very easily implemented in the current solution.

For example, the options available may involve authentication and/or authorization. Authentication may include forms authentication, passport authentication and windows authentication.

Forms authentication. A system in which unauthenticated requests are redirected to an HTML form using HTTP client-side redirection. The user provides credentials and submits the form. If the application authenticates the request, the system issues a cookie that contains the credentials or a key for reacquiring the identity. Subsequent requests are issued with the cookie in the request headers; they are authenticated and authorized by an ASP.NET event handler using whatever validation method the application developer specifies.

Passport authentication. Centralized authentication service provided by Microsoft that offers a single logon and core profile services for member sites.

Windows authentication. ASP.NET uses Windows authentication in conjunction with Microsoft Internet Information Services (IIS) authentication. Authentication is performed by IIS in one of three ways: basic, digest, or Integrated Windows Authentication. When IIS authentication is complete, ASP.NET uses the authenticated identity to authorize access.

Authorization may include file authorization and URL authorization.

File authorization. File authorization is performed by the FileAuthorizationModule, and is active when you use Windows authentication. It does an access control list (ACL) check of the .aspx or .asmx handler file to determine if a user should have access. Applications can further use impersonation to get resource checks on resources that they are accessing.

URL authorization. URL authorization is performed by the URLAuthorizationModule, which maps users and roles to pieces of the URL namespace. This module implements both positive and negative authorization assertions. That is, the module can be used to selectively allow or deny access to arbitrary parts of the URL namespace for certain sets, users, or roles.

Performance. Windows 2003 supported features/settings. There have been dozens of performance improvements to IIS 6.0 and ASP.NET on Windows Server 2003. Even ASP applications run faster on IIS 6.0 and Windows Server 2003 than they did on Windows 2000 and IIS 5.0.

Some of the reasons for the performance improvements include: 64-bit processor (Itanium) support for Windows Server Enterprise Edition and Datacenter Edition; ASP.NET is able to cache complete responses in HTTP.sys (the responses are marked as Location=“Server”) and the cached responses are served straight from HTTP.sys, which is much faster because it is served from kernel mode and no user-mode transition is required; and the ASP.NET application doesn't even see requests if they are served from the cache. Also, IIS 6.0 supports: output caching and a persistent ASP template cache for improved throughput, even when serving ASP applications; and a worker process mode without the marshaling overhead of IIS 5's in-process mode. Additionally, centralized binary logging: allows Windows Server 2003 to support up to 10,000 sites per server, up to twenty times more than the recommended 500 sites per box for Windows 2000; and relieves past bottlenecks by logging data for multiple sites to a single log file.

Still other reasons for the performance improvements include: Enterprise Edition and Datacenter Edition supporting more processors (up to eight for Enterprise Edition and up to 32 for Datacenter Edition); recycling processes recovers resources to ensure that a poorly written application doesn't compromise the scalability of other applications by starving them for resources; scalability features such as out-of-process session state management allow applications to be deployed across a Web farm for greater throughput and reliability; and processes are generally started on-demand, i.e., only when they are needed, so as not to consume resources unnecessarily. Likewise, applications can be swapped and restarted on the fly, and a Web site can be restarted without affecting other Web sites on the same server; running safe out-of-process processes doesn't require additional context switches from the IIS process to the application process as it did before; optimizations were made to global PFN lock acquisition on both 32-bit and 64-bit systems; and improvements were made to dispatcher lock acquisition during context switching. The dispatcher lock assures synchronization between different threads and different CPUs. It is acquired whenever you need to scale a thread or perform a synchronization operation like setting an event, acquiring a mutex, setting a semaphore, or using any of the .NET synchronization objects. On systems with a large number of threads and processes, performance will improve between 15 and 20 percent.

Windows Server 2003, Enterprise Edition, and Windows Server 2003, Datacenter Edition, both support Hot Add Memory. This allows ranges of memory to be added to a computer and made available to the operating system and applications as part of the normal memory pool while the server is running. This does not require re-booting the computer and involves no downtime. This feature will be available only on hardware that supports this feature.

ASP.NET Compiled execution. ASP.NET is much faster than classic ASP, while preserving the “just hit save” update model of ASP. However, no explicit compile step is required! ASP.NET will automatically detect any changes, dynamically compile the files if needed, and store the compiled results to reuse for subsequent requests. Dynamic compilation ensures that the application is always up to date, and compiled execution makes it fast. Most applications migrated from classic ASP see a 3× to 5× increase in pages served.

ASP.NET Caching features. ASP.NET provides two types of caching that can be used to create high-performance Web applications. The first is called output caching, which enables the storage of dynamic page and user control responses on any HTTP 1.1 cache-capable device in the output stream, from the originating server to the requesting browser. On subsequent requests, the page or user control code is not executed; the cached output is used to satisfy the request. The second type of caching is traditional application data caching, which can be used to programmatically store arbitrary objects, such as data sets, to server memory so that an application can save the time and resources it takes to recreate them. In accordance with one or more embodiments of the present invention, the second type of caching has been implemented in the solution. However, embodiments are contemplated in which the first type of caching is implemented.

ASP.NET view state feature. No server resources are required because state is contained in a structure in the page code. It is simple to implement. Pages and control state are automatically retained. The values in view state are hashed, compressed, and encoded, thus representing a higher state of security than hidden fields. View state is good for caching data in Web farm configurations because the data is cached on the client.

Scalability. Being scalable is an important capability for the solution and, in accordance with the present embodiment, which uses Windows 2003, Windows 2003 supports Load Balancing and Clustering. With Windows Server 2003, clustering is done using a two-part clustering strategy: 1) Network Load Balancing (NLB) and Server Cluster (SC). NLB provides load balancing support for IP-based applications and services that require high scalability and availability. SC provides failover support for applications and services that require high availability, scalability and reliability.

Network Load Balancing (NLB) is a clustering technology that distributes TCP requests across servers. For instance, if there are two servers in a cluster, NLB will allocate TCP requests across those two servers. NLB is easy to setup and is included in all Windows Server 2003 products. With NLB, organizations can build groups of clustered computers to support load balancing of TCP, UDP, and GRE requests. Web-tier and front-end services, such as Web servers, streaming media servers, and Terminal Services, are ideal candidates for NLB.

A Server Cluster takes two or more computers and organizes them to work together to provide higher availability, reliability, and scalability than can be obtained by using a single system. When failure occurs in a cluster, resources can be redirected and the workload can be redistributed. Typically the end user experiences a limited failure, and may only have to refresh the browser or reconnect to an application to begin working again.

Together, these two technologies combine to insulate an IT infrastructure from application and service failure (software crashes), system and hardware failure (disk crashes), and even site failure (natural disasters, power outages, network interruptions, and so on). Microsoft cluster technologies increase overall availability, while minimizing single points of failure. NLB is available in all versions of the Windows Server 2003 family and CS is available only in Windows Server 2003, Enterprise Edition and Datacenter Edition.

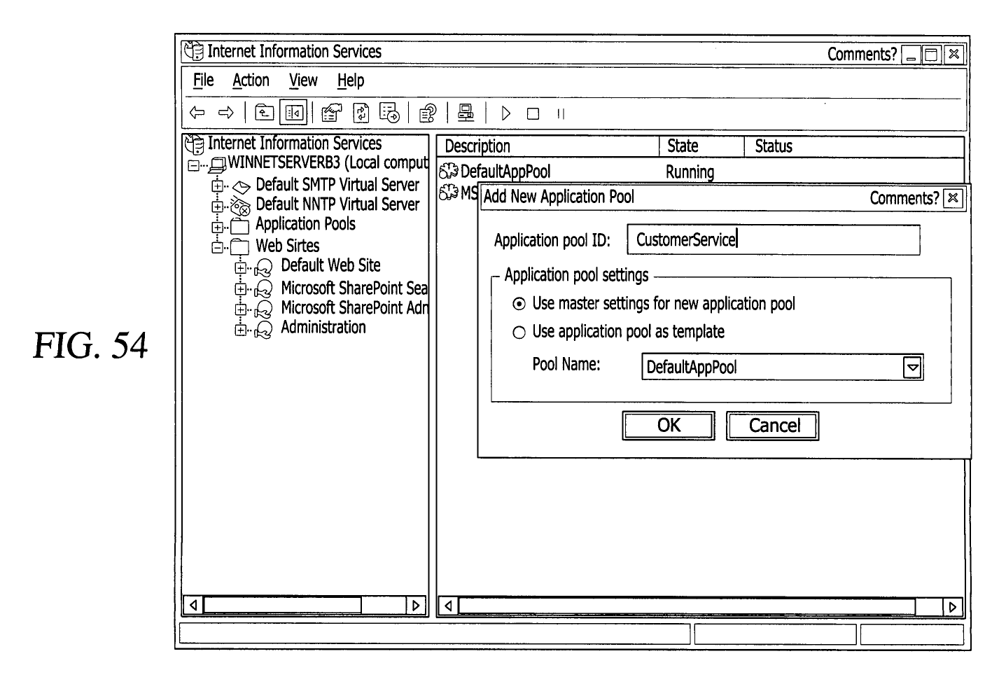

Configuring and Managing IIS for Scalability. Part of implementing a scalable architecture involves setting up the software. IIS 6 provides a number of features that can be used to accomplish this. First, consider Application Pools and the options that affect performance related to them. FIG. 54 is a screen shot of a page in the Internet Information Services (IIS) web server being used to create a new application pool, for use with one or more embodiments of the present invention. Internet Information Services (IIS) needs to be started and the Application Pools folder selected. In FIG. 54, an add new Application Pool window is being displayed as a result of a user Right-clicking the Application Pools folder, selecting New, selecting Application Pool, and naming the new pool “CustomerService.” Clicking OK creates a new pool.

Once the user clicks OK, the new pool will show up under Application Pools. Now the user can associate the application with the new pool. To accomplish this, the user opens the properties for the application and switches to the Virtual Directory or Home Directory page. Next, the user selects the new pool under the Application Pool list at the bottom of the page as shown below, then applies the change or clicks OK.

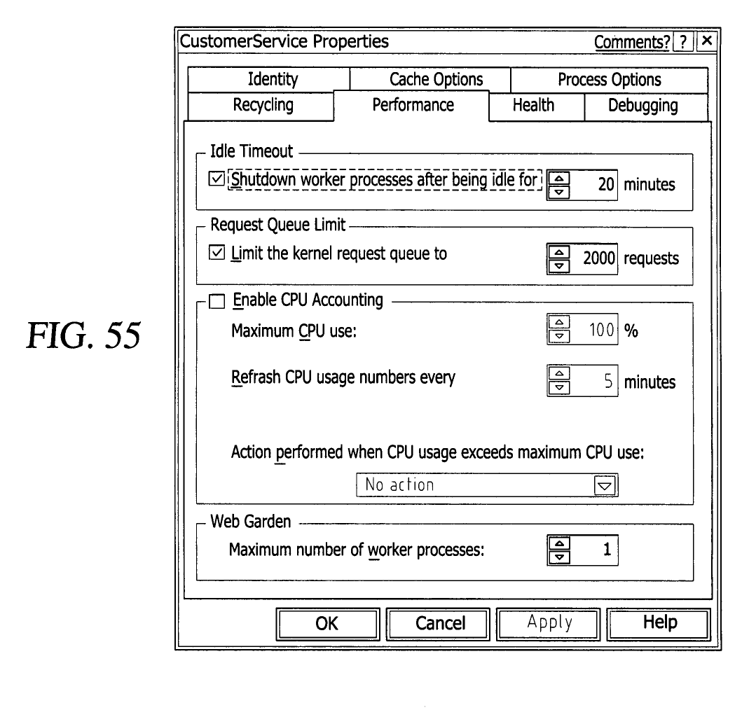

Now, the pool can be configured by setting the properties on the Application Pool parent folder and the settings will migrate to each pool. Alternatively, the properties can be set or overridden at the pool level. The main performance-related features are on the Performance Tab. FIG. 55 shows the performance tab with the default values for use in accordance with one or more embodiments of the present invention. This property page is used to configure the way that IIS handles processes by tweaking this behavior for each pool.

An Idle Timeout limit helps conserve system resources by terminating unused worker processes. IIS will gracefully shutdown an idle process after the time period elapses. The Request Queue Limit prevents a server from being overloaded by a large number of events. IIS monitors the number of requests for a designated application pool queue before adding a new request to the queue. Users receive a non-customizable 503 error response if the queue limit is exceeded.

CPU accounting enables a user to keep a process from overloading a CPU. The user can enable this and, then set the percentage of processor usage the application can use. The user can elect to take no action or terminate the pool when it exceeds this limit. An error is written to the Event Log when an exception occurs.

The last option affects Web gardens. A Web garden is an application pool using more than one worker process. A single Web garden may take advantage of multiple processors on a server. A Web garden can also establish affinity between processes and processors. Web gardens allow other processes to accept requests, even when one in the pool is unresponsive or hung. The Web Garden option is critical to scale up scenarios. To scale up, set up multiple Web gardens and control how many of them are running based upon the number of processors.

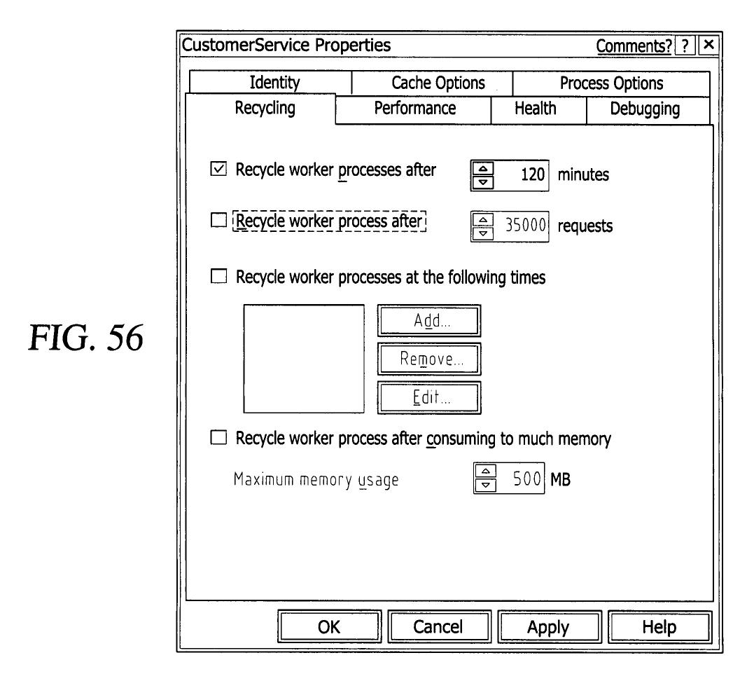

Additional options that pertain heavily to performance are found under a Recycling tab. This tab can be used to administer the recycling of worker processes and configure IIS to periodically restart worker processes in an application pool based upon one or more metrics that you set. This allows a user to manage worker processes that are faulty before they can impact the performance of a server, which ensures that specified applications in those pools remain healthy and that system resources can be recovered on a timely basis. FIG. 56 shows the recycling tab with the default values for use in accordance with one or more embodiments of the present invention.

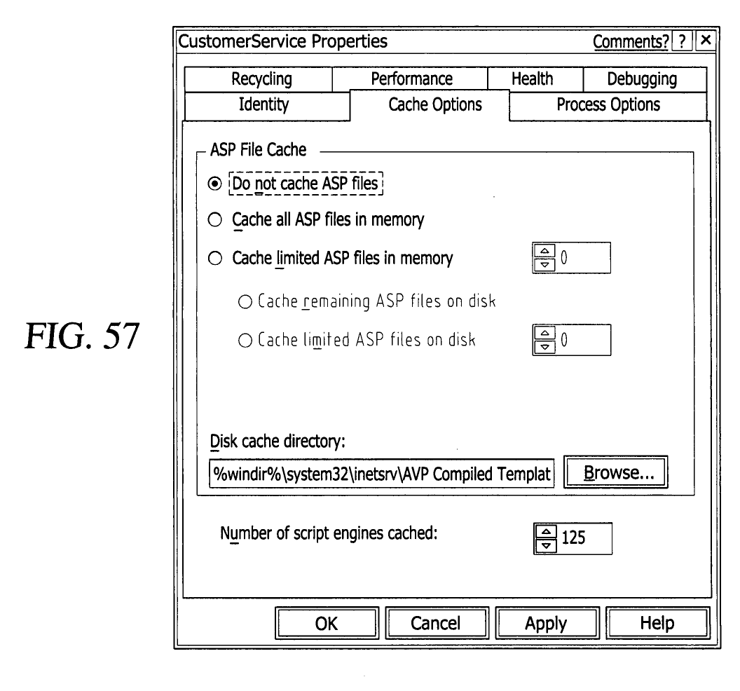

If IIS has to recycle a process, it throttles the ability of the faulty worker process to receive requests until it completes processing all remaining requests that it has stored in the request queue. A replacement worker process is started before the old worker process stops. The last set of options that affects performance for application pools is found under a Cache Options tab. This tab is used to set your application caching options for ASP applications for the pool. FIG. 57 shows the cache options tab with the default values for use in accordance with one or more embodiments of the present invention. As seen in FIG. 56, the IIS does not cache any ASP files by default. This forces the client browser to query the server for a new (or updated) page at each request. Although this strategy saves disk space on the client, it increases application response time. However, the client is assured of obtaining the most current version of the page or pages.

The user can use the cache options to improve performance of the application by either forcing the cache to memory on the server or limit the amount of files cached in memory and force the rest to disk. If the cache and/or files are forced to disk, then the user might consider setting up the cache directory on a fast disk.

There are also server settings that can impact the server's performance. For instance, there are certain ASP settings that change the server's behavior to one that will not scale as well. Tweaking these options can make a big difference on the server, especially if the user is running ASP.NET applications only and not any ASP applications. This information is found in the Performance Settings topic in the IIS 6 Documentation.

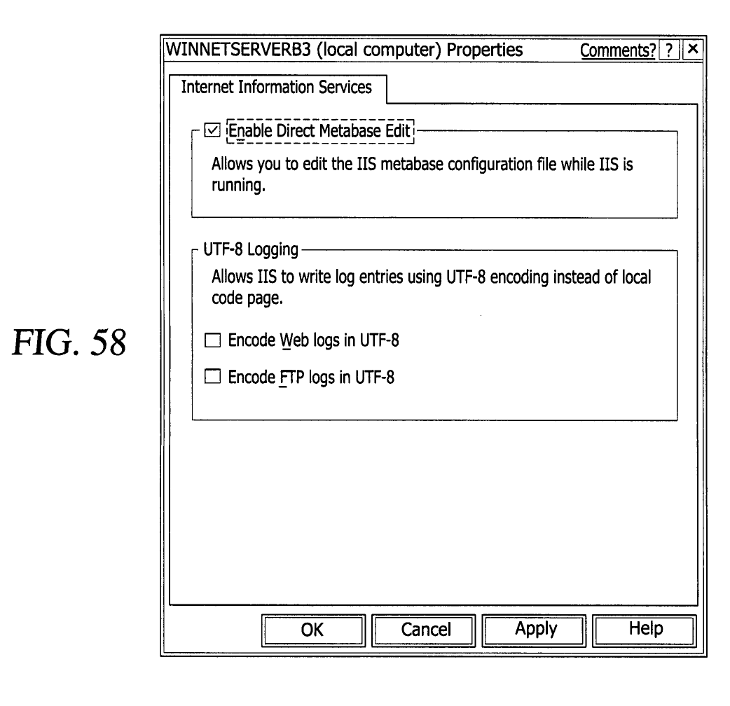

Another important property, Enable Direct Metabase Edit, allows changes to the metabase while IIS is running. This setting allows the user to make edits that affect scalability while the servers are in production if necessary. FIG. 58 is a screen shot of a property page for the IIS server for use with embodiments of the present invention. The user can change this on the property page for the IIS server.

Scaling up and out. Typically, scaling up is accomplished by adding hardware to a particular server first. Then, if support is needed for more resources, the user can scale from Web Edition or Standard Edition to Enterprise Edition. Applications can also be moved to Datacenter Edition as needs change over time. Table 1 details the maximum allowed RAM and number of CPUs, for each version of Windows Server 2003.

TABLE 1

| | | Max RAM | | Max CPUs per | Max CPUs | Max Nodes |
|---|---|---|---|---|---|---|
| Server | Max RAM | 64-bit | Min | Node | per Node | (32-bit and |
| Edition | 32-bit (x86) | (Itanium) | CPUs | 32-bit | 64-bit | 64-bit) |
| Web | 2 GB | N/A | 1 | 2 | N/A | N/A |
| Edition | | | | | | |
| Standard | 4 GB | N/A | 1 | 4 | N/A | N/A |
| Edition | | | | | | |
| Enterprise | 64 GB | 128 GB | 1 | 8 | 8 | 8 |
| Edition | | | | | | |
| Datacenter | 64 GB | 512 GB | 8 | 32 | 64 | 8 |
| Edition | | | | | | |

Table 2 shows, all versions of Windows Server 2003 that support NLB with up to 32 nodes in a cluster. Thus, any version of Windows Server 2003 can be used in an NLB environment to scale up any server application (that supports NLB) that is accessed via TCP. The user would typically move from one version of Windows Server 2003 to another because they either need new features or additional hardware that is supported by a particular version. In any case, the user can make the choice of when to switch to another version.

TABLE 2

| Operating | | NLB | | Server Cluster |
|---|---|---|---|---|
| System | Server Edition | Nodes | Cluster Support | Nodes |
| Windows | Advanced Server | 32 | NLB/MCSC | 2 |
| 2000 | | | | |
| Windows | Datacenter Server | 32 | NLB/MCSC | 4 |
| 2000 | | | | |
| Windows | Web Edition | 32 | NLB | |
| Windows | Standard Edition | 32 | NLB | |
| Windows | Enterprise Edition | 32 | NLB/CLB/MS | 8 |
| | | | CS | |
| Windows | Datacenter | 32 | NLB/CLB/MS | 8 |
| | Edition | | CS | |

Another important property, Enable Direct Metabase Edit, allows changes to the metabase while IIS is running. This setting allows the user to make edits that affect scalability while the servers are in production if necessary. FIG. 58 is a screen shot of a property page for the IIS server for use with embodiments of the present invention. The user can change this on the property page for the IIS server.

ADO.NET supported features. ADO.NET accommodates scalability by encouraging programmers to conserve limited resources. Because any ADO.NET application employs disconnected access to data, it does not retain database locks or active database connections for long durations.

Availability. Windows 2003 server supported features. Use Clustering. Despite the best software engineering, all applications fail eventually. Delivering application services in spite of failures is what availability engineering is all about. Clustering is a key technology for high-availability because it provides instant failover application services in the event of a failure.

Use Network Load Balancing. Network Load Balancing (NLB) enhances the availability of critical Web-based applications by detecting server failures and automatically redistributing traffic to still-running servers. NLB provides two design benefits: high-availability with minimal operational support, and incremental scalability with easily added capacity.

The first responder's application can be deployed in various large scale environments that need reliability, scalability, performance and security, by considering various deployment considerations stated in above paragraphs.

Emergency Management System/Solution

In accordance with yet another embodiment of the present invention, an emergency management system/solution (EMS) with control center functionality may be provided as a multi-tier application with different levels of functionality to provide end-users with the choice of how to use the application.

Profiling Engine Instances Management allows the Central Control to define the structure that they want for profiling different entities/products/people. The profiling engine can be used for profiling: First Responder Agencies, First Responders, Health Information, Private Corporations, Experts, NGOs, and Products and Services needed in Incident Management.

Methodology and Procedure Management. Embodiments of the present invention have a very robust functionality for creating pre-defined methodologies for different types of incidents that a city/state can encounter. The following functionality is provided in the present embodiment: Manage Incident Categories, (e.g. Medical, Personal, Terrorist, etc); Manage Incident Types: (e.g. Earthquake, Fire, Bomb scare, etc). For each incident type, questions can be defined which must be answered by the reconnaissance Team.

Procedure Library. This functionality enables the creation of multi-step commonly used procedures, which can be called into various methodologies. Apart from multi-step procedure library, electronic formats of Procedures can be maintained in the E-Learning module. These can be pulled on demand by various first responders and incident managers based on specific needs.

Methodology Management. A detailed methodology can be prepared for each type of Incident type defined. Each methodology can have multiple steps. Procedures can also be called into the methodology. Apart from this, specific Methodologies could be created for specific sites/locations which come under the program. For each step in the methodology, the following can be defined: The type of first responder agency responsible for that step; the assets required for executing the step; the profile of the first responder who will execute the step; and attachments can be made to each step.

SMS Intimation Management. The application can provide functionality for key stakeholders to receive intimations on their Cellular Phones. The following functionality is provided: intimate on an incident being reported to a list of people who have to be intimated the moment an incident is reported; and intimate members of action plan once the action plan is frozen, an SMS intimation is sent to all the people involved in the action plan, for example, first Responders/NGO members/Experts.

Search Functions. The application platform enables complex searches within the various first responder agencies and first responders. Some of them are listed below. Combination searches are possible. For example, searches can be performed by city, first responder agency, first responder name or e-mail id, incident type, first responder agency type and first responder role, previous incident experience, and chain of command.

Communication Module. Once searched, the first responder can be contacted by: e-mail, SMS, ad hoc chat, and/or phone.

Reconnaissance Management. The reconnaissance module allows the incident managers to have the following functionality: select different first responders from various agencies to run a reconnaissance mission at the incident site, and receive the reconnaissance reports including pictures and videos.

Incident Management. The incident management section of the present embodiment of the application enables the actual management of an incident and orchestrating its activities. The following functionality is available to the central control: ESF management, report incident, incident investigation, incident management, action plan making business logic and functionality, edit action plans, post incident management, and administrative tasks.

ESF Management. This enables central control to maintain the details of all their ESF contacts which have been assigned to them by the Federal function.

Report Incident. Three types of incidents can be reported. For each incident locale, incident type and the reporter details can be defined. For example, a human casualty incident, an incident related to a specific geographic location; and an incident related to a profiled site which is considered as a high vulnerability site.

Incidents Investigation. Incidents can be investigated and the report can be filed using either web based or hand held based interfaces.

Incident Management. For each active incident, the following functionality is provided: edit incident details; see incident details; see the current weather at the incident site; see the exact incident location on a map and the first responder companies available close to it; see the result of the investigation team; define a lead for the incident management team; create the action plan for the incident (this is done automatically by the solution based upon the incident type, location and the pre-defined methodologies; call for ESF; publish incident specific details on your web site; report status of people; accept lost or missing reports from relatives; create an instance of the Collaborative suite for the team members to collaborate amongst each other.

Action Plan Making Business Logic and Functionality. The action plan can always be edited by incident managers to bring in their domain knowledge into play to suit the specifics of that incident. For example: the incident types associated with every incident reported which is released for action is taken by the software; the location of the incident reported is taken by the software; the various steps defined for the incident type in the reported incident are taken; for each step, first responder agency type responsible for that step are picked up by the software; the exact first responder agency/s of that type which operates in that location are picked; the exact first responders in the selected first responder agency are selected; and the pre-decided documents and electronic procedures become part of the action plan.

Edit Action Plans. The present embodiment of the solution creates and action plan once an incident has been released for action. However, functionality is provided to edit the same if the same is needed. The following functionality is needed: edit step description; change first responder agency responsible for a step; change first responders for a step; change assets required for any step; edit experts needed for any incident type; and manage attachments for a step/action plan.

Post Incident Management. A recovery plan can be made for each incident. The Post Incident Plan can be multi-step. The following functionality is provided for each step: assign first responder agency responsible for recovery plan; assign assets required for each step; assign vendor from whom the assets have to be procured; assign human resources for a step; assign experts for each step; and print and distribute the post incident action plan.

Administrative Tasks. Incidents can be closed and archived for analysis on a latter date.

Entity Instance Management. The present embodiment of the application platform is infinitely flexible and allows creation of new instances of different types of entities. The following entity instances can be created: create new expert; create new first responder agency; create new vendor; create new private corporation; create new citizen (can be done by citizens directly too).

Event Management. Events are normally fertile territory for man made and natural calamities to occur. The present embodiment of the EMS platform provides the following functionality for each Event Management: maintain event calendars for a city/county/state; and event management for each event created, the following functionality is provided: maintain event location; maintain event duration; associate types of incidents possible; maintain event specific methodology/action plan; maintain deployed/deployable resources for the event; and maintain aAlerts list specific to the incident.

Public Health Awareness Program. This functionality enables the control center to publish health related information to the community at large through a web portal. The following functionality is provided: publish health related bulletins and notices on the web portals; spread the bulletins to subscription lists; accept epidemic incidence reports from citizens; and create epidemic spread charts and reports.

E-Learning Module. The E-Learning Module allows the central control to define their e-learning structure and then publish the content.

E-Learning Taxonomy: In this module, the Central Control can define the various categories they want in e-learning and also define the exact type of content they want in it.

Publish E-Learning Content: E-Learning content can be published by people to whom the rights have been given by the Central Control. Separate content could be prepared for: 1^{st} Responder Agencies; 1^{st} Responders; Private Citizens; and Businesses.

E-Learning Content Management System: Apart from the taxonomy driven e-learning engine, The EMS provides another e-learning system, which can be exposed, to citizens at large. The following type of e-learning content can be published using this CMS: Frequently Asked Questions; Must Read Documents; Multi Media tutorials; and Useful Links Library.

E-Training Module. The E-Training module derives from the EMS e-Learning module. Although the e-learning module is described elsewhere in this document, its various usages are also listed here: for pushing standard procedures and processes to 1^{st} Responder Agencies and 1^{st} Responders; push the right content to the right 1^{st} Responder based on a match algorithm between the content and the profile; and publish web based tests and provide e-certificates to CERTS and first responders.

Alerts Management. Alerts can be configured for different entities like: First Responders, Experts, Private Corporations, NGOs, and Private Citizens.

Collaborative Suite Usage. The present embodiment of the EMS is enabled with a web based Collaborative Suite. Although the Collaborative functionality is listed elsewhere in this document, we list the various areas here where the Central Control could start different groups for collaboration. For example, this collaboration could occur: between First Responders, Experts and Central Control for Incident Management; between patients, doctors, paramedics and the patient's near ones; for creating Procedures and e-Learning content; for training and simulation; between the city, county, state and federal office for coordinating various activities; and for groups which have to be created for special occasions like various events.

First Responder Functionality.

FIRST RESPONDER AGENCY LEVEL. In this section we discuss functionality which is available to the First Responder at the agency level.

Add Sector Specific Details. The First Responder agency can add their type of agency details here (for example, a hospital will provide details like number of beds they have, number of ambulances, etc).

Declare Area of Operation. Here the First Responder Agency details the areas where it provides its services. This can be defined. This can be defined at a ZIP/City/County/State or Country Level.

Provide MapPoint Data. This session is used to provide data used for pin pointing the agency location on a GIS map.

Provide Address Details.

Provide brief and Detailed Description.

Upload Logo.

Define Chain of Command The entire chain of command can be defined for all the members of the First Responder Agency. Proxies can be defined for each and every First Responder.

User Management The following functionality is provided: Create Roles; Create First Responders and assign roles to them; and Define e-Learning access levels for each First Responder.

E-procurement. The following functionality is provided: search products; start RFQs with vendors and negotiate; and place purchase orders.

Incident Management. The following functionality is provided: report incident (of three types); list all incidents in which the agency is involved; and provide investigation report of incidents assigned.

Asset Management and Maintenance. The following functionality is included: Maintain Assets; Maintain Assets maintenance schedule; and Update Asset condition reports.

Training Management. The following functionality is included:

Define Training Courses; Define Training Schedule; and Maintain results of tests taken.

Shift Management.

FIRST RESPONDER LEVEL. In this section we describe the functionality which is available to each individual First Responder.

Provide Personal Details.

Provide Professional Details. (e.g., A Doctor will provide the details about his specialty, experience, etc.)

Provide personal medical details.

View incidents he is involved in and jump to its Collaborative Suite Group.

View e-learning content he has access to him.

Report an incident.

Provide investigation report for an incident.

Report Daily Activities.

Create tasks and assign to self and others.

Search for First Responders. Full contact information can be found on the following search criteria: City; Agency; Qualifications; Incidents involved; and Tasks.

Communicate. First Responders can communicate by: SMS; E-Mail; Phone.

GIS Based Functionality. The following GIS based functionality is provided to each First Responder: Locate Agencies and First Responders; Locate Incident Locations; and Map route to incident site.

Hospital Specific Functionality. This functionality is only available to the First Responders belonging to the Hospital type of First Responder Agency. The functionality includes: access to medical information of casualties using hand held devices; capture current patient information using hand held devices; capture vital signs using medical equipment; transmit information over GPRS/CDMA network; and access Collaborative Suite Instances created for collaborating with patient's family doctors and near and dear ones.

Private Corporation Functionality. In this section we discuss the functionality that is available to each Private Corporation.

Private Corporation Level. In this section we discuss functionality which is available to the First Responder at the agency level:

Define Private Corporation Sites: Each Private Corporation can add all its sites which it wishes to enroll in the program. For each site, its various plans (e.g. Evacuation Plan, Fire Plan, etc) can be added.

Provide MapPoint Data. This session is used to provide data used for pin pointing the various sites on a GIS map.

Provide Address Details.

Provide brief and Detailed Description.

Upload Log.

Define Chain of Command. The entire chain of command can be defined for all the members of the private corporation. Proxies can be defined for each and every employee of the corporation.

User Management. The following functionality is provided:

Create Roles; and Create employees and assign roles to them.

Methodologies and Procedure Management. Private Corporations can create their own incident types and methodologies for their specific sites. These are also used while creating an action plan in case the incident site happens to be one of them.

Incident Management. The following functionality is provided:

Report Incident; and List all incidents in which the private corporation is involved.

Employee Level. In this section we describe the functionality which is available to each individual employee of the Private Corporation.

Provide Personal Details.

Provide Professional Details. (e.g., A Doctor will provide the details about his specialty, experience, etc.)

Provide personal medical details.

View incidents he is involved in and jump to its Collaborative Suite Group.

Report an incident.

Citizen Functionality. In this section we delineate between the functionality that is available to every citizen within the EMS solution.

Provide Personal Details.

Provide Contact Details.

Provide Health Related Details.

Provide Personal Description.

Report Incidents. The following functionality is provided: Report Personal Incident; Report generic Incidents; and Report missing people for any incident.

Access Web Based E-Learning Content.

Vendor Specific Functionality: In this section the functionality which is available to various approved vendors within the EMS framework is described.

Provide Vendor Profile Information.

Provide Contact Information.

Maintain Products and Services Catalog.

Respond to RFQs from First Responder Agencies.

Accept POs placed by First Responder Agencies.

Expert Specific Functionality: In this section the functionality that is available to Experts within the EMS framework is described.

Profile Management. Experts are provided with the following functionality for managing their profile: Provide Personal Information; Provide Contact Information; Provide Medical Information; Declare Area of Operation; and Select Expert Category/s.

Methodology and Procedure Management. Experts can be provided functionality similar to the Control Center for creating and managing Methodologies and procedures for different incident types.

E-Learning. Experts can be provided the right to manage the e-learning taxonomy and publish e-learning content.

Incident Management. The following functionality is provided:

View Incidents they are involved in and jump to its collaborative suite; and Report Incidents.

Collaborative Suite. In this section the functionality that is available in the EMS Collaborative Suite is described. A Group can be created for each incident reported.

Announcements. All members of the space will be able to submit announcements. Each announcement will be deleted after a specific member defined period.

Contacts. Apart from the members, other contacts could be created within the space. These will typically be those contacts that could be commonly used by the space members.

Projects. Members will be able to create projects. Each Project can have multiple tasks. Tasks could be assigned to members. Tasks could have a finish by date assigned to them.

Discussion Forums. Multiple Discussions could be started. Each Discussion Forum will be a multi threaded entity.

Schedule a Conference Call.

Schedule a Video Conference.

Document Repository.

A common document repository will allow all members of a specific space to load an share documents. The documents are version controlled for verification.

Online Chat: A Java based chat engine will be provided. This chat engine will not require any client to be downloaded.

EMS Features List

Profiling. One corner stone of any First Responder system is to know as much as possible about all the different entities and assets in the eco-system. These could be First Responder agencies, First Responder themselves, private citizens, NGOs, private organizations, vendors, etc. Apart from this, newer entities could always come up which may need profiling and data collation. In this section, we discuss the functionality available in the EMS platform.

Entity Profiling. The EMS provides the functionality to profile the various entities like First Responder agencies, First Responder themselves, private citizens, NGOs, private organizations, vendors, etc. Profiling allows capturing of all relevant information like personal details, medical data, contact details, professional details, etc.

EMS Profiling Engine. To make profiling effective, the EMS allows the Incident Managers to define what information is needed for different type of entities. For example—they may be interested how many beds are available in case of a hospital; while for a Police Station, they may be interested in knowing how many Radio equipped cars does it have. This flexibility allows the Incident Managers to capture relevant information about different agencies/individuals, thus making profiles rich and useful.

Search Capability. One of the core functionality available within the EMS is to search for different First Responders Agencies and individual First Responders using different types of searches. This allows Incident Managers to zero on the right resource in almost no time. The following types of searches are offered out-of-the-box: By City; By Agency; By GPS location; By Incident; By professional Qualification; By Entity Type; By Chain of Command; and By working on all of these parameters together.

Communication. The EMS provides multiple options of communicating with various agencies and First responders profiled. These can be instantiated on an adhoc manner anytime by the Incident Managers. These include: By Phone; By SMS (Short Message Service); By Mail; and By Chat.

Chain of Command. The EMS has a robust Chain of Command for defining day-to-day chain of command as well as Incident specific Chain of Commands. This Chain of Command can be made either for regular reporting or can be made for a specific incident. The Chain of Command can run across multiple different Agencies and jurisdictions.

Planning Function. Ability to plan is of utmost importance in any First Responder system. The EMS provides multi-level planning functionality to the Incident Managers and the Central Control. In this section, the planning functionality is described in detail.

Electronic Documentation. The EMS provides multiple mechanisms to electronically document standard procedures. Functionality is provided for different entities (First Responders/Incident Managers) to have access to the same based on their access rights. Similarly, pre-planned action plans made by Experts for different scenarios can be stored in electronic format. These electronic procedures can be indexed and searched based on multiple criteria like vulnerability, incident type as well as site based realities.

Adhoc Planning. Although the EMS application suggests an action plan based on the incident location and incident type, Incident Managers can modify these plans or create fresh Plans for any specific incident. Stored Electronic procedures are fetched automatically by the EMS based on the incident and scenario type to assist the planning function. These Action Plans can then be distributed through the EMS to the response team, which may span over multiple different First Responder Agencies.

Event Based Planning. The EMS allows Incident Managers to maintain an event calendar, profile all events and plan for them. These plans may include multiple scenarios, canned response plans for the same, deployed and deployable agencies and 1^{st} Responders, assets required, etc.

Procedural Library. The EMS provides multiple mechanisms to electronically document standard procedures. Functionality is provided for different entities (First Responders/Incident Managers) to have access to the same based on their access rights. Similarly, pre-planned action plans made by Experts for different scenarios can be stored in electronic format. These electronic procedures can be indexed and searched based on multiple criteria like vulnerability, incident type as well as site-based realities.

Action Plan Builder. The EMS helps Incident Managers to create rich incident specific Action plans based on stored procedures and Methodologies. The EMS Matching algorithm creates an Optimum Team based on Incident Location and Incident Type/s. The Algorithm draws upon the stored procedures and the profiled 1^{st} Responders for the same. The Incident Managers can always edit this Optimum Plan based on their experience and ground realities or can create a fresh plan altogether. Action Plans created can be sent to the response team and the chain of command through GEMs. Alerts can be sounded using email/SMS/Phone.

Pre-Incident Information. The EMS allows Incident Managers to profile and collate as much information as possible about the various incident prone locations, private as well as government owned. The EMS allows Incident Managers to depute specific First Responders to incident site for doing reconnaissance. First Responders can use hand held devices to provide site realities through text, pictures and videos.

Training and Certification. The EMS allows various First Responder agencies to maintain the training and certification levels of all its employees. This central database is available to Incident Managers for taking better informed decisions.

Equipment Maintenance and Readiness Check. This module allows First Responder companies to maintain an up to date list of all their equipment including their test schedules and their results. Thus, the Incident Managers always know what kind of equipment is available with which 1^{st} Responder agency, where is it deployed and what is its readiness level.

Response. The EMS provides rich functionality to respond to any incident.

Optimum Team Function. The EMS Matching algorithm creates an Optimum Team based on Incident Location and Incident Type/s. The Algorithm draws upon the stored procedures and the profiled First Responders for the same. The Incident Managers can always edit this Optimum Plan based on their experience and ground realities or can create a fresh plan altogether.

Action Plan Delivery. Action Plans created can be sent to the response team and the chain of command through the EMS. Alerts can be sounded using email/SMS/Phone.

Reconnaissance Function. The EMS allows Incident Managers to depute specific First Responders to incident site for doing reconnaissance. First Responders can use hand held devices to provide site realities through text, pictures and videos.

Editable Action Plans. Action Plans can be edited and changed in real time based upon ground realities. Changed Response Team structures can be communicated in real time across the system.

Information Bullet. The EMS delivers each member of the response team the relevant section of the action plan. Along with this, all critical information about the incident is relayed on a need to know basis.

Public Information System. The EMS provides excellent web based Content Management Systems for sharing and soliciting information from citizens at large in case of an incident happening.

Alert Mechanisms. The EMS provides multiple ways of alerting the Response Team and other involved people in real time. These mechanisms include: Mail; Phone; Fax; and SMS.

Recovery. The EMS provides rich functionality for managing all aspects of Recovery function.

Recovery Action Plan. Action Plans can be made for the Recovery function. The Action Plan can be multi-step. Resources, vendors and assets can be assigned to each step. The Recovery Action Plan can be distributed across the system through EMS.

Procurement Function. The EMS provides a comprehensive E-Procurement engine for recovery. The following functionality is provided: Ability to profile vendors and their products/services; Ability to place Purchase Orders based on pre-negotiated contracts; Ability to place fresh Purchase Orders after taking the RFQ route and negotiating; Ability to define shipment dates and delivery addresses in the Purchase Orders; Ability to track shipments; and Ability to mobilize contractors with amazing alacrity at the incident site.

Claims Settlement. The EMS provides excellent workflow for claims settlement after an incident has occurred. The workflow can be customized to meet exact requirements.

Community Health and Telemedicine Management. One of the unique features of the EMS is its Tele medicine component and its tight integration with the First Responder reconnaissance system.

Medical profiling and Access. First Responders and citizens at large can profile their relevant medical data. Paramedics and Doctors can access this information by receiving full permission or using bio-metric authentication devices in case of emergency. The functionality is completely HIPPA compliant.

Onsite Medical Data. Paramedics at the incident site can club historical medical data with current information like Vital Signs and other relevant details using hand held devices. This information can be transmitted in real time to hospitals for further action and increase their preparedness levels.

Collaboration in Real Time. The EMS can create collaborative environments for the patient's family doctors, relatives and his current physician to collaborate in real time.

Community Health Services. This component of the EMS allows incident managers and the health department people to deal with epidemics and other related issues in a more proactive manner. The following functionality is provided: Publish health related bulletins and notices on the web portals; Spread the bulletins to subscription lists; Accept epidemic incidence reports from citizens; and Create epidemic spread charts and reports.

Collaboration. Apart from good planning and profiling, collaboration is the biggest challenge in any First Responder situation. In this section we discuss the various scenarios in which the EMS Collaborative Suite can be deployed: Between First Responders, Experts and Central Control for Incident Management; Between patients, doctors, paramedics and the patient's near ones; For creating Procedures and e-Learning content; For training and simulation; Between the city, county, state and federal office for coordinating various activities; and For groups which have to be created for special occasions like various events.

E-Training. The E-Training module derives from the EMS e-Learning module. Although the e-learning module is described elsewhere in this document, its various usages are listed here: For pushing standard procedures and processes to First Responder Agencies and First Responders; Push the right content to the right First Responder based on a match algorithm between the content and the profile; and Publish web based tests and provide e-certificates to CERTS and First Responders.

Dispatches. Dispatches are an integral part of any First Responder Solution. The EMS has pre-defined hooks at all its function points. These hooks can be used to create Dispatch instructions at any level of area needed within the application. This is an implementation issue. A Dispatch master list is created during implementation and deployed on site.

EMS Integration Framework. The EMS uses its pliable Profiling Engine and the Web Services paradigm for integrating with various external applications and data sources. Using these tools and a well-honed methodology, EMS can either integrate or fetch data seamlessly from other remote sources. This data can then we searched/viewed/worked at within the EMS framework. The EMS Integration Framework is a mix of following pieces of codes and services.

Web Services. The EMS team deploys web services for connecting to remote servers (for e.g., terrorist database/Procedure Database). These Web Services then fetch the relevant data from these pre-designated sources.

EMS Taxonomy Engine. Data coming from multiple sources have different structures. The EMS taxonomy Engine is used for mapping these data sources within the EMS framework. This automatically creates the back-end needed for storing the data in the EMS framework.

User Interfaces. Users can access this stored data from either a browser or from hand held devices.

GlobeCom21 Emergency Management System (EMS) Technology Platform. In accordance with still another embodiment of the present invention, a GlobeCom21 Emergency Management System (EMS) Platform is build using Microsoft technologies. The platform is highly robust and scalable as it executes. Its analytical and data processing capabilities are thought from extreme usability perspective. At the core is it, it uses a revolutionary Profiling engine that enables EMS to map any kind of content and allows EMS to be integrated with any kind of application across platforms, and across protocols.

The following is a detailed explanation of the technology strengths of EMS as a platform. Using EMS the entire community involved in developing solutions that are a fusion of Enterprise Scale applications and Emergency Responder Solutions will be benefited. EMS has been designed, architected and developed keeping in mind that it should be easy to integrate with Enterprise Scale Applications. The robustness, ease of data sharing and data communication and the deployment strategy makes this happen. EMS has achieved this using Web Services, Remoting. The EMS SDK also provides the flexibility for achieving the same. EMS has an intuitive interface to use various Microsoft Enterprise scale servers/Products like BizTalk as EAI Integrator, Share Point Portal Server, Share Point Portal Services for interfacing with the outer world for data exchange.

EMS Architecture. The architecture of EMS is based on object orientation and componentization. This gives the flexibility to maintain the platform easily. Apart from this the componentization also gives the flexibility to add new features to the application. EMS follows a modified format of a three-tier application where every tier has a set of components which help in making the platform scalable and robust.

Presentation Tier. The presentation layer has been architected keeping in mind that the user interfacing can be done from desktops, Web Clients, Handheld devices and third party applications. The presentation layer is extremely flexible allowing lot of clients like Web/VoIP/Radio Paging/SMS/GIS to be easily integrated seamlessly with GEMS platform to deliver a complete suite of applications in Emergency scenarios.

Business Logic Tier. The thought of making it easy to integrate EMS with 3rd party components and Enterprise Scale Applications lead to building the business logic scalable enough to be called as the EMS SDK. The business logic is shared across all the presentation layer components. At the heart of Business logic layer is a Scenario builder which allows is to build various emergency scenarios. These in turn create a powerful tool for pre as well as post incidence situations. This coupled with powerful configurable workflow engine allows any kind of scenario mapped very quickly and easily and it gives ability to First responders to create detailed action plan with the help of other modules in EMS.

Data Access Tier. The key responsibility of the Data Access Tier is to support the platform in managing transactions at business logic level and support various Data Base engines. The system has to be inherently flexible in its ability to talk to multiple data sources. EMS data access layer allows us to talk to various data forms like email, SMS, Database, MS Documents. These are some of the sources of documents from where the trigger for incidence may generate. Likewise, any emergency management solution has to build a strong action plan which has to be then again fed back to the transaction systems for any state/county or company where EMS will be implemented. Flexibility at this layer is built by way of providing an intelligent and highly configurable Data Access layer which can allow us to talk to any kind of data sources or legacy systems.

Application Integration Engine. EMS leverages heavily on Microsoft Biztalk for integration with vast majority of applications. BizTalk is a Microsoft platform for integration of internal and external applications in order to fulfill business processes across an extended enterprise. It utilizes the Extensible Markup Language (XML) as the standard language for data exchange between applications. EMS also at the most basic level for data extraction and integration uses XML. This enables the integration of any kind of application with EMS with little effort. EMS has a dynamic profiling engine, which uses any data that can be profiled in a EMS database and required formats for BizTalk communication with EAI Systems can be generated on the fly. EMS has an adaptor, which interfaces between BizTalk and EMS Profiling Engine. Using this mechanism EMS can talk to Enterprise Scale applications like SAP R/3.

Content Integration Engine. Because the EMS platform has a capability to talk to Share Point Server and portal integration services, it can access any content outside the EMS platform, using Share Point integration Adapter components. The EMS application architecture is shown in previously described FIG. 17.

EMS Technology Features. The .NET Framework is a new computing platform that simplifies application development in the highly distributed environment of the Internet. Net Framework facilitates EMS with the features list below.

Security. Security is the most obvious concern that comes to any ones mind when any platform has to be integrated with Enterprise Applications. EMS address these security issues at two levels. A typical authentication and authorization scenario are mentioned below. Apart from this the all the communication and data sharing is done in a secured manner either using Web Services, Remoting or using HTTPS protocol over the internet.

Authentication.

Forms Authentication. A system by which unauthenticated requests are redirected to an HTML form using HTTP client-side redirection. The user provides credentials and submits the form. If the application authenticates the request, the system issues a cookie that contains the credentials or a key for reacquiring the identity. Subsequent requests are issued with the cookie in the request headers; they are authenticated and authorized by an ASP.NET event handler using whatever validation method the application developer specifies.

Passport Authentication. Centralized authentication service provided by Microsoft that offers a single logon and core profile services for member sites.

Windows Authentication. Windows Authentication is performed by IIS in one of three ways: basic, digest, or Integrated Windows Authentication. When IIS authentication is complete, ASP.NET uses the authenticated identity to authorize access. EMS can also integrate Active Directory (Domain Controller) as a security mechanism.

Authorization.

File Authorization. File authorization is performed by the FileAuthorizationModule, and is active when you use Windows authentication. Applications can further use impersonation to get resource checks on resources that they are accessing.

URL Authorization. URL authorization is performed by the URL Authorization Module, which maps users and roles to pieces of the URL namespace. That is, the module can be used to selectively allow or deny access to arbitrary parts of the URL namespace for certain sets, users, or roles.

Web Services. Designed to enable collaboration across multiple agencies, jurisdictions, and groups, EMS unrivaled data sharing capabilities enables users to selectively and securely exchange information between systems, with document control options and automatic updates made to shared reports. Additionally, EMS XML interface uses industry-standard XML to allow external systems, including trigger sources, to push data into and pull data from the application, further enabling effective data exchange. Data is maintained by paramedics in Hand Held devices is in a disconnected architecture, paramedic answers all the pre-generated questions, at the Incident location and paramedic synchronizes the data from hand held to server using Web Services.

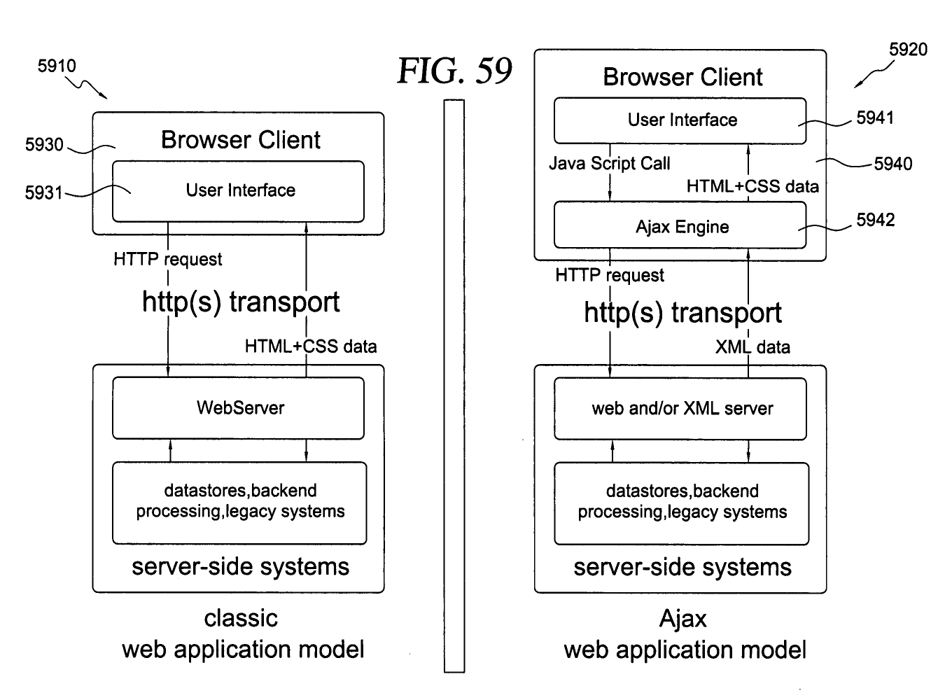

AJAX Integration. An Ajax application eliminates the start-stop-start-stop nature of interaction on the Web by introducing an intermediary—an Ajax engine—between the user and the server. It seems like adding a layer to the application would make it less responsive, but the opposite is true. FIG. 59 is a functional block diagram showing a comparison of a classic web application model 5910 and an Ajax web application model 5920. In FIG. 59, classic web application model 5910 includes a browser client 5930, which has a user interface 5931. Similarly, Ajax web application model 5920 includes a browser client 5940 with a user interface 5941 and an Ajax engine 5942.

EMS maintains hundreds of state, county and city, all the records of state, county and city are interrelated to each other, i.e., when the country is selected, states list of the selected country is to be displayed and when state is selected related county list are to be displayed. This change of interrelated data is done using Ajax which save the post-back to the server. Without causing the page to refresh you can zoom in and zoom out on the Incident Location Map's that are available in EMS.

Analytical Capabilities. EMS is using SQL Server 2005 as data store. SQL Server's Analysis Services has been enhanced in terms of real-time capabilities scalability and speed. Its new Unified Dimension Model (UDM) acts as a single source for any analysis—multidimensional cubes, relational online analytical processing (OLAP) or any variation on those themes. EMS Incident Analysis components uses profiled incident data, and features of SQL Server 2005 to represent incident analysis based on various attributes in nice graphical manner. EMS SDK provides wrappers to SQL Data Analysis Services, which can be used by developers who work on EMS SDK to model and present their data.

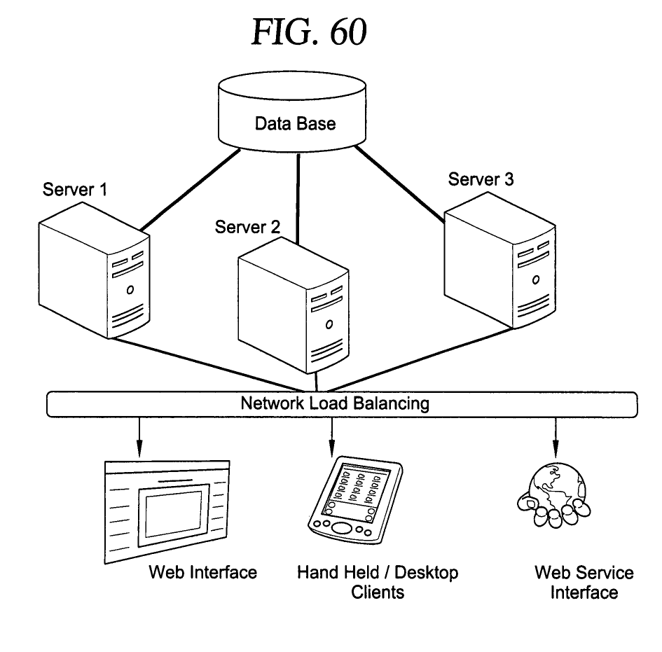

Window Server 2003. Recommended production environment for EMS is typically Window Server 2003 Standard Edition with IIS 6.0, SQL Server 2005. FIG. 60 is a block diagram of a recommended EMS Physical Deployment with a server cluster and NLB.

Scalability and Availability. With Windows Server 2003, EMS uses a two-part clustering strategy.

Network Load Balancing (NLB). NLB provides load balancing support for IP-based applications and services that require high scalability and availability. NLB is a clustering technology that distributes TCP requests across servers. For instance, if there are two servers in a cluster, NLB will allocate TCP requests across those two servers. NLB is easy to setup and is included in all Windows Server 2003 products. With NLB, organizations can build groups of clustered computers to support load balancing of TCP, UDP, and GRE requests. Web-tier and front-end services, such as Web servers, streaming media servers, and Terminal Services, are ideal candidates for NLB.

Server Cluster (SC). SC provides failover support for applications and services that require high availability, scalability and reliability. A Server Cluster takes two or more computers and organizes them to work together to provide higher availability, reliability, and scalability than can be obtained by using a single system. When failure occurs in a cluster, resources can be redirected and the workload can be redistributed. Typically the end user experiences a limited failure, and may only have to refresh the browser or reconnect to an application to begin working again. These two technologies combine to insulate the user's IT infrastructure from application and service failure (software crashes), system and hardware failure (disk crashes), and even site failure (natural disasters, power outages, network interruptions, and so on). Microsoft clustering technologies used by EMS increase overall availability, while minimizing single points of failure.

Performance. There have been lots of performance improvements to IIS 6.0 and ASP.NET on Windows Server 2003. Even ASP applications run faster on IIS 6.0 and Windows Server 2003 than they did on Windows 2000 and IIS 5.0. A reason for the performance improvements includes 64-bit processor (Itanium) support for Windows Server Enterprise Edition.

Windows Server 2003, Enterprise Edition, support Hot Add Memory. This allows ranges of memory to be added to a computer and made available to the operating system and applications as part of the normal memory pool while the server is running. This does not require re-booting the computer and involves no downtime. This feature will be available only on hardware that supports this feature.

EMS Application Portability. FIG. 18 describes how GEMS as a platform facilitates its users to integrate the applications developed using the GEMS SDK with different services. The EMS application itself is tightly coupled with all the services listed in the diagram below which makes it easy for the users to manage incidents, workflow, data sharing, etc. easily.

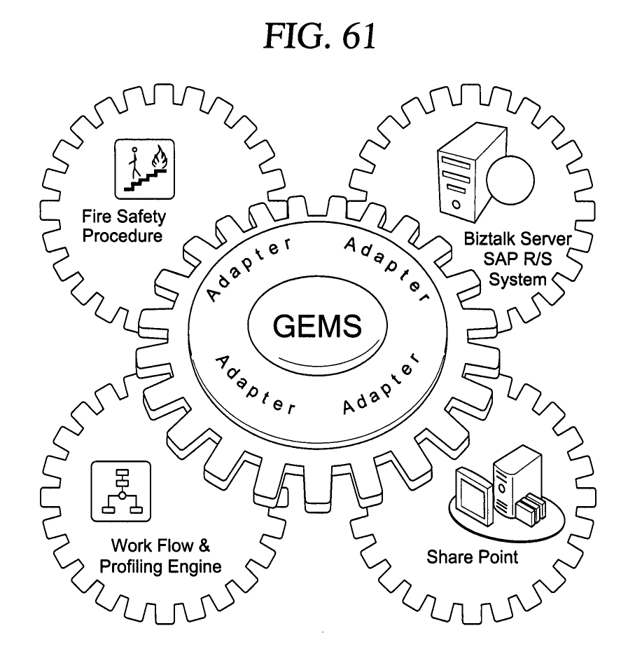

Chemical Company Solution. EMS has capabilities to work as a business solution and as an Emergency management solution within the Chemical Industry. FIG. 61 is an artistic representation of the EMS approach for integration with, EAI applications like SAP R/3 through EMS Adapter for BizTalk. Content Management Systems and document Management System like Share Point and any other contents outside the EMS framework through Share Point Adapter. The EMS profiling engine facilitates to manage Workflow and BizTalk communication document formats. And EMS Incident Management Solution with Metrology Engine helps users to configure different types of incidents and respective actionable items for the same.

In accordance with an embodiment of the present invention, a holistic process that allows and enables risk assessment, analysis, strategic planning, capability building and project execution for removing or mitigating risks faced by enterprises.

In accordance with an embodiment of the present invention, a machine readable medium having stored thereon a plurality of executable instructions to perform a holistic process that allows and enables risk assessment, analysis, strategic planning, capability building and project execution for removing or mitigating risks faced by enterprises.

In accordance with an embodiment of the present invention, a process and an enabling software diagnostic tool for diagnosing risks that enterprises are exposed to, the probability of the risks happening and the impacts on the enterprises.

In accordance with an embodiment of the present invention, a machine readable medium having stored thereon a plurality of executable instructions to perform a process of using a risk knowledge base to diagnose risks that enterprises are exposed to, the probability of the risks happening and the impacts on the enterprises. The machine readable medium further providing a flexible environment for creating the Risk Knowledge Base.

In accordance with an embodiment of the present invention, a machine readable medium having stored thereon a plurality of executable instructions to perform a method of creating forms, surveys and interview structures for trapping risk specific data.

A process and software (i.e., a computer program), which allows an enterprise to define all the activities it can undertake, to reduce/remove the probability and the impact of a risk.

A computer program, which, based on a specific available budget, suggests the right mix of activities an enterprise must execute, to maximize its returns, and minimize its risk.

A computer program and a process, which allows enterprises to create methodologies and action plan to address risk situations. These plans can be made for prevention, response and recovery. The computer program, which on a risk instance occurring, picks the right human and non human resources, intimates them, and provides them with a detailed action plan for execution.

A computer program and a process that monitors the critical parameters of any enterprise, and raises alarm as soon as any of the parameter values are exceeded.

A computer program that allows enterprises to create multiple groups, and work together in an collaborative environment for the different risks associated with the enterprise.

Risk Mitigation Project Selection: A methodology, process and a computer program which helps enterprises select, given a specific available budget with them, what projects must be implemented from a pool of implementable projects, where different project need different budget for implementation and different projects reduce risk probability and/or the risk impact by different amount, so that the enterprise gets the most value with respect to risk exposures reduction within the available budgets. Enterprises are exposed to different kinds of risks. For example, a particular facility may be exposed to Fire, Hurricanes and Terrorist Attack Risks. The probability of any of these risks actually happening differs. For example, the chances of fire erupting could be say 5/10 where as that of a terrorist attack could be as less as 1/10.

Each of these Risks has a different impact on the enterprise. The impact normally is of two types—impact in Time (Time needed to recover) and Monies (the total loss). Enterprises can implement different projects for reducing the probability, money impact and time impact of different risks. Each of these projects cost a specific amount of money, need a specific time frame to be implemented, reduce the risk probability, its money impact or recovery impact by different degrees. Consider a scenario wherein a company is exposed to say some 5 risks. The company has made a list of say 20 projects, each of which reduce the risk probability, its money impact or recovery impact by different degrees. If the company has say US$ X, which project must it implement to get the most out of its investment? The GC21 algorithm, methodology and the software provide this answer to the company.

Resource and Asset Profiling: A process and a computer program, which allows profiling of resources and assets, whether belonging to the company or of external sources, which could be used while warding off Risk situations or taking post risk actions. As described earlier, the GC21 application allows the enterprise to create action plans, which could be taken to ward off the risk situation. Almost all such steps need equipment for its implementation. For example, in case of a fire, the company needs buses for evacuating its employees to a safer place, fire tenders to fight the fire and people to coordinate the activities. The GC21 application allows the enterprise to map, profile and list all such resources and assets, their owners, availability and other relevant information, so that when the time comes, it's all available at a mouse click.

Taxonomy setting and data import: A methodology, process and software, which allows enterprises to map their existing risk related database structure within the GC21 application, and the ability to port their existing risk related data into the GC21 application. Most enterprises have some kind of DR (Disaster Recovery) or Risk Management plan, howsoever rudimentary, in place. Some data is also available for these plans. Instead of re-keying this data into the GC21 application, the software allows the enterprise to map its data structures into the Gc21 application. Following this, its current data can be ported very easily into GC21 application.

Ongoing Risk Mitigation: A methodology, process and a computer program, which allows enterprises to continuously reduce their risk exposure and/or its impact on their business. Risk Mitigation is not a onetime activity. It has to be pursued continuously to get perm anent, tangible benefits. The GC21 application allows enterprises to create long term Risk mitigation plans, monitor its execution over protracted periods of time, create steps needed for these projects and monitor online the planned versus actual reduction in risk probability and/or its impact in money and/or time terms.

Risk Scenario Builder: A methodology, process and a computer program, which allows enterprises to model the various risks faced by them, to model scenarios and see their impact if one or multiple of these Risks were to erupt at the same time. Although most enterprises know the risks that they face and their individual impact, it is difficult for most of them to envisage the havoc that can be created if these risks were to perpetuate together at the same time. The GC21 Risk Scenario Builder allows enterprises to create scenarios where they can perpetuate multiple risk scenarios at the same time, and see its impact on their business. This is a diagnostic tool and it tells Managers how vulnerable they are and that they need to take actions for mitigating the same.

Facility Risk Quotient: A methodology, formula and computer program, which calculates the total Risk Quotient of any Facility. The Formula is explained below: Assume that a particular facility is exposed to n Risks: R1, R2, R3 . . . Rn For each of these risks, the Risk Priority Number (RPN) is calculated by multiplying the Risk's probability to the Risk's impact. For Risk Rn, the RPNn is calculated thus: (RPN)n=Probability (Rn)×Impact (Rn). The Total Risk Quotient (TRQ) of any facility is calculated by multiplying together the RPN figures of all the Risks that a facility is exposed to: TRQ=(RPN)_{1×}(RPN)_{2×}(RPN)_{3×} . . . (RPN)ₙ. Most companies end up looking at individual risks. The Total Risk Quotient brings together the total impact of these individual risks and helps managers to look at the bigger picture.

Extended Enterprise interdependent Risk quantification. A methodology, formula and computer program, which calculates the individual risk factor interdependence on their partner's risk factor for an extended enterprise. This methodology calculates each risk (RPN)1 . . . (RPN)n based on the RPN(b) before mitigation in comparison to RPN(a) after mitigation. As well as the manner in which mitigation was treated [ [symbol] 1 (not at all), [symbol] 2 (partially or gradually), [symbol] 3 (totally)] translating to a specific status in each point in time. There is a dynamic relationship between ( [symbol] 1, [symbol] 2, [symbol] 3) that is time sensitive where, in time gamma1 can transform to gamma2 and gamma3. However, time is not taken in to the formulation since the status of each risk at any point in time is as is at that moment, and it will transfer as is to the starting risk of the next partner in the chain.

[symbol] 1=0=no mitigation impact

[symbol] 2=0−99=partial mitigation impact

[symbol] 3=100=full mitigation impact

TRQ(extended)= [symbol] 1∫[RPN(B)−RPN(A)]+ [symbol] 2∫[RPN(B)−RPN(A)]+ [symbol] 3∫[RPN(B)−RPN(A)]+ . . . + [symbol] n∫[RPN(B)−RPN(A)]

The effect of each risk element and the manner in which the mitigation measure were treated will be transferred to the next partner in the chain of an extended enterprise creating an interdependent risk portfolio.

Best Practice Mapping. A methodology, process and a computer program, which allows enterprises to define and trap best practices or the best possible scenario with respect to a specific functional area, and to fix a numeric value of 100% to it. Enterprises reduce their risks, not only by taking specific risk mitigating measures, but also by making their operations and processes more streamlined and flexible. The GC21 application allows enterprises to define and trap the best practices against each of their functional area. Given that the practices are best practices, they are provided with a numeric value of 100%.

Current Situation Mapping. A methodology, process and a computer program, which allows enterprises to define and trap the current state of their processes with respect to a specific functional area, and provide a numeric percentage to it, given that the relevant best practice is 100%. To move towards best practices, enterprises must first define their current state. For example, the best practice says that all information must be available from a web-based system, and this is pegged at 100%. Let's assume that the company's information can currently be accessed using proprietary applications. The company pegs this at a numeric value of say 30%. Now the company knows that it has to cover a gap of 70% to achieve the best practice slot. The GC21 application allows companies to do the same.

Steps to reach best practice slot. A methodology, process and a software, which allows enterprises to define and trap stages between their current process state and the best practice defined by them, and the ability to provide a percentage of efficiency to each of these stages/steps. Consider the situation described in the example of 21.2, where the company's current state is at 30%. The GC21 application allows enterprises to define the steps it will have to take in its journey to reach the best practice mark of 100%, and assign a percentage value to these steps too.

Process Gradation Matrix. A methodology, process and software, which allows an enterprise to grade its various processes with respect to their importance on a numeric scale, with respect to their impact on risk exposure, mitigation and reduction. Enterprises have many processes, whose efficiency an impact on the risk an enterprise is exposed to. However, all processes are not equal in this respect. The quality of some processes have more impact on the risks faced by an organization. For example, the quality of evacuation process is more relevant to risk reduction than the quality of procurement process. The GC21 application allows enterprises to numerically grade these processes with respect to their relevance to risk exposure, reduction and mitigation. This helps organizations to focus on improving those processes which have more effect on risk based issues than wasting time and money on those which have only marginal effects.

Although the present invention has been disclosed in detail, it should be understood that various changes, substitutions, and alterations can be made herein. Moreover, although software and hardware are described to control certain functions, such functions can be performed using either software, hardware or a combination of software and hardware, as is well known in the art. Other examples are readily ascertainable by one skilled in the art and can be made without departing from the spirit and scope of the present invention as defined by the following claims.

What is claimed is:

1. A method for creating a comprehensive process that diagnoses the risk factors threatening an enterprise and then mitigates the risks by prevention or preparedness to respond and recover to incidents, the method comprising:
determining a current risk position of an enterprise;
determining a vulnerability risk assessment for the enterprise based on the determined current position;
evaluating the implications of the vulnerability risk assessment for the enterprise; and
identifying an action plan based on the evaluation of the implications of the vulnerability risk assessment.

2. The method of claim 1 wherein the determining a vulnerability risk assessment for the enterprise comprises:
determining a vulnerability risk assessment for the enterprise based on the determined current position in at least the following areas, process, supply, environment, demand, and control or other areas as specified by the enterprise.

3. A method for creating a comprehensive process that diagnoses the risk factors threatening an enterprise and then mitigates the risks by prevention or preparedness to respond and recover to incidents, the method comprising:
determining a current risk position of an enterprise;
comparing the current risk position of the enterprise with standard industry best practices;
identifying existing vulnerabilities of the enterprise based on the determined current position and standard industry best practices;
performing an impact analysis of the existing vulnerabilities;
performing a capability assessment to determine mitigations for the identified vulnerabilities;
developing a mitigation plan to deal with the existing vulnerabilities;
implementing the mitigation plan;
continuously monitoring dependent and critical data for signals indicating the need for prevention or for response to an incident;
detecting a signal indicating the need for a preventive action or a response to an incident; and
automatically activating the mitigation plan.

4. A system to identify, diagnose and mitigate enterprise risks, the system comprising:
a network;
at least one server computer connected to the network;
a database system connected to the at least one server computer;
at least one client computing system adapted to connect to the network;
a web service interface connected to the network;
a web interface connected to the network;
a computer program being embodied on the database system and executable by the at least one server computer to perform a comprehensive process that
identifies and diagnoses the risk factors threatening an enterprise,
prepares a plan to mitigate the identified risks,
executes the plan, and
continuously monitors dependent and critical data for signals indicating the need to take a preventive action or to respond to an incident; and
executes a preventive or responsive action as a result of receiving a signal indicating the need for the action.
